(19) United States
(12) Patent Application Publication
(10) Pub. No.: US 2013/0281467 A1
(43) Pub. Date: Oct. 24, 2013

(54) NOVEL MICROBICIDES

(71) Applicants: Stephan Trah, Stein (CH); Laura Quaranta, Stein (CH); Clemens Lamberth, Stein (CH); Martin Pouliot, Stein (CH)

(72) Inventors: Stephan Trah, Stein (CH); Laura Quaranta, Stein (CH); Clemens Lamberth, Stein (CH); Martin Pouliot, Stein (CH)

(73) Assignee: SYNGENTA PARTICIPATIONS AG, Basel (CH)

(21) Appl. No.: 13/881,648

(22) PCT Filed: Oct. 28, 2011
(86) PCT No.: PCT/EP11/68990

§ 371 Date: Apr. 25, 2013

(30) Foreign Application Priority Data
Oct. 28, 2010 (EP) 10189188.5

(51) Int. Cl. A01N 43/54; A01N 43/90

(52) U.S. Cl. CPC A01N 43/54; A01N 43/90
USPC 514/260.1; 544/284; 514/266.21; 544/278; 544/230; 544/255

(57) ABSTRACT

Compounds of formula (I), wherein G represents together with the two carbon atoms of the pyrimidine ring to which it is attached, a 5- to 7-membered aliphatic carbocyclic or heterocyclic ring system which contain 0 to 2 heteroatoms selected from the group consisting of nitrogen, oxygen and sulfur; and wherein said 5- to 7-membered aliphatic carbocyclic or heterocyclic ring system can be mono-, di- or trisubstituted by substituents selected from the group consisting of halogen, keto, C₁-C₆alkyl, C₁-C₆alkoxy, C₁-C₆alkyloximino and C₁-C₆alkylendioxy; and wherein the other substituents R₁, R₂, R₃, R₄, R₅ and R₆ are as defined in claim 1, and their use as microbicides.

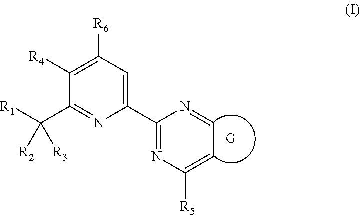

The present invention relates to novel microbiocidally active, in particular fungicidally active, 2-(pyridin-2-yl)-pyrimidines. It further relates to compositions which comprise these compounds and to their use in agriculture or horticulture for controlling or preventing infestation of plants by phytopathogenic microorganisms, preferably fungi.

Fungicidally active 2-(pyridin-2-yl)-pyrimidines are described in WO 2006/010570 and WO 2007/116079. The disclosed compounds are characterised by an aryl substituent in pyridine position 6.

It has been found now that novel 2-(pyridin-2-yl)-pyrimidines with an aliphatic substituent in position 6 of the pyridine ring, e.g. a benzyl or a pyridylmethyl group, have increased microbicidal activity.

The present invention accordingly relates to compounds of formula (I)

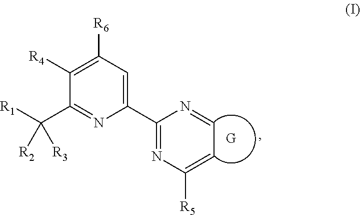

wherein
G represents together with the two carbon atoms of the pyrimidine ring to which it is attached, a 5- to 8-membered alicyclic or non aromatic heterocyclic ring system which is mono or bicyclic and contains 0 to 2 heteroatoms selected from the group consisting of nitrogen, oxygen and sulfur; and wherein said 5- to 8-membered alicyclic or non aromatic heterocyclic ring system can be mono-, di- or trisubstituted by substituents selected from the group consisting of halogen, hydroxyl, keto, C₁-C₆alkyl, C₁-C₆haloalkyl, C₁-C₆alkoxy, C₁-C₆haloalkoxy, C₁-C₆alkoxy-C₁-C₆alkyl, C₁-C₆alkyloximino and C₁-C₆alkylendioxy;
R₁ is aryl or heteroaryl, which can be mono-, di- or trisubstituted by substituents selected from the group consisting of -halogen, hydroxy, cyano, nitro, formyl, C₁-C₆alkyl, C₂-C₆alkenyl, C₂-C₆alkynyl, C₃-C₆cycloalkyl, C₁-C₆haloalkyl, C₂-C₆haloalkenyl, C₂-C₆haloalkynyl, C₃-C₆halocycloalkyl, C₁-C₆alkoxy, C₁-C₆alkoxy-C₁-C₆alkyl, C₁-C₆alkoxy-C₁-C₆alkoxy, C₁-C₆alkoxy-C₁-C₆alkoxy-C₁-C₆alkyl, C₁-C₆alkoxy-C₁-C₆alkylthio, C₁-C₆alkylthio-C₁-C₆alkoxy, C₁-C₆haloalkoxy, C₁-C₆alkylthio, C₁-C₆haloalkylthio, C₁-C₆alkylsulfinyl, C₁-C₆alkylsulfonyl, C₁-C₆alkylamino, diC₁-C₆alkylamino, C₃-C₆cycloalkylamino, (C₁-C₆alkyl)(C₃-C₆cycloalkyl)amino, diC₃-C₆cycloalkylamino, C₁-C₆alkylcarbonyl, C₁-C₆alkoxycarbonyl, C₁-C₆alkylaminocarbonyl, diC₁-C₆alkylaminocarbonyl, C₁-C₆alkoxycarbonyloxy, C₁-C₆alkylaminocarbonyloxy, diC₁-C₆alkylaminocarbonyloxy, C₁-C₆alkylcarbonyloxy, C₁-C₆alkylcarbonylamino, C₁-C₆alkylcarbonyl-C₁-C₆alkylamino, C₁-C₆alkoxyimino, C₁-C₆alkoxyimino-C₁-C₆alkyl, triC₁₋₆alkylsilyl, C₁-C₆alkoxy-C₂-C₆alkynyl, C₁-C₆alkoxyimino-C₂-C₆alkynyl, C₁-C₆alkylthio-C₂-C₆alkynyl, hydroxy-C₂-C₆alkynyl, C₁-C₆alkylthio-C₁-C₆alkyl or hydroxy-C₁-C₆alkyl;
R₂ and R₃ are, independently from each other, hydrogen, hydroxyl, halogen, C₁-C₆alkyl or C₆alkoxy; or
R₂ and R₃ together form a 3- to 5-membered aliphatic carbocyclic ring or a 3- to 5-membered heterocyclic ring containing up to two heteroatoms selected from O, S and N; or
R₂ and R₃ together form a carbonyl or a C₁-C₆ alkyloximino;
R₄ is hydrogen, halogen, cyano, C₁-C₆alkyl, C₁-C₆alkoxy or C₁-C₆alkylthio;
R₅ is hydrogen, hydroxy, halogen, C₁-C₆alkyl or C₁-C₆alkoxy; and
R₆ is hydrogen, halogen, C₁-C₆alkyl, C₁-C₆alkoxy or C₁-C₆alkylthio;
and agronomically acceptable salts, isomers, atropisomers, structural isomers, stereoisomers, diastereoisomers, enantiomers, tautomers and N-oxides of those compounds;
with the proviso that when G is an unsubstituted 5 or 6 membered monocyclic alicyclic ring, and R₂ and R₃ are, independently from each other, hydrogen, C₁-C₄alkyl then R₁ cannot be phenyl or substituted phenyl.

The invention covers all agronomically acceptable salts, isomers, atropisomers, structural isomers, stereoisomers, diastereoisomers, enantiomers, tautomers and N-oxides of those compounds. This invention covers all such isomers and tautomers and mixtures thereof in all proportions as well as isotopic forms such as deuterated compounds. Also atropisomerism may occur as a result of a restricted rotation about a single bond.

The alkyl groups occurring in the definitions of the substituents can be straight-chain or branched and are, for example, methyl, ethyl, n-propyl, n-butyl, n-pentyl, n-hexyl, iso-propyl, n-butyl, sec-butyl, iso-butyl or tert-butyl. Alkoxy, alkenyl and alkynyl radicals are derived from the alkyl radicals mentioned. The alkenyl and alkynyl groups can be mono- or di-unsaturated. The cycloalkyl groups are, for example, cyclopropyl, cyclobutyl, cyclopentyl or cyclohexyl. Halogen is generally fluorine, chlorine, bromine or iodine, preferably fluorine, bromine or chlorine more preferably chlorine or fluorine. This also applies, correspondingly, to halogen in combination with other meanings, such as halogenalkyl or halogenalkoxy. Haloalkyl groups preferably have a chain length of from 1 to 4 carbon atoms. Haloalkyl is, for example, fluoromethyl, difluoromethyl, trifluoromethyl, chloromethyl, dichloromethyl, trichloromethyl, 2,2,2-trifluoroethyl, 2-fluoroethyl, 2-chloroethyl, pentafluoroethyl, 1,1-difluoro-2,2,2-trichloroethyl, 2,2,3,3-tetrafluoroethyl and 2,2,2-trichloroethyl; preferably trichloromethyl, difluorochloromethyl, difluoromethyl, trifluoromethyl and dichlorofluoromethyl. Alkoxy is, for example, methoxy, ethoxy, propoxy, i-propoxy, n-butoxy, isobutoxy, sec-butoxy and tert-butoxy; preferably methoxy and ethoxy. Halogenalkoxy is, for example, fluoromethoxy, difluoromethoxy, trifluoromethoxy, 2,2,2-trifluoroethoxy, 1,1,2,2-tetrafluoroethoxy, 2-fluoroethoxy, 2-chloroethoxy, 2,2-difluoroethoxy and 2,2,2-trichloroethoxy; preferably difluoromethoxy, 2-chloroethoxy and trifluoromethoxy. Thioalkyl is, for example, methylthio, ethylthio, propylthio, tert-butylthio, hexylthio. Alkylamino is, for example, methylamino, ethylamino, propylamino, tert-butylamino, hexylamino as well as, for example dimethylamino, diethylamino, dipropylamino, ditert-butylamino, dihexylamino or trimethylamino, triethylamino, tripropylamino, tri tert-butylamino, trihexylamino or 2- to 3-fold substituted amines with different alkyl groups. The aryl and heteroaryl groups are, for example, phenyl, naphthyl, pyridyl, quinolinyl, pyridazinyl, cinnolinyl, pyrimidinyl, quinazolinyl, pyrazinyl, quinoxalinyl, thienyl, furyl, isoxazolyl, isothiazolyl, thiazoyl, oxazolyl, pyrazolyl, imidazolyl, pyrrolyl, oxadiazolyl, thiadiazolyl.

Preferably, when G is an unsubstituted 5 or 6 membered monocyclic alicyclic ring, and R₂ and R₃ are, independently from each other, hydrogen, C₁-C₆alkyl then R₁ cannot be phenyl or substituted phenyl.

Preferably the present invention relates to compounds of formula I wherein

G represents together with the two carbon atoms of the pyrimidine ring to which it is attached, a 5- to 8-membered alicyclic or non aromatic heterocyclic ring system which is mono or bicyclic and contains 0 to 2 heteroatoms selected from the group consisting of nitrogen, oxygen and sulfur; and wherein said 5- to 8-membered alicyclic or non aromatic heterocyclic ring system can be mono-, di- or trisubstituted by substituents selected from the group consisting of halogen, hydroxyl, keto, C₁-C₆alkyl, C₁-C₆haloalkyl, C₁-C₆alkoxy, C₁-C₆haloalkoxy, C₁-C₆alkoxy-C₁-C₆alkyl, C₁-C₆alkyloximino and C₁-C₆alkylendioxy;
R₁ is aryl or heteroaryl, which can be mono-, di- or trisubstituted by substituents selected from the group consisting of halogen, hydroxy, nitro, cyano, C₁-C₆alkyl, C₁-C₆haloalkyl, C₃-C₇cycloalkyl, C₁-C₆alkoxy, C₁-C₆haloalkoxy, C₁-C₆alkoxy-C₁-C₆alkyl, C₁-C₆alkoxy-C₁-C₆alkoxy, C₁-C₆alkylthio, C₁-C₆haloalkylthio, C₁-C₆alkylthioalkyl, C₁-C₆monoalkylamino, C₁-C₆dialkylamino;
R₂ and R₃ are, independently from each other, hydrogen, hydroxyl, halogen, C₁-C₆alkyl or C₁-C₆alkoxy; or
R₂ and R₃ together form a 3- to 5-membered aliphatic carbocyclic ring; or
R₂ and R₃ together form a carbonyl or a C₁-C₆alkyloximino;
R₄ is hydrogen, halogen, cyano, C₁-C₆alkyl, C₁-C₆alkoxy or C₁-C₆alkylthio; and
R₅ is hydrogen, hydroxy, halogen, C₁-C₆alkyl or C₁-C₆alkoxy;
R₆ is hydrogen, halogen, C₁-C₆alkyl, C₁-C₆alkoxy or C₁-C₆alkylthio;

In a further embodiment

G represents together with the two carbon atoms of the pyrimidine ring to which it is attached, a 5- to 8-membered alicyclic or non aromatic heterocyclic ring system which is mono or bicyclic and contains 0 to 2 heteroatoms selected from the group consisting of nitrogen, oxygen and sulfur; and wherein said 5- to 8-membered alicyclic or non aromatic heterocyclic ring system can be mono-, di- or trisubstituted by substituents selected from the group consisting of halogen, hydroxyl, keto, C₁-C₆alkyl, C₁-C₆haloalkyl, C₁-C₆alkoxy, C₁-C₆haloalkoxy, C₁-C₆alkoxy-C₁-C₆alkyl, C₁-C₆alkyloximino and C₁-C₆alkylendioxy;
R₁ is aryl or heteroaryl, which can be mono-, di- or trisubstituted by substituents selected from the group consisting of -halogen, hydroxy, cyano, nitro, formyl, C₁-C₆alkyl, C₂-C₆alkenyl, C₂-C₆alkynyl, C₃-C₆cycloalkyl, C₁-C₆haloalkyl, C₂-C₆haloalkenyl, C₂-C₆haloalkynyl, C₃-C₆halocycloalkyl, C₁-C₆alkoxy, C₁-C₆alkoxy-C₁-C₆alkyl, C₁-C₆alkoxy-C₁-C₆alkoxy, C₁-C₆alkoxy-C₁-C₆alkoxy-C₁-C₆alkyl, C₁-C₆alkoxy-C₁-C₆alkylthio, C₁-C₆alkylthio-C₁-C₆alkoxy, C₁-C₆haloalkoxy, C₁-C₆alkylthio, C₁-C₆haloalkylthio, C₁-C₆alkylsulfinyl, C₁-C₆alkylsulfonyl, C₁-C₆alkylamino, diC₁-C₆alkylamino, C₃-C₆cycloalkylamino, (C₁-C₆alkyl)(C₃-C₆cycloalkyl)amino, diC₃-C₆cycloalkylamino, C₁-C₆alkylcarbonyl, C₁-C₆alkoxycarbonyl, C₁-C₆alkylaminocarbonyl, diC₁-C₆alkylaminocarbonyl, C₁-C₆alkoxycarbonyloxy, C₁-C₆alkylaminocarbonyloxy, diC₁-C₆alkylaminocarbonyloxy, C₁-C₆alkylcarbonyloxy, C₁-C₆alkylcarbonylamino, C₁-C₆alkylcarbonyl-C₁-C₆alkylamino, C₁-C₆alkoxyimino, C₁-C₆alkoxyimino-C₁-C₆alkyl, triC₁₋₆alkylsilyl, C₁-C₆alkoxy-C₂-C₆alkynyl, C₁-C₆alkoxyimino-C₂-C₆alkynyl, C₁-C₆alkylthio-C₂-C₆alkynyl, hydroxy-C₂-C₆alkynyl, C₁-C₆alkylthio-C₁-C₆alkyl or hydroxy-C₁-C₆alkyl;
R₂ and R₃ are, independently from each other, hydrogen, hydroxyl, halogen, C₁-C₆alkyl or C₁-C₆alkoxy; or
R₂ and R₃ together form a 3- to 5-membered aliphatic carbocyclic ring or a 3- to 5-membered heterocyclic ring containing up to two heteroatoms selected from O, S and N; or
R₄ is hydrogen, halogen, cyano, C₁-C₆alkyl, C₁-C₆alkoxy or C₁-C₆alkylthio;
R₅ is hydrogen, hydroxy, halogen, C₁-C₆alkyl or C₁-C₆alkoxy; and
R₆ is hydrogen, halogen, C₁-C₆alkyl, C₁-C₆alkoxy or C₁-C₆alkylthio;
and agronomically acceptable salts, isomers, atropisomers, structural isomers, stereoisomers, diastereoisomers, enantiomers, tautomers and N-oxides of those compounds;
when G is an unsubstituted 5 or 6 membered monocyclic alicyclic ring, and R₂ and R₃ are, independently from each other, hydrogen, C₁-C₄alkyl then R₁ cannot be phenyl or substituted phenyl.

And in a further more preferred embodiment

G represents together with the two carbon atoms of the pyrimidine ring to which it is attached, a 5- to 8-membered alicyclic or non aromatic heterocyclic ring system which is mono or bicyclic and contains 0 to 2 heteroatoms selected from the group consisting of nitrogen, oxygen and sulfur; and wherein said 5- to 8-membered alicyclic or non aromatic heterocyclic ring system can be mono-, di- or trisubstituted by substituents selected from the group consisting of halogen, hydroxyl, keto, C₁-C₆alkyl, C₁-C₆haloalkyl, C₁-C₆alkoxy, C₁-C₆haloalkoxy, C₁-C₆alkoxy-C₁-C₆alkyl, C₁-C₆alkyloximino and C₁-C₆alkylendioxy;
R₁ is aryl or heteroaryl, which can be mono-, di- or trisubstituted by substituents selected from the group consisting of -halogen, hydroxy, cyano, nitro, formyl, C₁-C₆alkyl, C₂-C₆alkenyl, C₂-C₆alkynyl, C₃-C₆cycloalkyl, C₁-C₆haloalkyl, C₂-C₆haloalkenyl, C₂-C₆haloalkynyl, C₃-C₆halocycloalkyl, C₁-C₆alkoxy, C₁-C₆alkoxy-C₁-C₆alkyl, C₁-C₆alkoxy-C₁-C₆alkoxy, C₁-C₆alkoxy-C₁-C₆alkoxy-C₁-C₆alkyl, C₁-C₆alkoxy-C₁-C₆alkylthio, C₁-C₆alkylthio-C₁-C₆alkoxy, C₁-C₆haloalkoxy, C₁-C₆alkylthio, C₁-C₆haloalkylthio, C₁-C₆alkylsulfinyl, C₁-C₆alkylsulfonyl, C₁-C₆alkylamino, diC₁-C₆alkylamino, C₃-C₆cycloalkylamino, (C₁-C₆alkyl)(C₃-C₆cycloalkyl)amino, diC₃-C₆cycloalkylamino, C₁-C₆alkylcarbonyl, C₁-C₆alkoxycarbonyl, C₁-C₆alkylaminocarbonyl, diC₁-C₆alkylaminocarbonyl, C₁-C₆alkoxycarbonyloxy, C₁-C₆alkylaminocarbonyloxy, diC₁-C₆alkylaminocarbonyloxy, C₁-C₆alkylcarbonyloxy, C₁-C₆alkylcarbonylamino, C₁-C₆alkylcarbonyl-C₁-C₆alkylamino, C₁-C₆alkoxyimino, C₁-C₆alkoxyimino-C₁-C₆alkyl, triC₁₋₆alkylsilyl, C₁-C₆alkoxy-C₂-C₆alkynyl, C₁-C₆alkoxyimino-C₂-C₆alkynyl, C₁-C₆alkylthio-C₂-C₆alkynyl, hydroxy-C₂-C₆alkynyl, C₁-C₆alkylthio-C₁-C₆alkyl or hydroxy-C₁-C₆alkyl;
R₂ and R₃ are, independently from each other, hydrogen, hydroxyl, halogen, C₁-C₆alkyl or C₁-C₆alkoxy; or
R₂ and R₃ together form a 3- to 5-membered aliphatic carbocyclic ring
R₄ is hydrogen, halogen, cyano, C₁-C₆alkyl, C₁-C₆alkoxy or C₁-C₆alkylthio;
R₅ is hydrogen, hydroxy, halogen, C₁-C₆alkyl or C₁-C₆alkoxy; and
R₆ is hydrogen, halogen, C₁-C₆alkyl, C₁-C₆alkoxy or C₁-C₆alkylthio;
and agronomically acceptable salts, isomers, atropisomers, structural isomers, stereoisomers, diastereoisomers, enantiomers, tautomers and N-oxides of those compounds;
when G is an unsubstituted 5 or 6 membered monocyclic alicyclic ring, and R₂ and R₃ are, independently from each other, hydrogen, C₁-C₄alkyl then R₁ cannot be phenyl or substituted phenyl.

More preferably the present invention relates to compounds of formula I wherein

G represents together with the two carbon atoms of the pyrimidine ring to which it is attached, a 5- to 8-membered alicyclic or non aromatic heterocyclic ring system which is mono or bicyclic and contains 0 to 2 heteroatoms selected from the group consisting of nitrogen, oxygen and sulfur; and wherein said 5- to 8-membered alicyclic or non aromatic heterocyclic ring system can be mono-, di- or trisubstituted by substituents selected from the group consisting of halogen, keto, C₁-C₆alkyl, C₁-C₆alkoxy, C₁-C₆alkyloximino and C₁-C₆alkylendioxy;
R₁ is aryl or heteroaryl, which can be mono-, di- or trisubstituted by substituents selected from the group consisting of halogen, hydroxy, nitro, cyano, C₁-C₆alkyl, C₁-C₆haloalkyl, C₃-C₇cycloalkyl, C₁-C₆alkoxy, C₁-C₆haloalkoxy, C₁-C₆alkoxy-C₁-C₆alkyl, C₁-C₆alkoxy-C₁-C₆alkoxy, C₁-C₆alkylthio, C₁-C₆haloalkylthio, C₁-C₆alkylthioalkyl, C₁-C₆monoalkylamino, C₁-C₆dialkylamino, R₂ and R₃ are, independently from each other, hydrogen, hydroxyl, halogen, C₁-C₆alkyl or C₁-C₆alkoxy;
R₄ is hydrogen, halogen, cyano, C₁-C₆alkyl, C₁-C₆alkoxy or C₁-C₆alkylthio; and
R₅ is hydrogen, hydroxy, halogen, C₁-C₆alkyl or C₁-C₆alkoxy;
R₆ is hydrogen, halogen, C₁-C₆alkyl, C₁-C₆alkoxy or C₁-C₆alkylthio;
and agronomically acceptable salts, isomers, atropisomers, structural isomers, stereoisomers, diastereoisomers, enantiomers, tautomers and N-oxides of those compounds;
when G is an unsubstituted 5 or 6 membered monocyclic alicyclic ring, and R₂ and R₃ are, independently from each other, hydrogen, C₁-C₄alkyl then R₁ cannot be phenyl or substituted phenyl.

Examples for G which represents together with the two carbon atoms of the pyrimidine ring to which it is attached, a 5- to 7-membered aliphatic carbocyclic or heterocyclic ring system which contains 0 to 2 heteroatoms selected from the group consisting of nitrogen, oxygen and sulfur are cyclopentane, tetrahydrofurane, tetrahydrothiophene, cyclohexane, tetrahydropyrane, 2,2,1-bicycloheptane, 2,2,2-bicyclooctane or cycloheptane.

Preferred ringsystems for the compounds of formula (I) formed by the pyrimidine ring together with the substituent G are selected from the group consisting of

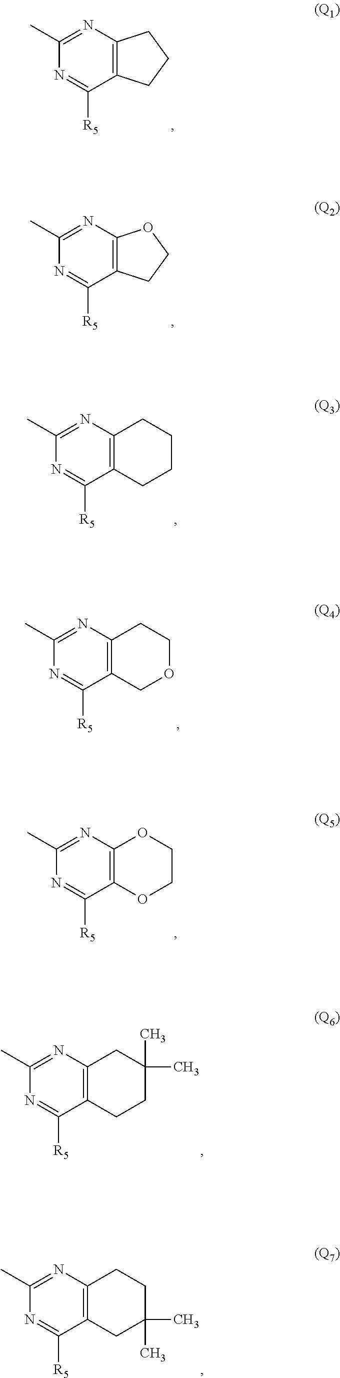

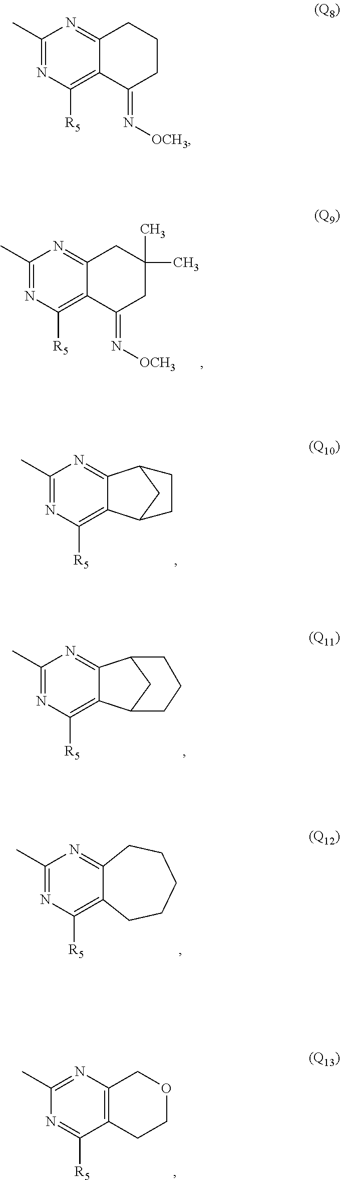

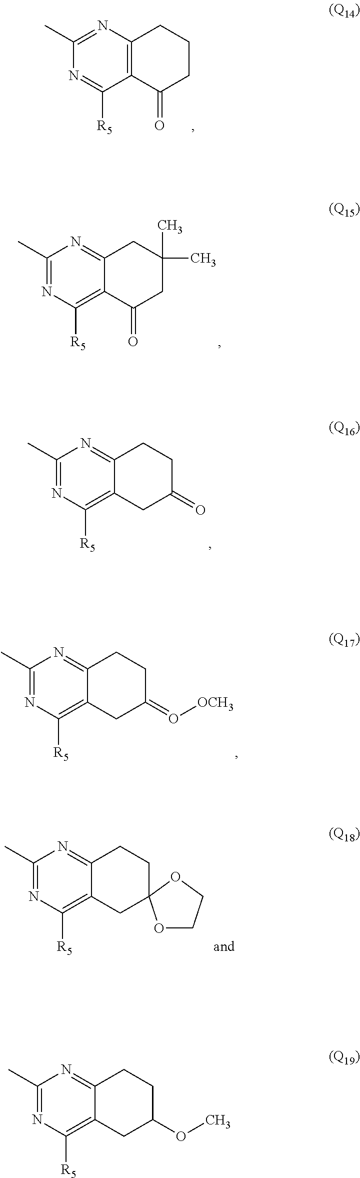

wherein R₅ has the meaning as defined for formula I above, in particular hydrogen, hydroxy, halogen, C₁-C₆alkyl or C₁-C₆alkoxy. Especially preferred ringsystems are Q₃, Q₄, Q₆, Q₁₂ and Q₁₉.

As an example in Q₁₁ G signifies a 8 membered alicyclic ring system which is bicyclic.

Preferably aryl is phenyl which can be mono-, di- or trisubstituted by substituents selected from the group consisting of halogen, C₁-C₄alkyl, C₁-C₆haloalkyl, C₁-C₄alkoxy, C₁-C₆alkoxy-C₁-C₆alkoxy, C₁-C₄alkylthio and C₁-C₆haloalkoxy.

Preferably heteroarylaryl is pyridyl or thienyl which can be mono-, di- or trisubstituted by substituents selected from the group consisting of halogen, C₁-C₄alkyl, C₁-C₆haloalkyl, C₁-C₄alkoxy, C₁-C₆alkoxy-C₁-C₆alkoxy, C₁-C₄alkylthio and C₁-C₆haloalkoxy.

In a preferred embodiment of the invention, R₁ is aryl which can be mono-, di- or trisubstituted by substituents selected from the group consisting of halogen, C₁-C₄alkyl, C₁-C₆haloalkyl, C₁-C₄alkoxy and C₁-C₄alkylthio.

In a preferred group of compounds of formula I, R₁ is phenyl, pyridyl or thienyl which can be mono-, di- or trisubstituted by substituents selected from the group consisting of halogen, C₁-C₄alkyl, C₁-C₆haloalkyl, C₁-C₄alkylthio and C₁-C₄alkoxy.

Preferably the pyridyl substituent is pyrid-2-yl or pyrid-3-yl. Preferably the thienyl substituent is thien-2-yl or thien-3-yl

R₁ is phenyl, naphthyl, pyridyl, quinolinyl, pyridazinyl, cinnolinyl, pyrimidinyl, quinazolinyl, pyrazinyl, quinoxalinyl, thienyl, furyl, isoxazolyl, isothiazolyl, thiazoyl, oxazolyl, pyrazolyl, imidazolyl, pyrrolyl, oxadiazolyl, thiadiazolyl which can be mono- or disubstituted by substituents selected from halogen, C₁-C₄alkyl, C₁-C₄haloalkyl, C₁-C₄alkylthio or C₁-C₄alkoxy;

More preferably R₁ is phenyl, pyridyl or thienly which can be optionally mono- or disubstituted substituted by halogen, C₁-C₄alkyl, C₁-C₄haloalkyl, C₁-C₄alkylthio or C₁-C₄alkoxy preferably by halogen, methyl, trihaloalkyl, methylthio or methoxy.

Preferrably R₂ and R₃ are, independently from each other, hydrogen, hydroxyl, halogen, C₁-C₆alkyl or C₁-C₆alkoxy or R₂ and R₃ together form a 3- to 5-membered aliphatic carbocyclic ring or a 3- to 5-membered heterocyclic ring containing up to two heteroatoms selected from O, S and N;

more preferred R₂ and R₃ are, independently from each other, hydrogen, hydroxyl, halogen, C₁-C₆alkyl or C₁-C₆alkoxy or R₂ and R₃ together form a 3- to 5-membered aliphatic carbocyclic ring;
even more preferred R₂ and R₃ are, independently from each other, hydrogen, hydroxyl, halogen, C₁-C₆alkyl or C₁-C₆alkoxy

When R₂ and R₃ together form a 3- to 5-membered aliphatic carbocyclic ring the 3-membered ring is preferred.

In a further preferred group of compounds of formula I,

R₁ is phenyl, naphthyl, pyridyl, quinolinyl, pyridazinyl, cinnolinyl, pyrimidinyl, quinazolinyl, pyrazinyl, quinoxalinyl, thienyl, furyl, isoxazolyl, isothiazolyl, thiazoyl, oxazolyl, pyrazolyl, imidazolyl, pyrrolyl, oxadiazolyl, thiadiazolyl which can be mono- or disubstituted by substituents selected from halogen, C₁-C₄alkyl, C₁-C₄haloalkyl, C₁-C₄alkylthio or C₁-C₄alkoxy;
R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen, C₁-C₄alkyl or C₁-C₄alkoxy.

Preferrably in the further preferred group of compounds of formula I,

R₁ is phenyl or pyridyl or thienyl which can be substituted by halogen, C₁-C₄alkyl, C₁-C₄alkylthio or C₁-C₄alkoxy;
R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen, C₁-C₄alkyl or C₁-C₄alkoxy.

More preferred in the further preferred group of compounds are compounds of formula I, R₁ is phenyl, pyridyl or thienyl which can be substituted by halogen, C₁-C₄alkyl or C₁-C₄alkoxy;

R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen.

Most preferred in the further preferred group of compounds are compounds of formula I, R₁ is phenyl which can be substituted by halogen, C₁-C₄alkyl or C₁-C₄alkoxy;

R₂ and R₃ are hydrogen or methyl;
R₄ is hydrogen or methyl;
R₅ is hydrogen or methyl; and
R₆ is hydrogen;

Further preferred embodiments of the present invention are the embodiments E1 to E19, which are defined as compounds of formula I which are represented by one formula selected from the group consisting of the formulae T1 to T19 as described below, wherein in formulae T1 to T19:

R₁ is phenyl, naphthyl, pyridyl, quinolinyl, pyridazinyl, cinnolinyl, pyrimidinyl, quinazolinyl, pyrazinyl, quinoxalinyl, thienyl, furyl, isoxazolyl, isothiazolyl, thiazoyl, oxazolyl, pyrazolyl, imidazolyl, pyrrolyl, oxadiazolyl, thiadiazolyl which can be mono- or disubstituted by substituents selected from halogen, C₁-C₄alkyl, C₁-C₄haloalkyl, C₁-C₄alkylthio or C₁-C₄alkoxy;

R₂ and R₃ are hydrogen or C₁-C₄alkyl;
R₄ is hydrogen, C₁-C₄alkyl or C₁-C₄alkoxy
R₅ is hydrogen, halogen or C₁-C₄alkyl; and
R₆ is hydrogen, C₁-C₄alkyl or C₁-C₄alkoxy.

Preferably R₁ is phenyl, pyridyl or thienyl which can be optionally mono- or disubstituted substituted by halogen, C₁-C₄alkyl, C₁-C₄haloalkyl, C₁-C₄alkylthio or C₁-C₄alkoxy preferably by halogen, methyl, trihaloalkyl, methylthio or methoxy.

For example, embodiment E1 is represented by the compounds of formula T1

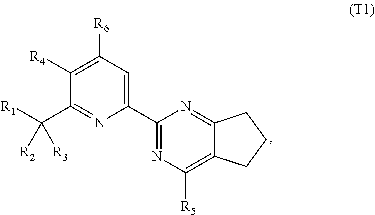

wherein
R₁ is phenyl, pyridyl or thienyl which can be substituted by halogen, C₁-C₄alkyl or C₁-C₄alkoxy;
R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen, C₁-C₄alkyl or C₁-C₄alkoxy.

The structure (T1) is defined by the compounds of formula (I) wherein the ringsystems formed by the pyrimidine ring together with the substituent G is the structure of Q₁. Likewise the structure (T2) is defined by the compounds of formula (I) wherein the ringsystems formed by the pyrimidine ring together with the substituent G is the structure of Q₂.

Embodiments E2 to E19 are defined accordingly. Preferred embodiments are embodiment E3, E4, E6, E12 and E19, in particular E3 and E12. Within said embodiments E1 to E19, the following meanings of the substituents are preferred:

R₁ is phenyl, pyridyl or thienyl which can be substituted by halogen, C₁-C₄alkyl or C₁-C₄alkoxy;
R₂ and R₃ are hydrogen or C₁-C₄alkyl;
R₄ is hydrogen, C₁-C₄alkyl or C₁-C₄alkoxy
R₅ is hydrogen, halogen or C₁-C₄alkyl; and
R₆ is hydrogen, C₁-C₄alkyl or C₁-C₄alkoxy.

Preferably R₆ is hydrogen, methyl or methoxy.

More preferred embodiments are embodiment E3, E4, E6, E12 and E19, in particular E3 and E12. Within said embodiments E1 to E19, the following meanings of the substituents are preferred:

R₁ is phenyl, pyridyl or thienyl which can be substituted by halogen, C₁-C₄alkyl or C₁-C₄alkoxy;
R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen

Within said embodiments E1 to E19, the following meanings of the substituents are more preferred:

R₁ is phenyl which can be substituted by halogen, C₁-C₄alkyl or C₁-C₄alkoxy;
R₂ and R₃ are hydrogen or C₁-C₄alkyl;
R₄ is hydrogen, C₁-C₄alkyl or C₁-C₄alkoxy
R₅ is hydrogen, halogen or C₁-C₄alkyl; and
R₆ is hydrogen.

Within said embodiments E1 to E19, the following meanings of the substitents are most preferred:

R₁ is phenyl which can be substituted by halogen, C₁-C₄alkyl or C₁-C₄alkoxy;
R₂ and R₃ are hydrogen or methyl;
R₄ is hydrogen or methyl;
R₅ is hydrogen or methyl; and
R₆ is hydrogen;

Compounds of formula I may be prepared as shown in the following schemes.

The compounds of formula I.1, wherein R₁, R₂, R₃, R₄, R₆ and G are as defined under formula I, can be obtained by transformation of a compound of formula II, wherein R₁, R₂, R₃ and R₄ are as defined under formula I, with a compound of formula III, wherein G is as defined under formula I and R₇ and R₈ are C₁-C₆alkyl, under basic conditions.

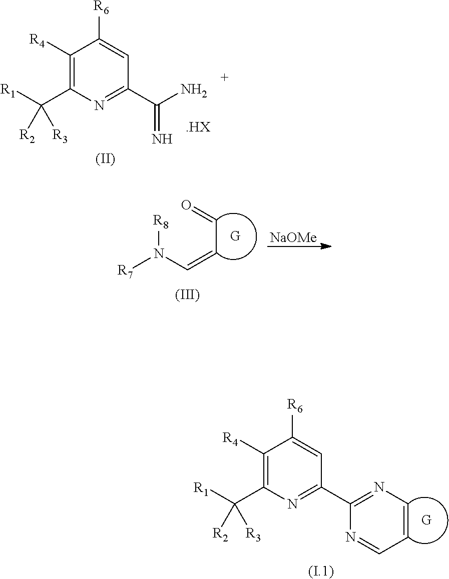

The compounds of formula II, wherein R₁, R₂, R₃, R₄ and R₆ are as defined under formula I can be obtained by transformation of a compound of formula IV, wherein R₁, R₂, R₃ and R₄ are as defined under formula I with a base and an ammonium salt.

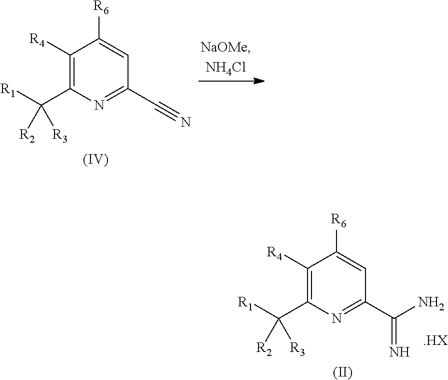

The compounds of formula IV, wherein R₁, R₂, R₃, R₄ and R₆ are as defined under formula I can be obtained by transformation of a compound of formula V, wherein R₁, R₂, R₃, R₄ and R₆ are as defined under formula I with a cyanide, such as sodium cyanide, potassium cyanide or trimethylsilylcyanide and a base, such as triethylamine, ethyldiisopropylamine or pyridine.

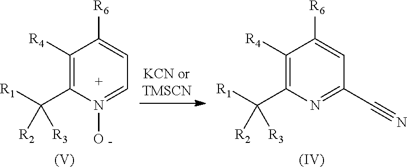

The compounds of formula V, wherein R₁, R₂, R₃, R₄ and R₆ are as defined under formula I, can be obtained by transformation of a compound of formula VI, wherein R₁, R₂, R₃ and R₄ are as defined under formula I, with an oxidatizing agent, such as meta-chloroperbenzoic acid, hydrogen peroxide or oxone.

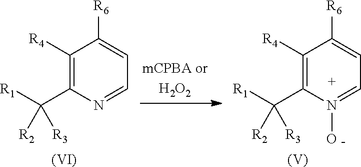

The mono- and disubstituted pyridines of formula VI are known compounds or may be obtained readily from known compounds using processes that are routine in the art and with which the skilled man will be familiar.

The compounds of formula III, wherein G is as defined under formula I and R₇ and R₈ are C₁-C₆alkyl, can be obtained by transformation of a compound of formula VII, wherein G is as defined under formula I, with a bis(dialkylamino)tert-butoxymethane or with a N,N-dialkylformamide dialkyl acetal.

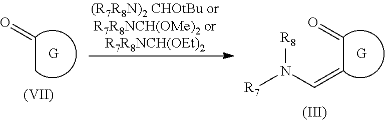

The ketones of formula VII are known compounds or may be obtained readily from known compounds using processes that are routine in the art and with which the skilled man will be familiar.

Alternatively, the compounds of formula I.1, wherein R₁, R₂, R₃, R₄, R₆ and G are as defined under formula I, can be obtained by transformation of a compound of formula VIII, wherein R₄ and G are as defined under formula I and Hal is halogen, preferably chloro, bromo or iodo, with a compound of formula IX, wherein R₁, R₂ and R₃ as defined under formula I and R₉ is In, MgCl, MgBr, Sn(R₁₀)₃, ZnCl, ZnBr or B(OR₁₀)₂, wherein either R₁₀ is independently from each other hydrogen, C₁-C₆alkyl or wherein two R₁₀ together can form a C₃-C₈cycloalkyl, and a catalyst, such as tetrakistriphenylphosphinepalladium, palladium dichloride, [1,1-bis(diphenylphosphino) ferrocene]dichloropalladium(II), palladium acetate or bis(diphenylphosphine)palladium(II) chloride.

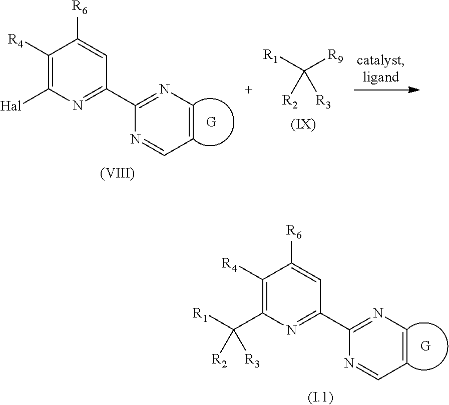

The compounds of formula VIII, wherein R₄ and G are as defined under formula I and Hal is halogen, preferably chloro, bromo or iodo, can be obtained by transformation of a compound of formula X, wherein R₄ is as defined under formula I and Hal is halogen, preferably chloro, bromo or iodo, with a compound of formula III, wherein G is as defined under formula I and R₇ and R₈ are C₁-C₆alkyl under basic conditions.

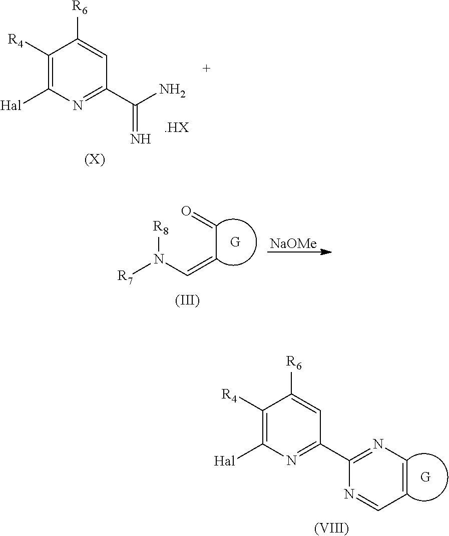

The compounds of formula X, wherein R₄ is as defined under formula I and Hal is halogen, preferably chloro, bromo or iodo, can be obtained by transformation of a compound of formula XI, wherein R₄ is as defined under formula I and Hal is halogen, preferably chloro, bromo or iodo, with a base and an ammonium salt.

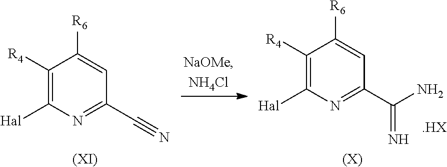

The compounds of formula XI, wherein R₄ is as defined under formula I and Hal is halogen, preferably chloro, bromo or iodo, can be obtained by transformation of a compound of formula XII, wherein R₄ is as defined under formula I and Hal is halogen, preferably chloro, bromo or iodo, with a cyanide, such as sodium cyanide, potassium cyanide or trimethylsilylcyanide and a base, such as triethylamine, ethyldiisopropylamine or pyridine.

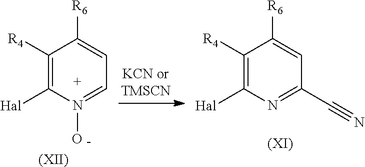

The compounds of formula XII, wherein R₄ is as defined under formula I and Hal is halogen, preferably chloro, bromo or iodo, can be obtained by transformation of a compound of formula XIII, wherein R₄ is as defined under formula I and Hal is halogen, preferably chloro, bromo or iodo, with an oxidatizing agent, such as meta-chloroperbenzoic acid, hydrogen peroxide or oxone.

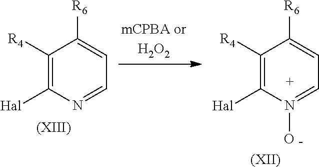

The mono- and disubstituted pyridines of formula XIII are known compounds or may be obtained readily from known compounds using processes that are routine in the art and with which the skilled man will be familiar.

Alternatively, the compounds of formula I, wherein R₁, R₂, R₃, R₄, R₅ and R₆ are as defined under formula I, can be obtained by transformation of a compound of formula XIV, wherein R₁, R₂, R₃ and R₄ are as defined under formula I and R₉ is In, MgCl, MgBr, Sn(R₁₀)₃, ZnCl, ZnBr or B(OR₁₀)₂, wherein either R₁₀ is independently from each other hydrogen, C₁-C₆alkyl or wherein two R₁₀ together can form a C₃-C₈cycloalkyl, with a compound of formula XV, wherein R₅ is as defined under formula I and Hal is a halogen, preferably chloro, bromo or iodo, and a catalyst, such as tetrakistriphenylphosphinepalladium, palladium dichloride, [1,1-bis(diphenylphosphino) ferrocene]dichloropalladium(II), palladium acetate or bis(diphenylphosphine)palladium(II) chloride.

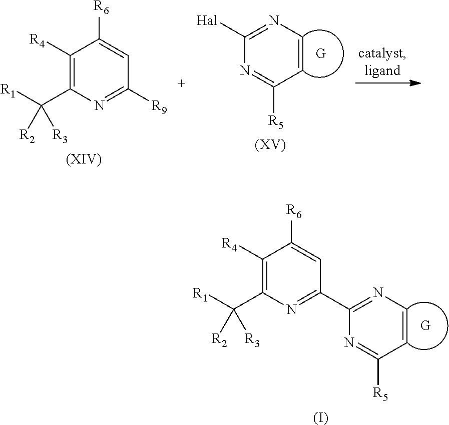

The metallo-substituted pyridines of formula XIV and the 2-halopyrimidines of formula XV are known compounds or may be obtained readily from known compounds using processes that are routine in the art and with which the skilled man will be familiar.

Alternatively, the compounds of formula I, wherein R₁, R₂, R₃, R₄ and R₅ are as defined under formula I, can be obtained by transformation of a compound of formula XVI, wherein R₁, R₂, R₃ and R₄ are as defined under formula I and Hal is a halogen, preferably chloro, bromo or iodo, with a compound of formula XVII, wherein R₅ is as defined under formula I and R₉ is In, MgCl, MgBr, Sn(R₁₀)₃, ZnCl, ZnBr or B(OR₁₀)₂, wherein either R₁₀ is independently from each other hydrogen, C₁-C₆alkyl or wherein two R₁₀ together can form a C₃-C₈cycloalkyl, and a catalyst, such as tetrakistriphenylphosphinepalladium, palladium dichloride, [1,1-bis(diphenylphosphino) ferrocene]dichloropalladium(II), palladium acetate or bis(diphenylphosphine)palladium(II) chloride.

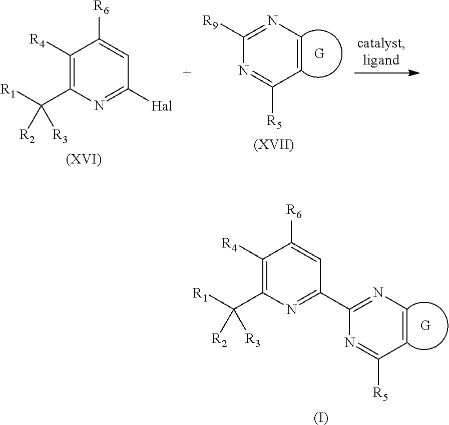

The di- and tri-substituted pyridines of formula XVI and the 2-metallo-substituted pyrimidines of formula XVII are known compounds or may be obtained readily from known compounds using processes that are routine in the art and with which the skilled man will be familiar.

The reactions to give compounds of formula I are advantageously carried out in aprotic inert organic solvents. Such solvents are hydrocarbons such as benzene, toluene, xylene or cyclohexane, chlorinated hydrocarbons such as dichloromethane, trichloromethane, tetrachloromethane or chlorobenzene, ethers such as diethyl ether, ethylene glycol dimethyl ether, diethylene glycol dimethyl ether, tetrahydrofuran or dioxane, nitriles such as acetonitrile or propionitrile, amides such as N,N-dimethylformamide, diethylformamide or N-methylpyrrolidinone. The reaction temperatures are advantageously between −20° C. and +120° C. In general, the reactions are slightly exothermic and, as a rule, they can be carried out at ambient temperature. To shorten the reaction time, or else to start the reaction, the mixture may be heated briefly to the boiling point of the reaction mixture. The reaction times can also be shortened by adding a few drops of base as reaction catalyst. Suitable bases are, in particular, tertiary amines such as trimethylamine, triethylamine, quinuclidine, 1,4-diazabicyclo[2.2.2]octane, 1,5-diazabicyclo[4.3.0]non-5-ene or 1,5-diazabicyclo-[5.4.0]undec-7-ene. However, inorganic bases such as hydrides, e.g. sodium hydride or calcium hydride, hydroxides, e.g. sodium hydroxide or potassium hydroxide, carbonates such as sodium carbonate and potassium carbonate, or hydrogen carbonates such as potassium hydrogen carbonate and sodium hydrogen carbonate may also be used as bases. The bases can be used as such or else with catalytic amounts of a phase-transfer catalyst, for example a crown ether, in particular 18-crown-6, or a tetraalkylammonium salt.

The compounds of formula I and, where appropriate, the tautomers thereof, can, if appropriate, also be obtained in the form of hydrates and/or include other solvents, for example those which may have been used for the crystallization of compounds which are present in solid form.

It has now been found that the compounds of formula I according to the invention have, for practical purposes, a very advantageous spectrum of activities for protecting useful plants against diseases that are caused by phytopathogenic microorganisms, such as fungi, bacteria or viruses.

The invention therefore also relates to a method of controlling or preventing infestation of useful plants by phytopathogenic microorganisms, wherein a compound of formula I is applied as active ingredient to the plants, to parts thereof or the locus thereof. The compounds of formula I according to the invention are distinguished by excellent activity at low rates of application, by being well tolerated by plants and by being environmentally safe. They have very useful curative, preventive and systemic properties and are used for protecting numerous useful plants. The compounds of formula I can be used to inhibit or destroy the diseases that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula I as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore, the compounds of formula I according to the invention may be used for controlling fungi in related areas, for example in the protection of technical materials, including wood and wood related technical products, in food storage or in hygiene management.

The compounds of formula I are, for example, effective against the phytopathogenic fungi of the following classes: Fungi imperfecti (e.g. Botrytis, Pyricularia, Helminthosporium, Fusarium, Septoria, Cercospora and Alternaria) and Basidiomycetes (e.g. Rhizoctonia, Hemileia, Puccinia). Additionally, they are also effective against the Ascomycetes classes (e.g. Venturia and Erysiphe, Podosphaera, Monilinia, Uncinula) and of the Oomycetes classes (e.g. Phytophthora, Pythium, Plasmopara). Furthermore, the novel compounds of formula I are effective against phytopathogenic bacteria and viruses (e.g. against Xanthomonas spp, Pseudomonas spp, Erwinia amylovora as well as against the tobacco mosaic virus). The compounds of formula I are also effective against Asian soybean rust (Phakopsora pachyrhizi).

Within the scope of the invention, useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucum-bers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® Agrisure® GT Advantage (GA21 glyphosate-tolerant trait), Agrisure® CB Advantage (Bt11 corn borer (CB) trait), Agrisure® RW (corn rootworm trait) and Protecta®.

The term “crops” is to be understood as including also crop plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins from Bacillus cereus or Bacillus popilliae; or insecticidal proteins from Bacillus thuringiensis, such as δ-endotoxins, e.g. Cry1Ab, Cry1Ac, Cry1F, Cry1Fa2, Cry2Ab, Cry3A, Cry3Bb1 or Cry9C, or vegetative insecticidal proteins (Vip), e.g. Vip1, Vip2, Vip3 or Vip3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsin inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example Cry1Ab, Cry1Ac, Cry1F, Cry1Fa2, Cry2Ab, Cry3A, Cry3Bb1 or Cry9C, or vegetative insecticidal proteins (Vip), for example Vip1, Vip2, Vip3 or Vip3A, expressly also hybrid toxins, truncated toxins and modified toxins. Hybrid toxins are produced recombinantly by a new combination of different domains of those proteins (see, for example, WO 02/15701). Truncated toxins, for example a truncated Cry1Ab, are known. In the case of modified toxins, one or more amino acids of the naturally occurring toxin are replaced. In such amino acid replacements, preferably non-naturally present protease recognition sequences are inserted into the toxin, such as, for example, in the case of Cry3A055, a cathepsin-G-recognition sequence is inserted into a Cry3A toxin (see WO 03/018810).

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a Cry1Ab toxin); YieldGard Rootworm® (maize variety that expresses a Cry3Bb1 toxin); YieldGard Plus® (maize variety that expresses a Cry1Ab and a Cry3Bb1 toxin); Starlink® (maize variety that expresses a Cry9C toxin); Herculex I® (maize variety that expresses a Cry1Fa2 toxin and the enzyme phosphinothricine N-acetyltransferase (PAT) to achieve tolerance to the herbicide glufosinate ammonium); NuCOTN 33B® (cotton variety that expresses a Cry1Ac toxin); Bollgard I® (cotton variety that expresses a Cry1Ac toxin); Bollgard II® (cotton variety that expresses a Cry1Ac and a Cry2Ab toxin); VipCot® (cotton variety that expresses a Vip3A and a Cry1Ab toxin); NewLeaf® (potato variety that expresses a Cry3A toxin); Nature-Gard®, Agrisure® GT Advantage (GA21 glyphosate-tolerant trait), Agrisure® CB Advantage (Bt11 corn borer (CB) trait) and Protecta®.

Further examples of such transgenic crops are:

1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated Cry1Ab toxin. Bt11 maize also transgenically expresses the enzyme PAT to achieve tolerance to the herbicide glufosinate ammonium.
2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a Cry1Ab toxin. Bt176 maize also transgenically expresses the enzyme PAT to achieve tolerance to the herbicide glufosinate ammonium.
3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified Cry3A toxin. This toxin is Cry3A055 modified by insertion of a cathepsin-G-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a Cry3Bb1 toxin and has resistance to certain Coleoptera insects.
5. IPC 531 Cotton from Monsanto Europe S.A. 270-272 Avenue de Tervuren, B-1150 Brussels, Belgium, registration number C/ES/96/02.
6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.
7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a Cry1Ab toxin obtained from Bacillus thuringiensis subsp. kurstaki which brings about tolerance to certain Lepidoptera, include the European corn borer.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula I can be used in unmodified form or, preferably, together with carriers and adjuvants conventionally employed in the art of formulation.

Therefore the invention also relates to compositions for controlling and protecting against phytopathogenic microorganisms, comprising a compound of formula I and an inert carrier, and to a method of controlling or preventing infestation of useful plants by phytopathogenic microorganisms, wherein a composition, comprising a compound of formula I as acitve ingredient and an inert carrier, is applied to the plants, to parts thereof or the locus thereof.

To this end compounds of formula I and inert carriers are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants (auxiliaries) can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The compounds of formula I or compositions, comprising a compound of formula I as acitve ingredient and an inert carrier, can be applied to the locus of the plant or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

A preferred method of applying a compound of formula I, or a composition, comprising a compound of formula I as active ingredient and an inert carrier, is foliar application. The frequency of application and the rate of application will depend on the risk of infestation by the corresponding pathogen. However, the compounds of formula I can also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula I may also be applied to seeds (coating) by impregnating the seeds or tubers either with a liquid formulation of the fungicide or coating them with a solid formulation.

A formulation, i.e. a composition comprising the compound of formula I and, if desired, a solid or liquid adjuvant or, if desired as well, a further, other biocidally active ingredient, is prepared in a known manner, typically by intimately mixing and/or grinding the compound with extenders, for example solvents, solid carriers and, optionally, surface-active compounds (surfactants).

The present invention relates additionally to mixtures comprising at least a compound of formula I and at least a further, other biocidally active ingredient and optionally further ingredients. The further, other biocidally active ingredient are known for example from “The Pesticide Manual” [The Pesticide Manual—A World Compendium; Thirteenth Edition (New edition (2 Nov. 2003)); Editor: C. D. S. Tomlin; The British Crop Protection Council, ISBN-10: 1901396134; ISBN-13: 978-1901396133] or its electronic version “e-Pesticide Manual V4.2” or from the website http://www.alanwood.net/pesticides/ or preferably one of the further pesticides listed below.

The following mixtures of the compounds of TX with a further active ingredient (B) are preferred (the abbreviation “TX” means “one compound selected from the group consisting of the compounds of formulae from the lines A.1.1 to A.1.215 described in Tables 1 to 57 of the present invention, thus the abbreviation “TX” means at least one compound selected from the compounds T.1.1.1 to T57.1.215 or selected at least one compound selected from the Table A1 (compound 1 to 46:
an adjuvant selected from the group of substances consisting of petroleum oils (alternative name) (628)+TX,
an acaricide selected from the group of substances consisting of 1,1-bis(4-chlorophenyl)-2-ethoxyethanol (IUPAC name) (910)+TX, 2,4-dichlorophenyl benzenesulfonate (IUPAC/Chemical Abstracts name) (1059)+TX, 2-fluoro-N-methyl-N-1-naphthylacetamide (IUPAC name) (1295)+TX, 4-chlorophenyl phenyl sulfone (IUPAC name) (981)+TX, abamectin (1)+TX, acequinocyl (3)+TX, acetoprole [CCN]+TX, acrinathrin (9)+TX, aldicarb (16)+TX, aldoxycarb (863)+TX, alpha-cypermethrin (202)+TX, amidithion (870)+TX, amidoflumet [CCN]+TX, amidothioate (872)+TX, amiton (875)+TX, amiton hydrogen oxalate (875)+TX, amitraz (24)+TX, aramite (881)+TX, arsenous oxide (882)+TX, AVI 382 (compound code)+TX, AZ 60541 (compound code)+TX, azinphos-ethyl (44)+TX, azinphos-methyl (45)+TX, azobenzene (IUPAC name) (888)+TX, azocyclotin (46)+TX, azothoate (889)+TX, benomyl (62)+TX, benoxafos (alternative name) [CCN]+TX, benzoximate (71)+TX, benzyl benzoate (IUPAC name) [CCN]+TX, bifenazate (74)+TX, bifenthrin (76)+TX, binapacryl (907)+TX, brofenvalerate (alternative name)+TX, bromo-cyclen (918)+TX, bromophos (920)+TX, bromophos-ethyl (921)+TX, bromopropylate (94)+TX, buprofezin (99)+TX, butocarboxim (103)+TX, butoxycarboxim (104)+TX, butylpyridaben (alternative name)+TX, calcium polysulfide (IUPAC name) (111)+TX, camphechlor (941)+TX, carbanolate (943)+TX, carbaryl (115)+TX, carbofuran (118)+TX, carbophenothion (947)+TX, CGA 50′439 (development code) (125)+TX, chino-methionat (126)+TX, chlorbenside (959)+TX, chlordimeform (964)+TX, chlordimeform hydrochloride (964)+TX, chlorfenapyr (130)+TX, chlorfenethol (968)+TX, chlorfenson (970)+TX, chlorfensulphide (971)+TX, chlorfenvinphos (131)+TX, chlorobenzilate (975)+TX, chloromebuform (977)+TX, chloromethiuron (978)+TX, chloropropylate (983)+TX, chlorpyrifos (145)+TX, chlorpyrifos-methyl (146)+TX, chlorthiophos (994)+TX, cinerin I (696)+TX, cinerin II (696)+TX, cinerins (696)+TX, clofentezine (158)+TX, closantel (alternative name) [CCN]+TX, coumaphos (174)+TX, crotamiton (alternative name) [CCN]+TX, crotoxyphos (1010)+TX, cufraneb (1013)+TX, cyanthoate (1020)+TX, cyflumetofen (CAS Reg. No.: 400882-07-7)+TX, cyhalothrin (196)+TX, cyhexatin (199)+TX, cypermethrin (201)+TX, DCPM (1032)+TX, DDT (219)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-5-methyl (224)+TX, demeton-5-methylsulphon (1039)+TX, diafen-thiuron (226)+TX, dialifos (1042)+TX, diazinon (227)+TX, dichlofluanid (230)+TX, dichlorvos (236)+TX, dicliphos (alternative name)+TX, dicofol (242)+TX, dicrotophos (243)+TX, dienochlor (1071)+TX, dimefox (1081)+TX, dimethoate (262)+TX, dinactin (alternative name) (653)+TX, dinex (1089)+TX, dinex-diclexine (1089)+TX, dinobuton (269)+TX, dinocap (270)+TX, dinocap-4 [CCN]+TX, dinocap-6 [CCN]+TX, dinocton (1090)+TX, dinopenton (1092)+TX, dinosulfon (1097)+TX, dinoterbon (1098)+TX, dioxathion (1102)+TX, diphenyl sulfone (IUPAC name) (1103)+TX, disulfuram (alternative name) [CCN]+TX, disulfoton (278)+TX, DNOC (282)+TX, dofenapyn (1113)+TX, doramectin (alternative name) [CCN]+TX, endosulfan (294)+TX, endothion (1121)+TX, EPN (297)+TX, eprinomectin (alternative name) [CCN]+TX, ethion (309)+TX, ethoate-methyl (1134)+TX, etoxazole (320)+TX, etrimfos (1142)+TX, fenazaflor (1147)+TX, fenazaquin (328)+TX, fenbutatin oxide (330)+TX, fenothiocarb (337)+TX, fenpropathrin (342)+TX, fenpyrad (alternative name)+TX, fenpyroximate (345)+TX, fenson (1157)+TX, fentrifanil (1161)+TX, fenvalerate (349)+TX, fipronil (354)+TX, fluacrypyrim (360)+TX, fluazuron (1166)+TX, flubenzimine (1167)+TX, flucycloxuron (366)+TX, flucythrinate (367)+TX, fluenetil (1169)+TX, flufenoxuron (370)+TX, flumethrin (372)+TX, fluorbenside (1174)+TX, fluvalinate (1184)+TX, FMC 1137 (development code) (1185)+TX, formetanate (405)+TX, formetanate hydrochloride (405)+TX, formothion (1192)+TX, formparanate (1193)+TX, gamma-HCH (430)+TX, glyodin (1205)+TX, halfenprox (424)+TX, heptenophos (432)+TX, hexadecyl cyclopropanecarboxylate (IUPAC/Chemical Abstracts name) (1216)+TX, hexythiazox (441)+TX, iodomethane (IUPAC name) (542)+TX, isocarbophos (alternative name) (473)+TX, isopropyl O-(methoxyaminothiophosphoryl)salicylate (IUPAC name) (473)+TX, ivermectin (alternative name) [CCN]+TX, jasmolin I (696)+TX, jasmolin II (696)+TX, jodfenphos (1248)+TX, lindane (430)+TX, lufenuron (490)+TX, malathion (492)+TX, malonoben (1254)+TX, mecarbam (502)+TX, mephosfolan (1261)+TX, mesulfen (alternative name) [CCN]+TX, methacrifos (1266)+TX, methamidophos (527)+TX, methidathion (529)+TX, methiocarb (530)+TX, methomyl (531)+TX, methyl bromide (537)+TX, metolcarb (550)+TX, mevinphos (556)+TX, mexacarbate (1290)+TX, milbemectin (557)+TX, milbemycin oxime (alternative name) [CCN]+TX, mipafox (1293)+TX, monocrotophos (561)+TX, morphothion (1300)+TX, moxidectin (alternative name) [CCN]+TX, naled (567)+TX, NC-184 (compound code)+TX, NC-512 (compound code)+TX, nifluridide (1309)+TX, nikkomycins (alternative name) [CCN]+TX, nitrilacarb (1313)+TX, nitrilacarb 1:1 zinc chloride complex (1313)+TX, NNI-0101 (compound code)+TX, NNI-0250 (compound code)+TX, omethoate (594)+TX, oxamyl (602)+TX, oxydeprofos (1324)+TX, oxydisulfoton (1325)+TX, pp′-DDT (219)+TX, parathion (615)+TX, permethrin (626)+TX, petroleum oils (alternative name) (628)+TX, phenkapton (1330)+TX, phenthoate (631)+TX, phorate (636)+TX, phosalone (637)+TX, phosfolan (1338)+TX, phosmet (638)+TX, phosphamidon (639)+TX, phoxim (642)+TX, pirimiphos-methyl (652)+TX, polychloroterpenes (traditional name) (1347)+TX, polynactins (alternative name) (653)+TX, proclonol (1350)+TX, profenofos (662)+TX, promacyl (1354)+TX, propargite (671)+TX, propetamphos (673)+TX, propoxur (678)+TX, prothidathion (1360)+TX, prothoate (1362)+TX, pyrethrin I (696)+TX, pyrethrin II (696)+TX, pyrethrins (696)+TX, pyridaben (699)+TX, pyridaphenthion (701)+TX, pyrimidifen (706)+TX, pyrimitate (1370)+TX, quinalphos (711)+TX, quintiofos (1381)+TX, R-1492 (development code) (1382)+TX, RA-17 (development code) (1383)+TX, rotenone (722)+TX, schradan (1389)+TX, sebufos (alternative name)+TX, selamectin (alternative name) [CCN]+TX, SI-0009 (compound code)+TX, sophamide (1402)+TX, spirodiclofen (738)+TX, spiromesifen (739)+TX, SSI-121 (development code) (1404)+TX, sulfuram (alternative name) [CCN]+TX, sulfluramid (750)+TX, sulfotep (753)+TX, sulphur (754)+TX, SZI-121 (development code) (757)+TX, tau-fluvalinate (398)+TX, tebufenpyrad (763)+TX, TEPP (1417)+TX, terbam (alternative name)+TX, tetrachlorvinphos (777)+TX, tetradifon (786)+TX, tetranactin (alternative name) (653)+TX, tetrasul (1425)+TX, thiafenox (alternative name)+TX, thiocarboxime (1431)+TX, thiofanox (800)+TX, thiometon (801)+TX, thioquinox (1436)+TX, thuringiensin (alternative name) [CCN]+TX, triamiphos (1441)+TX, triarathene (1443)+TX, triazophos (820)+TX, triazuron (alternative name)+TX, trichlorfon (824)+TX, trifenofos (1455)+TX, trinactin (alternative name) (653)+TX, vamidothion (847)+TX, vaniliprole [CCN] and YI-5302 (compound code)+TX,
an algicide selected from the group of substances consisting of bethoxazin [CCN]+TX, copper dioctanoate (IUPAC name) (170)+TX, copper sulfate (172)+TX, cybutryne [CCN]+TX, dichlone (1052)+TX, dichlorophen (232)+TX, endothal (295)+TX, fentin (347)+TX, hydrated lime [CCN]+TX, nabam (566)+TX, quinoclamine (714)+TX, quinonamid (1379)+TX, simazine (730)+TX, triphenyltin acetate (IUPAC name) (347) and triphenyltin hydroxide (IUPAC name) (347)+TX,
an anthelmintic selected from the group of substances consisting of abamectin (1)+TX, crufomate (1011)+TX, doramectin (alternative name) [CCN]+TX, emamectin (291)+TX, emamectin benzoate (291)+TX, eprinomectin (alternative name) [CCN]+TX, ivermectin (alternative name) [CCN]+TX, milbemycin oxime (alternative name) [CCN]+TX, moxidectin (alternative name) [CCN]+TX, piperazine [CCN]+TX, selamectin (alternative name) [CCN]+TX, spinosad (737) and thiophanate (1435)+TX,
an avicide selected from the group of substances consisting of chloralose (127)+TX, endrin (1122)+TX, fenthion (346)+TX, pyridin-4-amine (IUPAC name) (23) and strychnine (745)+TX,
a bactericide selected from the group of substances consisting of 1-hydroxy-1H-pyridine-2-thione (IUPAC name) (1222)+TX, 4-(quinoxalin-2-ylamino)benzenesulfonamide (IUPAC name) (748)+TX, 8-hydroxyquinoline sulfate (446)+TX, bronopol (97)+TX, copper dioctanoate (IUPAC name) (170)+TX, copper hydroxide (IUPAC name) (169)+TX, cresol [CCN]+TX, dichlorophen (232)+TX, dipyrithione (1105)+TX, dodicin (1112)+TX, fenaminosulf (1144)+TX, formaldehyde (404)+TX, hydrargaphen (alternative name) [CCN]+TX, kasugamycin (483)+TX, kasugamycin hydrochloride hydrate (483)+TX, nickel bis(dimethyldithiocarbamate) (IUPAC name) (1308)+TX, nitrapyrin (580)+TX, octhilinone (590)+TX, oxolinic acid (606)+TX, oxytetracycline (611)+TX, potassium hydroxyquinoline sulfate (446)+TX, probenazole (658)+TX, streptomycin (744)+TX, streptomycin sesquisulfate (744)+TX, tecloftalam (766)+TX, and thiomersal (alternative name) [CCN]+TX,
a biological agent selected from the group of substances consisting of Adoxophyes orana GV (alternative name) (12)+TX, Agrobacterium radiobacter (alternative name) (13)+TX, Amblyseius spp. (alternative name) (19)+TX, Anagrapha falcifera NPV (alternative name) (28)+TX, Anagrus atomus (alternative name) (29)+TX, Aphelinus abdominalis (alternative name) (33)+TX, Aphidius colemani (alternative name) (34)+TX, Aphidoletes aphidimyza (alternative name) (35)+TX, Autographa californica NPV (alternative name) (38)+TX, Bacillus firmus (alternative name) (48)+TX, Bacillus sphaericus Neide (scientific name) (49)+TX, Bacillus thuringiensis Berliner (scientific name) (51)+TX, Bacillus thuringiensis subsp. aizawai (scientific name) (51)+TX, Bacillus thuringiensis subsp. israelensis (scientific name) (51)+TX, Bacillus thuringiensis subsp. japonensis (scientific name) (51)+TX, Bacillus thuringiensis subsp. kurstaki (scientific name) (51)+TX, Bacillus thuringiensis subsp. tenebrionis (scientific name) (51)+TX, Beauveria bassiana (alternative name) (53)+TX, Beauveria brongniartii (alternative name) (54)+TX, Chrysoperla carnea (alternative name) (151)+TX, Cryptolaemus montrouzieri (alternative name) (178)+TX, Cydia pomonella GV (alternative name) (191)+TX, Dacnusa sibirica (alternative name) (212)+TX, Diglyphus isaea (alternative name) (254)+TX, Encarsia formosa (scientific name) (293)+TX, Eretmocerus eremicus (alternative name) (300)+TX, Helicoverpa zea NPV (alternative name) (431)+TX, Heterorhabditis bacteriophora and H. megidis (alternative name) (433)+TX, Hippodamia convergens (alternative name) (442)+TX, Leptomastix dactylopii (alternative name) (488)+TX, Macrolophus caliginosus (alternative name) (491)+TX, Mamestra brassicae NPV (alternative name) (494)+TX, Metaphycus helvolus (alternative name) (522)+TX, Metarhizium anisopliae var. acridum (scientific name) (523)+TX, Metarhizium anisopliae var. anisopliae (scientific name) (523)+TX, Neodiprion sertifer NPV and N. lecontei NPV (alternative name) (575)+TX, Orius spp. (alternative name) (596)+TX, Paecilomyces fumosoroseus (alternative name) (613)+TX, Phytoseiulus persimilis (alternative name) (644)+TX, Spodoptera exigua multicapsid nuclear polyhedrosis virus (scientific name) (741)+TX, Steinernema bibionis (alternative name) (742)+TX, Steinernema carpocapsae (alternative name) (742)+TX, Steinernema feltiae (alternative name) (742)+TX, Steinernema glaseri (alternative name) (742)+TX, Steinernema riobrave (alternative name) (742)+TX, Steinernema riobravis (alternative name) (742)+TX, Steinernema scapterisci (alternative name) (742)+TX, Steinernema spp. (alternative name) (742)+TX, Trichogramma spp. (alternative name) (826)+TX, Typhlodromus occidentalis (alternative name) (844) and Verticillium lecanii (alternative name) (848)+TX,
a soil sterilant selected from the group of substances consisting of iodomethane (IUPAC name) (542) and methyl bromide (537)+TX,
a chemosterilant selected from the group of substances consisting of apholate [CCN]+TX, bisazir (alternative name) [CCN]+TX, busulfan (alternative name) [CCN]+TX, diflubenzuron (250)+TX, dimatif (alternative name) [CCN]+TX, hemel [CCN]+TX, hempa [CCN]+TX, metepa [CCN]+TX, methiotepa [CCN]+TX, methyl apholate [CCN]+TX, morzid [CCN]+TX, penfluoron (alternative name) [CCN]+TX, tepa [CCN]+TX, thiohempa (alternative name) [CCN]+TX, thiotepa (alternative name) [CCN]+TX, tretamine (alternative name) [CCN] and uredepa (alternative name) [CCN]+TX,
an insect pheromone selected from the group of substances consisting of (E)-dec-5-en-1-yl acetate with (E)-dec-5-en-1-ol (IUPAC name) (222)+TX, (E)-tridec-4-en-1-yl acetate (IUPAC name) (829)+TX, (E)-6-methylhept-2-en-4-ol (IUPAC name) (541)+TX, (E,Z)-tetradeca-4,10-dien-1-yl acetate (IUPAC name) (779)+TX, (Z)-dodec-7-en-1-yl acetate (IUPAC name) (285)+TX, (Z)-hexadec-11-enal (IUPAC name) (436)+TX, (Z)-hexadec-11-en-1-yl acetate (IUPAC name) (437)+TX, (Z)-hexadec-13-en-11-yn-1-yl acetate (IUPAC name) (438)+TX, (Z)-icos-13-en-10-one (IUPAC name) (448)+TX, (Z)-tetradec-7-en-1-al (IUPAC name) (782)+TX, (Z)-tetradec-9-en-1-ol (IUPAC name) (783)+TX, (Z)-tetradec-9-en-1-yl acetate (IUPAC name) (784)+TX, (7E,9Z)-dodeca-7,9-dien-1-yl acetate (IUPAC name) (283)+TX, (9Z,11E)-tetradeca-9,11-dien-1-yl acetate (IUPAC name) (780)+TX, (9Z,12E)-tetradeca-9,12-dien-1-yl acetate (IUPAC name) (781)+TX, 14-methyloctadec-1-ene (IUPAC name) (545)+TX, 4-methylnonan-5-ol with 4-methylnonan-5-one (IUPAC name) (544)+TX, alpha-multistriatin (alternative name) [CCN]+TX, brevicomin (alternative name) [CCN]+TX, codlelure (alternative name) [CCN]+TX, codlemone (alternative name) (167)+TX, cuelure (alternative name) (179)+TX, disparlure (277)+TX, dodec-8-en-1-yl acetate (IUPAC name) (286)+TX, dodec-9-en-1-yl acetate (IUPAC name) (287)+TX, dodeca-8+TX, 10-dien-1-yl acetate (IUPAC name) (284)+TX, dominicalure (alternative name) [CCN]+TX, ethyl 4-methyloctanoate (IUPAC name) (317)+TX, eugenol (alternative name) [CCN]+TX, frontalin (alternative name) [CCN]+TX, gossyplure (alternative name) (420)+TX, grandlure (421)+TX, grandlure I (alternative name) (421)+TX, grandlure II (alternative name) (421)+TX, grandlure III (alternative name) (421)+TX, grandlure IV (alternative name) (421)+TX, hexylure [CCN]+TX, ipsdienol (alternative name) [CCN]+TX, ipsenol (alternative name) [CCN]+TX, japonilure (alternative name) (481)+TX, lineatin (alternative name) [CCN]+TX, litlure (alternative name) [CCN]+TX, looplure (alternative name) [CCN]+TX, medlure [CCN]+TX, megatomoic acid (alternative name) [CCN]+TX, methyl eugenol (alternative name) (540)+TX, muscalure (563)+TX, octadeca-2,13-dien-1-yl acetate (IUPAC name) (588)+TX, octadeca-3,13-dien-1-yl acetate (IUPAC name) (589)+TX, orfralure (alternative name) [CCN]+TX, oryctalure (alternative name) (317)+TX, ostramone (alternative name) [CCN]+TX, siglure [CCN]+TX, sordidin (alternative name) (736)+TX, sulcatol (alternative name) [CCN]+TX, tetradec-11-en-1-yl acetate (IUPAC name) (785)+TX, trimedlure (839)+TX, trimedlure A (alternative name) (839)+TX, trimedlure B₁ (alternative name) (839)+TX, trimedlure B₂ (alternative name) (839)+TX, trimedlure C (alternative name) (839) and trunc-call (alternative name) [CCN]+TX,
an insect repellent selected from the group of substances consisting of 2-(octylthio)-ethanol (IUPAC name) (591)+TX, butopyronoxyl (933)+TX, butoxy(polypropylene glycol) (936)+TX, dibutyl adipate (IUPAC name) (1046)+TX, dibutyl phthalate (1047)+TX, dibutyl succinate (IUPAC name) (1048)+TX, diethyltoluamide [CCN]+TX, dimethyl carbate [CCN]+TX, dimethyl phthalate [CCN]+TX, ethyl hexanediol (1137)+TX, hexamide [CCN]+TX, methoquin-butyl (1276)+TX, methylneodecanamide [CCN]+TX, oxamate [CCN] and picaridin [CCN]+TX,
an insecticide selected from the group of substances consisting of 1-dichloro-1-nitroethane (IUPAC/Chemical Abstracts name) (1058)+TX, 1,1-dichloro-2,2-bis(4-ethylphenyl)ethane (IUPAC name) (1056), +TX, 1,2-dichloropropane (IUPAC/Chemical Abstracts name) (1062)+TX, 1,2-dichloropropane with 1,3-dichloropropene (IUPAC name) (1063)+TX, 1-bromo-2-chloroethane (IUPAC/Chemical Abstracts name) (916)+TX, 2,2,2-trichloro-1-(3,4-dichlorophenyl)ethyl acetate (IUPAC name) (1451)+TX, 2,2-dichlorovinyl 2-ethylsulphinylethyl methyl phosphate (IUPAC name) (1066)+TX, 2-(1,3-dithiolan-2-yl)phenyl dimethylcarbamate (IUPAC/Chemical Abstracts name) (1109)+TX, 2-(2-butoxyethoxy)ethyl thiocyanate (IUPAC/Chemical Abstracts name) (935)+TX, 2-(4,5-dimethyl-1,3-dioxolan-2-yl)phenyl methylcarbamate (IUPAC/Chemical Abstracts name) (1084)+TX, 2-(4-chloro-3,5-xylyloxy)ethanol (IUPAC name) (986)+TX, 2-chlorovinyl diethyl phosphate (IUPAC name) (984)+TX, 2-imidazolidone (IUPAC name) (1225)+TX, 2-isovalerylindan-1,3-dione (IUPAC name) (1246)+TX, 2-methyl(prop-2-ynyl)aminophenyl methylcarbamate (IUPAC name) (1284)+TX, 2-thiocyanatoethyl laurate (IUPAC name) (1433)+TX, 3-bromo-1-chloroprop-1-ene (IUPAC name) (917)+TX, 3-methyl-1-phenylpyrazol-5-yl dimethylcarbamate (IUPAC name) (1283)+TX, 4-methyl(prop-2-ynyl)amino-3,5-xylyl methylcarbamate (IUPAC name) (1285)+TX, 5,5-dimethyl-3-oxocyclohex-1-enyl dimethylcarbamate (IUPAC name) (1085)+TX, abamectin (1)+TX, acephate (2)+TX, acetamiprid (4)+TX, acethion (alternative name) [CCN]+TX, acetoprole [CCN]+TX, acrinathrin (9)+TX, acrylonitrile (IUPAC name) (861)+TX, alanycarb (15)+TX, aldicarb (16)+TX, aldoxycarb (863)+TX, aldrin (864)+TX, allethrin (17)+TX, allosamidin (alternative name) [CCN]+TX, allyxycarb (866)+TX, alpha-cypermethrin (202)+TX, alpha-ecdysone (alternative name) [CCN]+TX, aluminium phosphide (640)+TX, amidithion (870)+TX, amidothioate (872)+TX, aminocarb (873)+TX, amiton (875)+TX, amiton hydrogen oxalate (875)+TX, amitraz (24)+TX, anabasine (877)+TX, athidathion (883)+TX, AVI 382 (compound code)+TX, AZ 60541 (compound code)+TX, azadirachtin (alternative name) (41)+TX, azamethiphos (42)+TX, azinphos-ethyl (44)+TX, azinphos-methyl (45)+TX, azothoate (889)+TX, Bacillus thuringiensis delta endotoxins (alternative name) (52)+TX, barium hexafluorosilicate (alternative name) [CCN]+TX, barium polysulfide (IUPAC/Chemical Abstracts name) (892)+TX, barthrin [CCN]+TX, Bayer 22/190 (development code) (893)+TX, Bayer 22408 (development code) (894)+TX, bendiocarb (58)+TX, benfuracarb (60)+TX, bensultap (66)+TX, beta-cyfluthrin (194)+TX, beta-cypermethrin (203)+TX, bifenthrin (76)+TX, bioallethrin (78)+TX, bioallethrin S-cyclopentenyl isomer (alternative name) (79)+TX, bioethanomethrin [CCN]+TX, biopermethrin (908)+TX, bioresmethrin (80)+TX, bis(2-chloroethyl)ether (IUPAC name) (909)+TX, bistrifluoron (83)+TX, borax (86)+TX, brofenvalerate (alternative name)+TX, bromfenvinfos (914)+TX, bromocyclen (918)+TX, bromo-DDT (alternative name) [CCN]+TX, bromophos (920)+TX, bromophos-ethyl (921)+TX, bufencarb (924)+TX, buprofezin (99)+TX, butacarb (926)+TX, butathiofos (927)+TX, butocarboxim (103)+TX, butonate (932)+TX, butoxycarboxim (104)+TX, butylpyridaben (alternative name)+TX, cadusafos (109)+TX, calcium arsenate [CCN]+TX, calcium cyanide (444)+TX, calcium polysulfide (IUPAC name) (111)+TX, camphechlor (941)+TX, carbanolate (943)+TX, carbaryl (115)+TX, carbofuran (118)+TX, carbon disulfide (IUPAC/Chemical Abstracts name) (945)+TX, carbon tetrachloride (IUPAC name) (946)+TX, carbophenothion (947)+TX, carbosulfan (119)+TX, cartap (123)+TX, cartap hydrochloride (123)+TX, cevadine (alternative name) (725)+TX, chlorbicyclen (960)+TX, chlordane (128)+TX, chlordecone (963)+TX, chlordimeform (964)+TX, chlordimeform hydrochloride (964)+TX, chlorethoxyfos (129)+TX, chlorfenapyr (130)+TX, chlorfenvinphos (131)+TX, chlorfluazuron (132)+TX, chlormephos (136)+TX, chloroform [CCN]+TX, chloropicrin (141)+TX, chlorphoxim (989)+TX, chlorprazophos (990)+TX, chlorpyrifos (145)+TX, chlorpyrifos-methyl (146)+TX, chlorthiophos (994)+TX, chromafenozide (150)+TX, cinerin I (696)+TX, cinerin II (696)+TX, cinerins (696)+TX, cis-resmethrin (alternative name)+TX, cismethrin (80)+TX, clocythrin (alternative name)+TX, cloethocarb (999)+TX, closantel (alternative name)

[CCN]+TX, clothianidin (165)+TX, copper acetoarsenite [CCN]+TX, copper arsenate [CCN]+TX, copper oleate [CCN]+TX, coumaphos (174)+TX, coumithoate (1006)+TX, crotamiton (alternative name) [CCN]+TX, crotoxyphos (1010)+TX, crufomate (1011)+TX, cryolite (alternative name) (177)+TX, CS 708 (development code) (1012)+TX, cyanofenphos (1019)+TX, cyanophos (184)+TX, cyanthoate (1020)+TX, cyclethrin [CCN]+TX, cycloprothrin (188)+TX, cyfluthrin (193)+TX, cyhalothrin (196)+TX, cypermethrin (201)+TX, cyphenothrin (206)+TX, cyromazine (209)+TX, cythioate (alternative name) [CCN]+TX, d-limonene (alternative name) [CCN]+TX, d-tetramethrin (alternative name) (788)+TX, DAEP (1031)+TX, dazomet (216)+TX, DDT (219)+TX, decarbofuran (1034)+TX, deltamethrin (223)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-5-methyl (224)+TX, demeton-5-methylsulphon (1039)+TX, diafenthiuron (226)+TX, dialifos (1042)+TX, diamidafos (1044)+TX, diazinon (227)+TX, dicapthon (1050)+TX, dichlofenthion (1051)+TX, dichlorvos (236)+TX, dicliphos (alternative name)+TX, dicresyl (alternative name) [CCN]+TX, dicrotophos (243)+TX, dicyclanil (244)+TX, dieldrin (1070)+TX, diethyl 5-methylpyrazol-3-yl phosphate (IUPAC name) (1076)+TX, diflubenzuron (250)+TX, dilor (alternative name) [CCN]+TX, dimefluthrin [CCN]+TX, dimefox (1081)+TX, dimetan (1085)+TX, dimethoate (262)+TX, dimethrin (1083)+TX, dimethylvinphos (265)+TX, dimetilan (1086)+TX, dinex (1089)+TX, dinex-diclexine (1089)+TX, dinoprop (1093)+TX, dinosam (1094)+TX, dinoseb (1095)+TX, dinotefuran (271)+TX, diofenolan (1099)+TX, dioxabenzofos (1100)+TX, dioxacarb (1101)+TX, dioxathion (1102)+TX, disulfoton (278)+TX, dithicrofos (1108)+TX, DNOC (282)+TX, doramectin (alternative name) [CCN]+TX, DSP (1115)+TX, ecdysterone (alternative name) [CCN]+TX, E1 1642 (development code) (1118)+TX, emamectin (291)+TX, emamectin benzoate (291)+TX, EMPC (1120)+TX, empenthrin (292)+TX, endosulfan (294)+TX, endothion (1121)+TX, endrin (1122)+TX, EPBP (1123)+TX, EPN (297)+TX, epofenonane (1124)+TX, eprinomectin (alternative name) [CCN]+TX, esfenvalerate (302)+TX, etaphos (alternative name) [CCN]+TX, ethiofencarb (308)+TX, ethion (309)+TX, ethiprole (310)+TX, ethoate-methyl (1134)+TX, ethoprophos (312)+TX, ethyl formate (IUPAC name) [CCN]+TX, ethyl-DDD (alternative name) (1056)+TX, ethylene dibromide (316)+TX, ethylene dichloride (chemical name) (1136)+TX, ethylene oxide [CCN]+TX, etofenprox (319)+TX, etrimfos (1142)+TX, EXD (1143)+TX, famphur (323)+TX, fenamiphos (326)+TX, fenazaflor (1147)+TX, fenchlorphos (1148)+TX, fenethacarb (1149)+TX, fenfluthrin (1150)+TX, fenitrothion (335)+TX, fenobucarb (336)+TX, fenoxacrim (1153)+TX, fenoxycarb (340)+TX, fenpirithrin (1155)+TX, fenpropathrin (342)+TX, fenpyrad (alternative name)+TX, fensulfothion (1158)+TX, fenthion (346)+TX, fenthion-ethyl [CCN]+TX, fenvalerate (349)+TX, fipronil (354)+TX, flonicamid (358)+TX, flubendiamide (CAS. Reg. No.: 272451-65-7)+TX, flucofuron (1168)+TX, flucycloxuron (366)+TX, flucythrinate (367)+TX, fluenetil (1169)+TX, flufenerim [CCN]+TX, flufenoxuron (370)+TX, flufenprox (1171)+TX, flumethrin (372)+TX, fluvalinate (1184)+TX, FMC 1137 (development code) (1185)+TX, fonofos (1191)+TX, formetanate (405)+TX, formetanate hydrochloride (405)+TX, formothion (1192)+TX, formparanate (1193)+TX, fosmethilan (1194)+TX, fospirate (1195)+TX, fosthiazate (408)+TX, fosthietan (1196)+TX, furathiocarb (412)+TX, furethrin (1200)+TX, gamma-cyhalothrin (197)+TX, gamma-HCH (430)+TX, guazatine (422)+TX, guazatine acetates (422)+TX, GY-81 (development code) (423)+TX, halfenprox (424)+TX, halofenozide (425)+TX, HCH (430)+TX, HEOD (1070)+TX, heptachlor (1211)+TX, heptenophos (432)+TX, heterophos [CCN]+TX, hexaflumuron (439)+TX, HHDN (864)+TX, hydramethylnon (443)+TX, hydrogen cyanide (444)+TX, hydroprene (445)+TX, hyquincarb (1223)+TX, imidacloprid (458)+TX, imiprothrin (460)+TX, indoxacarb (465)+TX, iodomethane (IUPAC name) (542)+TX, IPSP (1229)+TX, isazofos (1231)+TX, isobenzan (1232)+TX, isocarbophos (alternative name) (473)+TX, isodrin (1235)+TX, isofenphos (1236)+TX, isolane (1237)+TX, isoprocarb (472)+TX, isopropyl O-(methoxy-aminothiophosphoryl)salicylate (IUPAC name) (473)+TX, isoprothiolane (474)+TX, isothioate (1244)+TX, isoxathion (480)+TX, ivermectin (alternative name) [CCN]+TX, jasmolin I (696)+TX, jasmolin II (696)+TX, jodfenphos (1248)+TX, juvenile hormone I (alternative name) [CCN]+TX, juvenile hormone II (alternative name) [CCN]+TX, juvenile hormone III (alternative name) [CCN]+TX, kelevan (1249)+TX, kinoprene (484)+TX, lambda-cyhalothrin (198)+TX, lead arsenate [CCN]+TX, lepimectin (CCN)+TX, leptophos (1250)+TX, lindane (430)+TX, lirimfos (1251)+TX, lufenuron (490)+TX, lythidathion (1253)+TX, m-cumenyl methylcarbamate (IUPAC name) (1014)+TX, magnesium phosphide (IUPAC name) (640)+TX, malathion (492)+TX, malonoben (1254)+TX, mazidox (1255)+TX, mecarbam (502)+TX, mecarphon (1258)+TX, menazon (1260)+TX, mephosfolan (1261)+TX, mercurous chloride (513)+TX, mesulfenfos (1263)+TX, metaflumizone (CCN)+TX, metam (519)+TX, metam-potassium (alternative name) (519)+TX, metam-sodium (519)+TX, methacrifos (1266)+TX, methamidophos (527)+TX, methanesulphonyl fluoride (IUPAC/Chemical Abstracts name) (1268)+TX, methidathion (529)+TX, methiocarb (530)+TX, methocrotophos (1273)+TX, methomyl (531)+TX, methoprene (532)+TX, methoquin-butyl (1276)+TX, methothrin (alternative name) (533)+TX, methoxychlor (534)+TX, methoxyfenozide (535)+TX, methyl bromide (537)+TX, methyl isothiocyanate (543)+TX, methylchloroform (alternative name) [CCN]+TX, methylene chloride [CCN]+TX, metofluthrin [CCN]+TX, metolcarb (550)+TX, metoxadiazone (1288)+TX, mevinphos (556)+TX, mexacarbate (1290)+TX, milbemectin (557)+TX, milbemycin oxime (alternative name) [CCN]+TX, mipafox (1293)+TX, mirex (1294)+TX, monocrotophos (561)+TX, morphothion (1300)+TX, moxidectin (alternative name) [CCN]+TX, naftalofos (alternative name) [CCN]+TX, naled (567)+TX, naphthalene (IUPAC/Chemical Abstracts name) (1303)+TX, NC-170 (development code) (1306)+TX, NC-184 (compound code)+TX, nicotine (578)+TX, nicotine sulfate (578)+TX, nifluridide (1309)+TX, nitenpyram (579)+TX, nithiazine (1311)+TX, nitrilacarb (1313)+TX, nitrilacarb 1:1 zinc chloride complex (1313)+TX, NNI-0101 (compound code)+TX, NNI-0250 (compound code)+TX, nornicotine (traditional name) (1319)+TX, novaluron (585)+TX, noviflumuron (586)+TX, O-5-dichloro-4-iodophenyl O-ethyl ethylphosphonothioate (IUPAC name) (1057)+TX, O,O-diethyl O-4-methyl-2-oxo-2H-chromen-7-yl phosphorothioate (IUPAC name) (1074)+TX, O,O-diethyl O-6-methyl-2-propylpyrimidin-4-yl phosphorothioate (IUPAC name) (1075)+TX, O,O,O′,O′-tetrapropyl dithiopyrophosphate (IUPAC name) (1424)+TX, oleic acid (IUPAC name) (593)+TX, omethoate (594)+TX, oxamyl (602)+TX, oxydemeton-methyl (609)+TX, oxydeprofos (1324)+TX, oxydisulfoton (1325)+TX, pp′-DDT (219)+TX, para-dichlorobenzene [CCN]+TX, parathion (615)+TX, parathion-methyl (616)+TX, penfluoron (alternative name) [CCN]+TX, pentachlorophenol (623)+TX, pentachlorophenyl laurate (IUPAC name) (623)+TX, permethrin (626)+TX, petroleum oils (alternative name) (628)+TX, PH 60-38 (development code) (1328)+TX, phenkapton (1330)+TX, phenothrin (630)+TX, phenthoate (631)+TX, phorate (636)+TX, phosalone (637)+TX, phosfolan (1338)+TX, phosmet (638)+TX, phosnichlor (1339)+TX, phosphamidon (639)+TX, phosphine (IUPAC name) (640)+TX, phoxim (642)+TX, phoxim-methyl (1340)+TX, pirimetaphos (1344)+TX, pirimicarb (651)+TX, pirimiphos-ethyl (1345)+TX, pirimiphos-methyl (652)+TX, polychlorodicyclopentadiene isomers (IUPAC name) (1346)+TX, polychloroterpenes (traditional name) (1347)+TX, potassium arsenite [CCN]+TX, potassium thiocyanate [CCN]+TX, prallethrin (655)+TX, precocene I (alternative name) [CCN]+TX, precocene II (alternative name) [CCN]+TX, precocene III (alternative name) [CCN]+TX, primidophos (1349)+TX, profenofos (662)+TX, profluthrin [CCN]+TX, promacyl (1354)+TX, promecarb (1355)+TX, propaphos (1356)+TX, propetamphos (673)+TX, propoxur (678)+TX, prothidathion (1360)+TX, prothiofos (686)+TX, prothoate (1362)+TX, protrifenbute [CCN]+TX, pymetrozine (688)+TX, pyraclofos (689)+TX, pyrazophos (693)+TX, pyresmethrin (1367)+TX, pyrethrin I (696)+TX, pyrethrin II (696)+TX, pyrethrins (696)+TX, pyridaben (699)+TX, pyridalyl (700)+TX, pyridaphenthion (701)+TX, pyrimidifen (706)+TX, pyrimitate (1370)+TX, pyriproxyfen (708)+TX, quassia (alternative name) [CCN]+TX, quinalphos (711)+TX, quinalphos-methyl (1376)+TX, quinothion (1380)+TX, quintiofos (1381)+TX, R-1492 (development code) (1382)+TX, rafoxanide (alternative name) [CCN]+TX, resmethrin (719)+TX, rotenone (722)+TX, RU 15525 (development code) (723)+TX, RU 25475 (development code) (1386)+TX, ryania (alternative name) (1387)+TX, ryanodine (traditional name) (1387)+TX, sabadilla (alternative name) (725)+TX, schradan (1389)+TX, sebufos (alternative name)+TX, selamectin (alternative name) [CCN]+TX, SI-0009 (compound code)+TX, SI-0205 (compound code)+TX, SI-0404 (compound code)+TX, SI-0405 (compound code)+TX, silafluofen (728)+TX, SN 72129 (development code) (1397)+TX, sodium arsenite [CCN]+TX, sodium cyanide (444)+TX, sodium fluoride (IUPAC/Chemical Abstracts name) (1399)+TX, sodium hexafluorosilicate (1400)+TX, sodium pentachlorophenoxide (623)+TX, sodium selenate (IUPAC name) (1401)+TX, sodium thiocyanate [CCN]+TX, sophamide (1402)+TX, spinosad (737)+TX, spiromesifen (739)+TX, spirotetrmat (CCN)+TX, sulcofuron (746)+TX, sulcofuron-sodium (746)+TX, sulfluramid (750)+TX, sulfotep (753)+TX, sulphuryl fluoride (756)+TX, sulprofos (1408)+TX, tar oils (alternative name) (758)+TX, tau-fluvalinate (398)+TX, tazimcarb (1412)+TX, TDE (1414)+TX, tebufenozide (762)+TX, tebufenpyrad (763)+TX, tebupirimfos (764)+TX, teflubenzuron (768)+TX, tefluthrin (769)+TX, temephos (770)+TX, TEPP (1417)+TX, terallethrin (1418)+TX, terbam (alternative name)+TX, terbufos (773)+TX, tetrachloroethane [CCN]+TX, tetrachlorvinphos (777)+TX, tetramethrin (787)+TX, theta-cypermethrin (204)+TX, thiacloprid (791)+TX, thiafenox (alternative name)+TX, thiamethoxam (792)+TX, thicrofos (1428)+TX, thiocarboxime (1431)+TX, thiocyclam (798)+TX, thiocyclam hydrogen oxalate (798)+TX, thiodicarb (799)+TX, thiofanox (800)+TX, thiometon (801)+TX, thionazin (1434)+TX, thiosultap (803)+TX, thiosultap-sodium (803)+TX, thuringiensin (alternative name) [CCN]+TX, tolfenpyrad (809)+TX, tralomethrin (812)+TX, transfluthrin (813)+TX, transpermethrin (1440)+TX, triamiphos (1441)+TX, triazamate (818)+TX, triazophos (820)+TX, triazuron (alternative name)+TX, trichlorfon (824)+TX, trichlormetaphos-3 (alternative name) [CCN]+TX, trichloronat (1452)+TX, trifenofos (1455)+TX, triflumuron (835)+TX, trimethacarb (840)+TX, triprene (1459)+TX, vamidothion (847)+TX, vaniliprole [CCN]+TX, veratridine (alternative name) (725)+TX, veratrine (alternative name) (725)+TX, XMC (853)+TX, xylylcarb (854)+TX, YI-5302 (compound code)+TX, zeta-cypermethrin (205)+TX, zetamethrin (alternative name)+TX, zinc phosphide (640)+TX, zolaprofos (1469) and ZXI 8901 (development code) (858)+TX, cyantraniliprole [736994-63-19]+TX, chlorantraniliprole [500008-45-7]+TX, cyenopyrafen [560121-52-0]+TX, cyflumetofen [400882-07-7]+TX, pyrifluquinazon [337458-27-2]+TX, spinetoram [187166-40-1+187166-15-0]+TX, spirotetramat [203313-25-1]+TX, sulfoxaflor [946578-00-3]+TX, flufiprole [704886-18-0]+TX, meperfluthrin [915288-13-0]+TX, tetramethylfluthrin [84937-88-2]+TX,
a molluscicide selected from the group of substances consisting of bis(tributyltin) oxide (IUPAC name) (913)+TX, bromoacetamide [CCN]+TX, calcium arsenate [CCN]+TX, cloethocarb (999)+TX, copper acetoarsenite [CCN]+TX, copper sulfate (172)+TX, fentin (347)+TX, ferric phosphate (IUPAC name) (352)+TX, metaldehyde (518)+TX, methiocarb (530)+TX, niclosamide (576)+TX, niclosamide-olamine (576)+TX, pentachlorophenol (623)+TX, sodium pentachlorophenoxide (623)+TX, tazimcarb (1412)+TX, thiodicarb (799)+TX, tributyltin oxide (913)+TX, trifenmorph (1454)+TX, trimethacarb (840)+TX, triphenyltin acetate (IUPAC name) (347) and triphenyltin hydroxide (IUPAC name) (347)+TX, pyriprole [394730-71-3]+TX,
a nematicide selected from the group of substances consisting of AKD-3088 (compound code)+TX, 1,2-dibromo-3-chloropropane (IUPAC/Chemical Abstracts name) (1045)+TX, 1,2-dichloropropane (IUPAC/Chemical Abstracts name) (1062)+TX, 1,2-dichloropropane with 1,3-dichloropropene (IUPAC name) (1063)+TX, 1,3-dichloropropene (233)+TX, 3,4-dichlorotetrahydrothiophene 1,1-dioxide (IUPAC/Chemical Abstracts name) (1065)+TX, 3-(4-chlorophenyl)-5-methylrhodanine (IUPAC name) (980)+TX, 5-methyl-6-thioxo-1,3,5-thiadiazinan-3-ylacetic acid (IUPAC name) (1286)+TX, 6-isopentenylaminopurine (alternative name) (210)+TX, abamectin (1)+TX, acetoprole [CCN]+TX, alanycarb (15)+TX, aldicarb (16)+TX, aldoxycarb (863)+TX, AZ 60541 (compound code)+TX, benclothiaz [CCN]+TX, benomyl (62)+TX, butylpyridaben (alternative name)+TX, cadusafos (109)+TX, carbofuran (118)+TX, carbon disulfide (945)+TX, carbosulfan (119)+TX, chloropicrin (141)+TX, chlorpyrifos (145)+TX, cloethocarb (999)+TX, cytokinins (alternative name) (210)+TX, dazomet (216)+TX, DBCP (1045)+TX, DCIP (218)+TX, diamidafos (1044)+TX, dichlofenthion (1051)+TX, dicliphos (alternative name)+TX, dimethoate (262)+TX, doramectin (alternative name) [CCN]+TX, emamectin (291)+TX, emamectin benzoate (291)+TX, eprinomectin (alternative name) [CCN]+TX, ethoprophos (312)+TX, ethylene dibromide (316)+TX, fenamiphos (326)+TX, fenpyrad (alternative name)+TX, fensulfothion (1158)+TX, fosthiazate (408)+TX, fosthietan (1196)+TX, furfural (alternative name) [CCN]+TX, GY-81 (development code) (423)+TX, heterophos [CCN]+TX, iodomethane (IUPAC name) (542)+TX, isamidofos (1230)+TX, isazofos (1231)+TX, ivermectin (alternative name) [CCN]+TX, kinetin (alternative name) (210)+TX, mecarphon (1258)+TX, metam (519)+TX, metam-potassium (alternative name) (519)+TX, metam-sodium (519)+TX, methyl bromide (537)+TX, methyl isothiocyanate (543)+TX, milbemycin oxime (alternative name) [CCN]+TX, moxidectin (alternative name) [CCN]+TX, Myrothecium verrucaria composition (alternative name) (565)+TX, NC-184 (compound code)+TX, oxamyl (602)+TX, phorate (636)+TX, phosphamidon (639)+TX, phosphocarb [CCN]+TX, sebufos (alternative name)+TX, selamectin (alternative name) [CCN]+TX, spinosad (737)+TX, terbam (alternative name)+TX, terbufos (773)+TX, tetrachlorothiophene (IUPAC/Chemical Abstracts name) (1422)+TX, thiafenox (alternative name)+TX, thionazin (1434)+TX, triazophos (820)+TX, triazuron (alternative name)+TX, xylenols [CCN]+TX, YI-5302 (compound code) and zeatin (alternative name) (210)+TX, fluensulfone [318290-98-1]+TX,
a nitrification inhibitor selected from the group of substances consisting of potassium ethylxanthate [CCN] and nitrapyrin (580)+TX,
a plant activator selected from the group of substances consisting of acibenzolar (6)+TX, acibenzolar-5-methyl (6)+TX, probenazole (658) and Reynoutria sachalinensis extract (alternative name) (720)+TX,
a rodenticide selected from the group of substances consisting of 2-isovalerylindan-1,3-dione (IUPAC name) (1246)+TX, 4-(quinoxalin-2-ylamino)benzenesulfonamide (IUPAC name) (748)+TX, alpha-chlorohydrin [CCN]+TX, aluminium phosphide (640)+TX, antu (880)+TX, arsenous oxide (882)+TX, barium carbonate (891)+TX, bisthiosemi (912)+TX, brodifacoum (89)+TX, bromadiolone (91)+TX, bromethalin (92)+TX, calcium cyanide (444)+TX, chloralose (127)+TX, chlorophacinone (140)+TX, cholecalciferol (alternative name) (850)+TX, coumachlor (1004)+TX, coumafuryl (1005)+TX, coumatetralyl (175)+TX, crimidine (1009)+TX, difenacoum (246)+TX, difethialone (249)+TX, diphacinone (273)+TX, ergocalciferol (301)+TX, flocoumafen (357)+TX, fluoroacetamide (379)+TX, flupropadine (1183)+TX, flupropadine hydrochloride (1183)+TX, gamma-HCH (430)+TX, HCH (430)+TX, hydrogen cyanide (444)+TX, iodomethane (IUPAC name) (542)+TX, lindane (430)+TX, magnesium phosphide (IUPAC name) (640)+TX, methyl bromide (537)+TX, norbormide (1318)+TX, phosacetim (1336)+TX, phosphine (IUPAC name) (640)+TX, phosphorus [CCN]+TX, pindone (1341)+TX, potassium arsenite [CCN]+TX, pyrinuron (1371)+TX, scilliroside (1390)+TX, sodium arsenite [CCN]+TX, sodium cyanide (444)+TX, sodium fluoroacetate (735)+TX, strychnine (745)+TX, thallium sulfate [CCN]+TX, warfarin (851) and zinc phosphide (640)+TX,
a synergist selected from the group of substances consisting of 2-(2-butoxyethoxy)ethyl piperonylate (IUPAC name) (934)+TX, 5-(1,3-benzodioxol-5-yl)-3-hexylcyclohex-2-enone (IUPAC name) (903)+TX, farnesol with nerolidol (alternative name) (324)+TX, MB-599 (development code) (498)+TX, MGK 264 (development code) (296)+TX, piperonyl butoxide (649)+TX, piprotal (1343)+TX, propyl isomer (1358)+TX, S421 (development code) (724)+TX, sesamex (1393)+TX, sesasmolin (1394) and sulfoxide (1406)+TX,
an animal repellent selected from the group of substances consisting of anthraquinone (32)+TX, chloralose (127)+TX, copper naphthenate [CCN]+TX, copper oxychloride (171)+TX, diazinon (227)+TX, dicyclopentadiene (chemical name) (1069)+TX, guazatine (422)+TX, guazatine acetates (422)+TX, methiocarb (530)+TX, pyridin-4-amine (IUPAC name) (23)+TX, thiram (804)+TX, trimethacarb (840)+TX, zinc naphthenate [CCN] and ziram (856)+TX,
a virucide selected from the group of substances consisting of imanin (alternative name) [CCN] and ribavirin (alternative name) [CCN]+TX,
a wound protectant selected from the group of substances consisting of mercuric oxide (512)+TX, octhilinone (590) and thiophanate-methyl (802)+TX,
and biologically active compounds selected from the group consisting of azaconazole (60207-31-0]+TX, bitertanol [70585-36-3]+TX, bromuconazole [116255-48-2]+TX, cyproconazole [94361-06-5]+TX, difenoconazole [119446-68-3]+TX, diniconazole [83657-24-3]+TX, epoxiconazole [106325-08-0]+TX, fenbuconazole [114369-43-6]+TX, fluquinconazole [136426-54-5]+TX, flusilazole [85509-19-9]+TX, flutriafol [76674-21-0]+TX, hexaconazole [79983-71-4]+TX, imazalil [35554-44-0]+TX, imibenconazole [86598-92-7]+TX, ipconazole [125225-28-7]+TX, metconazole [125116-23-6]+TX, myclobutanil [88671-89-0]+TX, pefurazoate [101903-30-4]+TX, penconazole [66246-88-6]+TX, prothioconazole [178928-70-6]+TX, pyrifenox [88283-41-4]+TX, prochloraz [67747-09-5]+TX, propiconazole [60207-90-1]+TX, simeconazole [149508-90-7]+TX, tebuconazole [107534-96-3]+TX, tetraconazole [112281-77-3]+TX, triadimefon [43121-43-3]+TX, triadimenol [55219-65-3]+TX, triflumizole [99387-89-0]+TX, triticonazole [131983-72-7]+TX, ancymidol [12771-68-5]+TX, fenarimol [60168-88-9]+TX, nuarimol [63284-71-9]+TX, bupirimate [41483-43-6]+TX, dimethirimol [5221-53-4]+TX, ethirimol [23947-60-6]+TX, dodemorph [1593-77-7]+TX, fenpropidine [67306-00-7]+TX, fenpropimorph [67564-91-4]+TX, spiroxamine [118134-30-8]+TX, tridemorph [81412-43-3]+TX, cyprodinil [121552-61-2]+TX, mepanipyrim [110235-47-7]+TX, pyrimethanil [53112-28-0]+TX, fenpiclonil [74738-17-3]+TX, fludioxonil [131341-86-1]+TX, benalaxyl [71626-11-4]+TX, furalaxyl [57646-30-7]+TX, metalaxyl [57837-19-1]+TX, R-metalaxyl [70630-17-0]+TX, ofurace [58810-48-3]+TX, oxadixyl [77732-09-3]+TX, benomyl [17804-35-2]+TX, carbendazim [10605-21-7]+TX, debacarb [62732-91-6]+TX, fuberidazole [3878-19-1]+TX, thiabendazole [148-79-8]+TX, chlozolinate [84332-86-5]+TX, dichlozoline [24201-58-9]+TX, iprodione [36734-19-7]+TX, myclozoline [54864-61-8]+TX, procymidone [32809-16-8]+TX, vinclozoline [50471-44-8]+TX, (S)-[3-(4-Chloro-2-fluoro-phenyl)-5-(2,4-difluoro-phenyl)-isoxazol-4-yl]-pyridin-3-yl-methanol (WO2010069881)+TX, 3-(4-Chloro-2-fluoro-phenyl)-5-(2,4-difluoro-phenyl)-isoxazol-4-yl]-pyridin-3-yl-methanol (WO2010069881)+TX, boscalid [188425-85-6]+TX, carboxin [5234-68-4]+TX, fenfuram [24691-80-3]+TX, flutolanil [66332-96-5]+TX, mepronil [55814-41-0]+TX, oxycarboxin [5259-88-1]+TX, penthiopyrad [183675-82-3]+TX, thifluzamide [130000-40-7]+TX, guazatine [108173-90-6]+TX, dodine [2439-10-3] [112-65-2] (free base)+TX, iminoctadine [13516-27-3]+TX, azoxystrobin [131860-33-8]+TX, dimoxystrobin [149961-52-4]+TX, enestroburin {Proc. BCPC, Int. Congr., Glasgow, 2003, 1, 93}+TX, fluoxastrobin [361377-29-9]+TX, kresoxim-methyl [143390-89-0]+TX, metominostrobin [133408-50-1]+TX, trifloxystrobin [141517-21-7]+TX, orysastrobin [248593-16-0]+TX, picoxystrobin [117428-22-5]+TX, pyraclostrobin [175013-18-0]+TX, ferbam [14484-64-1]+TX, mancozeb [8018-01-7]+TX, maneb [12427-38-2]+TX, metiram [9006-42-2]+TX, propineb [12071-83-9]+TX, thiram [137-26-8]+TX, zineb [12122-67-7]+TX, ziram [137-30-4]+TX, captafol [2425-06-1]+TX, captan [133-06-2]+TX, dichlofluanid [1085-98-9]+TX, fluoroimide [41205-21-4]+TX, folpet [133-07-3]+TX, tolylfluanid [731-27-1]+TX, bordeaux mixture [8011-63-0]+TX, copperhydroxid [20427-59-2]+TX, copperoxychlorid [1332-40-7]+TX, coppersulfat [7758-98-7]+TX, copperoxid [1317-39-1]+TX, mancopper [53988-93-5]+TX, oxine-copper [10380-28-6]+TX, dinocap [131-72-6]+TX, nitrothal-isopropyl [10552-74-6]+TX, edifenphos [17109-49-8]+TX, iprobenphos [26087-47-8]+TX, isoprothiolane [50512-35-1]+TX, phosdiphen [36519-00-3]+TX, pyrazophos [13457-18-6]+TX, tolclofos-methyl [57018-04-9]+TX, acibenzolar-5-methyl [135158-54-2]+TX, anilazine [101-05-3]+TX, benthiavalicarb [413615-35-7]+TX, blasticidin-S [2079-00-7]+TX, chinomethionat [2439-01-2]+TX, chloroneb [2675-77-6]+TX, chlorothalonil [1897-45-6]+TX, cyflufenamid [180409-60-3]+TX, cymoxanil [57966-95-7]+TX, dichlone [117-80-6]+TX, diclocymet [139920-32-4]+TX, diclomezine [62865-36-5]+TX, dicloran [99-30-9]+TX, diethofencarb [87130-20-9]+TX, dimethomorph [110488-70-5]+TX, SYP-LI90 (Flumorph) [211867-47-9]+TX, dithianon [3347-22-6]+TX, ethaboxam [162650-77-3]+TX, etridiazole [2593-15-9]+TX, famoxadone [131807-57-3]+TX, fenamidone [161326-34-7]+TX, fenoxanil [115852-48-7]+TX, fentin [668-34-8]+TX, ferimzone [89269-64-7]+TX, fluazinam [79622-59-6]+TX, fluopicolide [239110-15-7]+TX, flusulfamide [106917-52-6]+TX, fenhexamid [126833-17-8]+TX, fosetyl-aluminium [39148-24-8]+TX, hymexazol [10004-44-1]+TX, iprovalicarb [140923-17-7]+TX, IKF-916 (Cyazofamid) [120116-88-3]+TX, kasugamycin [6980-18-3]+TX, methasulfocarb [66952-49-6]+TX, metrafenone [220899-03-6]+TX, pencycuron [66063-05-6]+TX, phthalide [27355-22-2]+TX, polyoxins [11113-80-7]+TX, probenazole [27605-76-1]+TX, propamocarb [25606-41-1]+TX, proquinazid [189278-12-4]+TX, pyroquilon [57369-32-1]+TX, quinoxyfen [124495-18-7]+TX, quintozene [82-68-8]+TX, sulphur [7704-34-9]+TX, tiadinil [223580-51-6]+TX, triazoxide [72459-58-6]+TX, tricyclazole [41814-78-2]+TX, triforine [26644-46-2]+TX, validamycin [37248-47-8]+TX, zoxamide (RH7281) [156052-68-5]+TX, mandipropamid [374726-62-2]+TX, isopyrazam [881685-58-1]+TX, sedaxane [874967-67-6]+TX, 3-difluoromethyl-1-methyl-1H-pyrazole-4-carboxylic acid (9-dichloromethylene-1,2,3,4-tetrahydro-1,4-methano-naphthalen-5-yl)-amide (disclosed in WO 2007/048556)+TX, 3-difluoromethyl-1-methyl-1H-pyrazole-4-carboxylic acid [2-(2,4-dichlorophenyl)-2-methoxy-1-methyl-ethyl]-amide (disclosed in WO 2008/148570)+TX, 1-[4-[4-[(5S)₅-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone+TX, 1-[4-[4-[5-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone [1003318-67-9], both disclosed in WO 2010/123791, WO 2008/013925, WO 2008/013622 and WO 2011/051243 page 20)+TX, and 3-difluoromethyl-1-methyl-1H-pyrazole-4-carboxylic acid (3′,4′,5′-trifluoro-biphenyl-2-yl)-amide (disclosed in WO 2006/087343)+TX.

It has been found that the use of component (B) in combination with component TX surprisingly and substantially may enhance the effectiveness of the latter against fungi, and vice versa. Additionally, the method of the invention is effective against a wider spectrum of such fungi that can be combated with the active ingredients of this method, when used solely.

In general, the weight ratio of component TX to component (B) is from 2000:1 to 1:1000. A non-limiting example for such weight ratios is compound of formula I:compound of formula B-2 is 10:1. The weight ratio of component TX to component (B) is preferably from 100:1 to 1:100; more preferably from 20:1 to 1:50.

The active ingredient mixture of component TX to component (B) comprises compounds of formula I and a further, other biocidally active ingredients or compositions or if desired, a solid or liquid adjuvant preferably in a mixing ratio of from 1000:1 to 1:1000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred, above all in a ratio of 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are understood to include, on the one hand, ratios by weight and also, on other hand, molar ratios.

It has been found, surprisingly, that certain weight ratios of component TX to component (B) are able to give rise to synergistic activity. Therefore, a further aspect of the invention are compositions, wherein component TX and component (B) are present in the composition in amounts producing a synergistic effect. This synergistic activity is apparent from the fact that the fungicidal activity of the composition comprising component TX and component (B) is greater than the sum of the fungicidal activities of component TX and of component (B). This synergistic activity extends the range of action of component TX and component (B) in two ways. Firstly, the rates of application of component TX and component (B) are lowered whilst the action remains equally good, meaning that the active ingredient mixture still achieves a high degree of phytopathogen control even where the two individual components have become totally ineffective in such a low application rate range. Secondly, there is a substantial broadening of the spectrum of phytopathogens that can be controlled.

A synergistic effect exists whenever the action of an active ingredient combination is greater than the sum of the actions of the individual components. The action to be expected E for a given active ingredient combination obeys the so-called COLBY formula and can be calculated as follows (COLBY, S.R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

However, besides the actual synergistic action with respect to fungicidal activity, the compositions according to the invention can also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Some compositions according to the invention have a systemic action and can be used as foliar, soil and seed treatment fungicides.

With the compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The compositions according to the invention can be applied to the phytopathogenic microorganisms, the useful plants, the locus thereof, the propagation material thereof, storage goods or technical materials threatened by microorganism attack.

The compositions according to the invention may be applied before or after infection of the useful plants, the propagation material thereof, storage goods or technical materials by the microorganisms.

A further aspect of the present invention is a method of controlling diseases on useful plants or on propagation material thereof caused by phytopathogens, which comprises applying to the useful plants, the locus thereof or propagation material thereof a composition according to the invention. Preferred is a method, which comprises applying to the useful plants or to the locus thereof a composition according to the invention, more preferably to the useful plants. Further preferred is a method, which comprises applying to the propagation material of the useful plants a composition according to the invention.

Throughout this document the expression “composition” stands for the various mixtures or combinations of components TX and (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components TX and (B) is not essential for working the present invention.

The compositions according to the invention may also comprise more than one of the active components (B), if, for example, a broadening of the spectrum of disease control is desired.

For instance, it may be advantageous in the agricultural practice to combine two or three components (B) with component TX. An example is a composition comprising a compound of formula (I), azoxystrobin and cyproconazole.

Whereas it is preferred to formulate commercial products as concentrates, the end user will normally use dilute formulations.

Advantageous rates of application are normally from 5 g to 2 kg of active ingredient (a.i.) per hectare (ha), preferably from 10 g to 1 kg a.i./ha, most preferably from 20 g to 600 g a.i./ha. When used as seed drenching agent, convenient rates of application are from 10 mg to 1 g of active substance per kg of seeds. The rate of application for the desired action can be determined by experiments. It depends for example on the type of action, the developmental stage of the useful plant, and on the application (location, timing, application method) and can, owing to these parameters, vary within wide limits.

The compounds of formula (I), or a pharmaceutical salt thereof, described above may also have an advantageous spectrum of activity for the treatment and/or prevention of microbial infection in an animal. “Animal” can be any animal, for example, insect, mammal, reptile, fish, amphibian, preferably mammal, most preferably human. “Treatment” means the use on an animal which has microbial infection in order to reduce or slow or stop the increase or spread of the infection, or to reduce the infection or to cure the infection. “Prevention” means the use on an animal which has no apparent signs of microbial infection in order to prevent any future infection, or to reduce or slow the increase or spread of any future infection. According to the present invention there is provided the use of a compound of formula (I) in the manufacture of a medicament for use in the treatment and/or prevention of microbial infection in an animal. There is also provided the use of a compound of formula (I) as a pharmaceutical agent. There is also provided the use of a compound of formula (I) as an antimicrobial agent in the treatment of an animal. According to the present invention there is also provided a pharmaceutical composition comprising as an active ingredient a compound of formula (I), or a pharmaceutically acceptable salt thereof, and a pharmaceutically acceptable diluent or carrier. This composition can be used for the treatment and/or prevention of antimicrobial infection in an animal. This pharmaceutical composition can be in a form suitable for oral administration, such as tablet, lozenges, hard capsules, aqueous suspensions, oily suspensions, emulsions dispersible powders, dispersible granules, syrups and elixirs. Alternatively this pharmaceutical composition can be in a form suitable for topical application, such as a spray, a cream or lotion. Alternatively this pharmaceutical composition can be in a form suitable for parenteral administration, for example injection. Alternatively this pharmaceutical composition can be in inhalable form, such as an aerosol spray. The compounds of formula (I) may be effective against various microbial species able to cause a microbial infection in an animal. Examples of such microbial species are those causing Aspergillosis such as Aspergillus fumigatus, A. flavus, A. terrus, A. nidulans and A. niger, those causing Blastomycosis such as Blastomyces dermatitidis; those causing Candidiasis such as Candida albicans, C. glabrata, C. tropicalis, C. parapsilosis, C. krusei and C. lusitaniae; those causing Coccidioidomycosis such as Coccidioides immitis; those causing Cryptococcosis such as Cryptococcus neoformans; those causing Histoplasmosis such as Histoplasma capsulatum and those causing Zygomycosis such as Absidia corymbifera, Rhizomucor pusillus and Rhizopus arrhizus. Further examples are Fusarium Spp such as Fusarium oxysporum and Fusarium solani and Scedosporium Spp such as Scedosporium apiospermum and Scedosporium prolificans. Still further examples are Microsporum Spp, Trichophyton Spp, Epidermophyton Spp, Mucor Spp, Sporothorix Spp, Phialophora Spp, Cladosporium Spp, Petriellidium spp, Paracoccidioides Spp and Histoplasma Spp.

The following non-limiting examples illustrate the above-described invention in greater detail without limiting it.

### PREPARATORY EXAMPLES

### Example P1

### Preparation of 2-[6-(6-chloropyridin-3-ylmethyl)-pyridin-2-yl]-5,6,7,8-tetrahydroquinazoline

a) Preparation of 2-(6-bromopyridin-2-yl)-5,6,7,8-tetrahydroquinazoline: Sodium methylate (16.5 g of a 30% solution in methanol) is added to a solution of 6-bromopicolinimidamide hydrochloride (described in JP 01052772; 6.4 g, 32 mmol) in 350 ml of methanol. This reaction is stirred for 30 min at room temperature, then 2-(dimethylamino)methylene-cyclohexanone (described in Tetrahedron 1994, 50, 2255; 14.1 g, 92 mmol) is added and the reaction mixture is heated to reflux for 2 h. The mixture is cooled, diluted with water and extracted with tert-butyl methyl ether. The combined organic layer is dried over sodium sulfate, filtered and evaporated in vacuo, the remainder purified by crystallisation from ether/hexane to deliver 2-(6-bromopyridin-2-yl)-5,6,7,8-tetrahydroquinazoline as yellow crystalls, m.p. 126-128° C.

b) A mixture of 2-(6-bromopyridin-2-yl)-5,6,7,8-tetrahydroquinazoline (150 mg, 0.5 mmol) and bis(triphenylphosphine)palladium(II) dichloride (40 mg, 0.05 mmol) in 5 ml of tetrahydrofuran is heated to reflux. 2-Chloro-5-pyridylmethylzinc chloride (1.1 ml of a 0.5 M solution in tetrahydrofuran) is then added dropwise at this temperature. The reaction mixture is heated to reflux for one further hour, then cooled, poured on water and extracted with ethyl acetate. The combined organic layer is washed with brine, dried over sodium sulfate, filtered and evaporated in vacuo. The remainder is purified by chromatography on silica gel, using cyclohexane/dichloromethane 4:1 as eluent to deliver 2-[6-(6-chloropyridin-3-ylmethyl)-pyridin-2-yl]-5,6,7,8-tetrahydroquinazoline as a beige powder, m.p. 115-120° C.

### Example P2

### Preparation of 2-[6-(2-methylbenzyl)-pyridin-2-yl]-7,8-dihydro-5H-pyrano[4,3-d]pyrimidine

a) Preparation of 2-(6-bromopyridin-2-yl)-7,8-dihydro-5H-pyrano[4,3-d]pyrimidine: Sodium methylate (3.6 g of a 30% solution in methanol) is added to a solution of 6-bromopicolinimidamide hydrochloride (described in JP 01052772; 4.2 g, 18 mmol) in 35 ml of methanol. This reaction is stirred for 30 min at room temperature, then 3-(dimethylamino)methylene-2H-5,6-dihydropyran-4-one (described in WO 2004/060890; 3.3 g, 21 mmol) is added and the reaction mixture is heated to reflux for 2 h. The mixture is cooled, diluted with water and extracted with tert-butyl methyl ether. The combined organic layer is dried over sodium sulfate, filtered and evaporated in vacuo, the remainder purified by crystallisation from ether/hexane to deliver 2-(6-bromopyridin-2-yl)-7,8-dihydro-5H-pyrano[4,3-d]pyrimidine as a brown powder, m.p. 156-158° C.

b) A mixture of 2-(6-bromopyridin-2-yl)-7,8-dihydro-5H-pyrano[4,3-d]pyrimidine (120 mg, 0.41 mmol) and bis(triphenylphosphine)palladium(II) dichloride (29 mg, 0.04 mmol) in 4 ml of tetrahydrofuran is heated to reflux. 2-Methylbenzylzinc chloride (0.95 ml of a 0.5 M solution in tetrahydrofuran) is then added dropwise at this temperature. The reaction mixture is heated to reflux for one further hour, then cooled, poured on water and extracted with ethyl acetate. The combined organic layer is washed with brine, dried over sodium sulfate, filtered and evaporated in vacuo. The remainder is purified by chromatography on silica gel, using tetrahydrofuran/hexane 1:1 as eluent to deliver 2-[6-(2-methylbenzyl)-pyridin-2-yl]-7,8-dihydro-5H-pyrano[4,3-d]pyrimidine as a yellow powder, m.p. 132-133° C.

### Example P3

### Preparation of 2-[6-(2-methoxybenzyl)-pyridin-2-yl]-7,7-dimethyl-5,6,7,8-tetrahydroquinazoline

a) Preparation of 2-(6-bromopyridin-2-yl)-7,7-dimethyl-5,6,7,8-tetrahydroquinazoline: Sodium methylate (1.3 g of a 30% solution in methanol) is added to a solution of 6-bromopicolinimidamide hydrochloride (described in JP 01052772; 1.5 g, 6.3 mmol) in 25 ml of methanol. This reaction is stirred for 30 min at room temperature, then 1-Dimethylamino-methylidene-5,5-dimethyl-cyclohexan-2-one (described in Bull. Chem. Soc. Jpn. 1987, 60, 3285; 1.4 g, 7.6 mmol) is added and the reaction mixture is heated to reflux for 2 h. The mixture is cooled, diluted with water and extracted with tert-butyl methyl ether. The combined organic layer is dried over sodium sulfate, filtered and evaporated in vacuo, the remainder purified by crystallisation from ether/hexane to deliver 2-(6-bromopyridin-2-yl)-7,7-dimethyl-5,6,7,8-tetrahydroquinazoline as a grey powder, m.p. 175-177° C.

b) A mixture of 2-(6-bromopyridin-2-yl)-7,7-dimethyl-5,6,7,8-tetrahydroquinazoline (120 mg, 0.37 mmol) and bis(triphenylphosphine)palladium(II) dichloride (29 mg, 0.04 mmol) in 4 ml of tetrahydrofuran is heated to reflux. 2-Methoxybenzylzinc chloride (0.9 ml of a 0.5 M solution in tetrahydrofuran) is then added dropwise at this temperature. The reaction mixture is heated to reflux for one further hour, then cooled, poured on water and extracted with ethyl acetate. The combined organic layer is washed with brine, dried over sodium sulfate, filtered and evaporated in vacuo. The remainder is purified by chromatography on silica gel, using tetrahydrofuran/hexane 1:1 as eluent to deliver 2-[6-(2-methoxybenzyl)-pyridin-2-yl]-7,7-dimethyl-5,6,7,8-tetrahydroquinazoline as a yellow powder, m.p. 251-252° C.

### Example P4

### Preparation of 2-(6-Benzyl-pyridin-2-yl)-6,7,8,9-tetrahydro-5H-cycloheptapyrimidine

a) Preparation of 2-benzyl-pyridine: Anhydrous cobalt (II) acetylacetonate (0.454 g, 1.8 mmol) was taken in a two necked flask containing anhydrous dioxane (50 mL) under nitrogen. To the resulting red solution, benzyl magnesium chloride (2M ethereal solution, 26.54 mL, 53 mmol) was added at 0° C. The mixture was stirred for about 5 min at 25° C., and then 2-chloropyridine (2 g, 17.7 mmol) was added to it dropwise. After stirring for 30 min at the same temperature, the reaction mixture was poured into the water (50 mL). The product was extracted with ethyl acetate (3×150 mL). The combined organic extracts were dried over anhydrous sodium sulphate and were concentrated under reduced pressure. Purification of the crude product by column chromatography (silica gel column, 20% ethyl acetate in hexane) provided the 2-benzylpyridine in as viscous liquid.

¹HNMR (400 MHZ, CDCl₃): δ 8.58-8.54 (m, 1H), 7.59-7.55 (ddd, J=7.70 Hz and 1.83 Hz, 1H), 7.4-7.2 (m, 5H), 7.14-6.19 (m, 2H), 4.2 (s, 2H).

b) Preparation of 2-benzylpyridin-1-oxide: To a solution of 2-benzylpyridine (1 g, 6 mmol) in dichlomethane (30 ml) in a 100 ml round bottom flask was added 3-chloroperbenzoic acid (50%, 1.5 g, 9 mmol) in small portions over a period of 10 min. at 0° C. After complete addition, the reaction mixture was stirred at room temperature till completion of the reaction. The excess peracid was decomposed with 5% aqueous sodium metabisulfite solution and the reaction mass was concentrated under reduced pressure and was subjected to column chromatography (silica column) using 5% methanol in dichloromethane as eluent to afford the desired product as viscous liquid.

¹HNMR (400 MHZ, CDCl₃): δ 8.34-8.29 (m, 1H), 7.38-7.33 (m, 2H), 7.32-7.25 (m, 3H), 7.18-7.14 (m, 2H), 6.97-6.92 (m, 1H), 4.2 (s, 2H).

c) Preparation of 6-benzyl-pyridine-2-carbonitrile: To a solution of 2-benzyl-pyridin-1-ol (0.9 g, 5 mmol) in dichloromethane in a two necked flask was added trimethylsilyl cyanide (0.96 g, 10 mmol) followed by drop wise addition of carbamoyl chloride (0.8 g, 7 mmol). The reaction mixture was allowed to stir at room temperature for two days and was washed with saturated sodium bicarbonate solution, and finally was extracted with dichloromethane (3×50 mL). Organic layer was dried over anhydrous sodium sulphate, concentrated under reduced pressure followed by purification using flash chromatography. The desired product was obtained as viscous liquid.

¹HNMR (400 MHZ, CDCl₃): δ 7.67-7.61 (dd, J=7.79 Hz, 1H), 7.48-7.44 (dd, J=7.69 Hz, 1H), 7.28-7.22 (m, 3H), 7.21-7.14 (m, 3H), 4.2 (s, 2H).

d) Preparation of 6-benzyl-pyridine-2-carboxamidine hydrochloride: To a solution of 2-cyano-6-benzyl pyridine (0.5 g, 2.6 mmol) in methanol (10 mL) in a two necked flask was added freshly prepared sodium methoxide (0.278 g, 5 mmol) and the reaction mixture was allowed to stir for 3 hours. To this reaction mixture ammonium chloride (0.418 g, 8 mmol) was added and the reaction mixture was allowed to stir for another 3 hours at the same temperature. After the completion of the reaction methanol was evaporated from the reaction mixture under reduced pressure to get the desired amidine hydrochloride salt as white solid.

¹HNMR (400 MHZ, DMSO-d₆): δ 8.33-8.28 (d, J=7.63 Hz, 1H), 8.08-8.02 (dd, J=8.02 Hz, 1H), 7.66-7.63 (d, J=7.76 Hz, 1H), 7.38-7.34 (m, 2H), 7.33-7.28 (m, 2H), 7.24-7.18 (m, 1H), 4.2 (s, 2H).

e) Preparation of 2-(6-benzyl-pyridin-2-yl)-6,7,8,9-tetrahydro-5H-cycloheptapyrimidine: To a solution of 6-benzylpyridine-2-carboxamidine hydrochloride (0.2 g, 0.9 mmol) in methanol in a two necked flask was added sodium methoxide (0.1 g, 1.9 mmol) at room temperature. Then 2-(1-dimethylamino-methylidene)-cycloheptanone (0.239 g, 1.4 mmol) was added to the reaction mixture and was allowed to heat at 60° C. for 6 hours. After the completion of reaction methanol from the reaction mixture was evaporated off, the residual mass was washed with water and was extracted with ethyl acetate (3×20 mL). The organic layer was dried over anhydrous sodium sulphate and was concentrated under reduced pressure. Purification of the crude product was done by column chromatography (silica gel column) using 15% ethyl acetate in hexane as eluant to afford the desired product as a brown gum.

¹HNMR (400 MHZ, CDCl₃): δ 8.6 (s, 1H), 8.30-8.27 (d, J=7.95 Hz, 1H), 7.73-7.67 (dd, J=7.8 Hz, 1H), 7.36-7.28 (m, 4H), 7.26-7.20 (m, 1H), 7.06 (d, J=7.8 Hz, 1H), 4.4 (s, 2H), 3.2 (m, 2H), 2.8 (m, 2H), 1.9 (m, 2H), 1.8 (m, 4H)

### Example P5

### Preparation of 2-[6-(6-Methoxy-pyridin-3-ylmethyl)-pyridin-2-yl]-6,7,8,9-tetrahydro-5H-cycloheptapyrimidine

a) Preparation of 2-(6-methoxy-pyridin-3-ylmethyl)-pyridin-1-oxide: Pd₂(dba)₃ (70 mg, 0.08 mmol), X-phos (70 g, 16 mmol), NaOtBu (0.8 g, 8 mmol) and 2-picoline N-oxide (0.58 g, 5.3 mmol) were weighed and placed in a microwave vial with a magnetic stirrer bar. The flask was capped with rubber septum and purged with nitrogen. 5-bromo-2-methoxy pyridine (0.5 g, 2.67 mmol) and anhydrous toluene (10 mL) were then added via syringe and the mixture was degassed with nitrogen. The rubber septum was then replaced by microwave tube cap and the mixture was then placed in a microwave synthesiser at 110° C. for 60 min(max power-200 w, pressure-3 bar). After the completion of the reaction, the reaction mixture was diluted with 50 mL of dichloromethane, filtered through celite and then evaporated under reduced pressure. The residue was purified by flash chromatography using 8% methanol in dichloromethane, having the desired product as viscous oil.

¹HNMR (400 MHZ, CDCl₃): δ 8.2-8.3 (m, 1H), 8.09 (d, J=2.3 Hz, 1H), 7.54 (dd, J=8.51 Hz, 1H), 7.16-7.2 (m, 3H), 7.0-7.06 (m, 1H), 4.17 (s, 2H), 3.9 (S, 3H).

b) Preparation of 6-(6-methoxy-pyridin-3-ylmethyl)-pyridine-2-carbonitrile: To a solution of 2-(6-methoxy-pyridin-3-ylmethyl)-pyridin-1-oxide (0.2 g, 1 mmol) in dichloromethane (10 ml) in a two neck flask was added trimethylsilyl cyanide (0.18 g, 1.8 mmol) followed by dropwise addition of carbamoyl chloride (0.147 g, 1.4 mmol). The reaction mixture was allowed to stir at room temperature for two days. After completion of the reaction, the reaction mixture was washed with saturated sodium bicarbonate solution, and extracted with dichloromethane. The organic layer was dried over sodium sulphate, concentrated under reduced pressure and purified by flash chromatography. The desired product was obtained as viscous liquid.

¹HNMR (400 MHZ, CDCl₃): δ 8.07 (d, J=2.43 Hz, 1H), 7.73 (dd, J=7.6 Hz, J=8 Hz, 1H), 7.55 (dd, J=0.8 Hz, 1.2 Hz, 1H), 7.48 (dd, J=2.8 Hz, J=2.4, 1H), 7.32 (dd, J=0.8 Hz, each, 1H), 6.71 (d, J=8.46 Hz, 1H), 4.1 (s, 2H), 3.8 (s, 3H).

c) Preparation of 6-[(6-methoxy-3-pyridyl)methyl]pyridine-2-carboxamidine hydrochloride: To a solution of 6-(6-Methoxy-pyridin-3-ylmethyl)-pyridine-2-carbonitrile (0.1 g, 0.4 mmol) in methanol (5 mL) in two neck flask was added freshly prepared sodium methoxide (0.048 g, 0.8 mmol) and the reaction mixture was allowed to stir for 3 hours. To this reaction mixture ammonium chloride (0.07 g, 1.3 mmol) was added and the reaction mixture was allowed to stir at room temperature for 3 hours. After the completion of the reaction, methanol was evaporated from the reaction mixture to get the desire product as white solid.

¹HNMR (400 MHZ, DMSO-d₆): δ 8.3 (d, J=2 Hz, 1H), 8.2 (d, J=2.23 Hz, 1H), 8.08 (dd, J=7.6 Hz, J=8 Hz, 1H), 7.73 (dd, J=2.4 Hz each, J=2H), 7.68 (d, J=7.92 Hz, 3H), 6.75 (d, J=8.4 Hz, 1H), 4.1 (s, 2H), 3.8 (s, 3H).

d) Preparation of 2-[6-(6-methoxy-pyridin-3-ylmethyl)-pyridin-2-yl]-6,7,8,9-tetrahydro-5H-cycloheptapyrimidine: To a solution of 6-[(6-methoxy-3-pyridyl) methyl]pyridine-2-carboxamidine hydrochloride (0.2 g, 0.8 mmol) in methanol in a two necked flask was added sodium methoxide (0.09 g, 1.6 mmol) at room temperature. Then 2-(1-dimethylamino-methylidene)-cycloheptanone (0.207 g, 1.2 mmol) was added to the reaction mixture and was allowed to heat at 60° C. for 6 hours. After the completion of the reaction, methanol from the reaction mixture was concentrated and the residue was washed with water and extracted with ethyl acetate (30 mL). The organic layer was dried over sodium sulphate and concentrated. Purification of the product was done by flash chromatography using 15% ethyl acetate in hexane afforded the desired product as a brown gummy mass.

¹HNMR (400 MHZ, CDCL₃): δ 8.6 (s, 1H), 8.3 (d, J=7.95 Hz, 1H), 8.1 (d, J=2.39 Hz, 1H), 7.7 (dd, J=8 Hz each, 1H), 7.5 (dd, J=2.8 Hz each, 1H), 7.05 (d, J=7.69 Hz, 1H), 6.7 (d, J=8.35 Hz, 1H), 4.4 (s, 2H), 3.8 (s, 3H), 3.2 (m, 2H), 2.8 (m, 2H), 1.9 (m, 2H), 1.8 (m, 4H)

Table A below defines chemical designations for the substituents R₁, R₂, R₃, R₄ and R₅ for the compounds of formula I while the meaning of R₆ is given in the Tables 1 to 57:

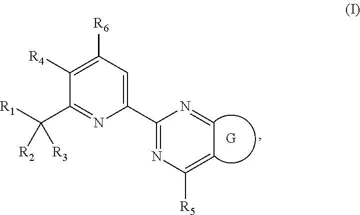

TABLE A
chemical designations for substituents R₁, R₂, R₃, R₄ and R₅
of the compound of formula I:

| Line | R₁ | R₂ | R₃ | R₄ | R₅ |
|---|---|---|---|---|---|
| A.1.1 | phenyl | H | H | H | H |
| A.1.2 | phenyl | CH₃ | H | H | H |
| A.1.3 | phenyl | CH₃ | CH₃ | H | H |
| A.1.4 | phenyl | H | H | CH₃ | H |
| A.1.5 | phenyl | H | H | H | CH₃ |
| A.1.6 | 2-chlorophenyl | H | H | H | H |
| A.1.7 | 2-chlorophenyl | CH₃ | H | H | H |
| A.1.8 | 2-chlorophenyl | CH₃ | CH₃ | H | H |
| A.1.9 | 2-chlorophenyl | H | H | CH₃ | H |
| A.1.10 | 2-chlorophenyl | H | H | H | CH₃ |
| A.1.11 | 3-chlorophenyl | H | H | H | H |
| A.1.12 | 3-chlorophenyl | CH₃ | H | H | H |
| A.1.13 | 3-chlorophenyl | CH₃ | CH₃ | H | H |
| A.1.14 | 3-chlorophenyl | H | H | CH₃ | H |
| A.1.15 | 3-chlorophenyl | H | H | H | CH₃ |
| A.1.16 | 4-chlorophenyl | H | H | H | H |
| A.1.17 | 4-chlorophenyl | CH₃ | H | H | H |
| A.1.18 | 4-chlorophenyl | CH₃ | CH₃ | H | H |
| A.1.19 | 4-chlorophenyl | H | H | CH₃ | H |
| A.1.20 | 4-chlorophenyl | H | H | H | CH₃ |
| A.1.21 | 2-fluorophenyl | H | H | H | H |
| A.1.22 | 2-fluorophenyl | CH₃ | H | H | H |
| A.1.23 | 2-fluorophenyl | CH₃ | CH₃ | H | H |
| A.1.24 | 2-fluorophenyl | H | H | CH₃ | H |
| A.1.25 | 2-fluorophenyl | H | H | H | CH₃ |
| A.1.26 | 2-methylthiophenyl | H | H | H | H |
| A.1.27 | 2-methylthiophenyl | CH₃ | H | H | H |
| A.1.28 | 2-methylthiophenyl | CH₃ | CH₃ | H | H |
| A.1.29 | 2-methylthiophenyl | H | H | CH₃ | H |
| A.1.30 | 2-methylthiophenyl | H | H | H | CH₃ |
| A.1.31 | 2-methylphenyl | H | H | H | H |
| A.1.32 | 2-methylphenyl | CH₃ | H | H | H |
| A.1.33 | 2-methylphenyl | CH₃ | CH₃ | H | H |
| A.1.34 | 2-methylphenyl | H | H | CH₃ | H |
| A.1.35 | 2-methylphenyl | H | H | H | CH₃ |
| A.1.36 | 2-methoxyphenyl | H | H | H | H |
| A.1.37 | 2-methoxyphenyl | CH₃ | H | H | H |
| A.1.38 | 2-methoxyphenyl | CH₃ | CH₃ | H | H |
| A.1.39 | 2-methoxyphenyl | H | H | CH₃ | H |
| A.1.40 | 2-methoxyphenyl | H | H | H | CH₃ |
| A.1.41 | 2-trifluoromethylphenyl | H | H | H | H |
| A.1.42 | 2-trifluoromethylphenyl | CH₃ | H | H | H |
| A.1.43 | 2-trifluoromethylphenyl | CH₃ | CH₃ | H | H |
| A.1.44 | 2-trifluoromethylphenyl | H | H | CH₃ | H |
| A.1.45 | 2-trifluoromethylphenyl | H | H | H | CH₃ |
| A.1.46 | 2-trifluoromethoxyphenyl | H | H | H | H |
| A.1.47 | 2-trifluoromethoxyphenyl | CH₃ | H | H | H |
| A.1.48 | 2-trifluoromethoxyphenyl | CH₃ | CH₃ | H | H |
| A.1.49 | 2-trifluoromethoxyphenyl | H | H | CH₃ | H |
| A.1.50 | 2-trifluoromethoxyphenyl | H | H | H | CH₃ |
| A.1.51 | 2-cyanophenyl | H | H | H | H |
| A.1.52 | 2-cyanophenyl | CH₃ | H | H | H |
| A.1.53 | 2-cyanophenyl | CH₃ | CH₃ | H | H |
| A.1.54 | 2-cyanophenyl | H | H | CH₃ | H |
| A.1.55 | 2-cyanophenyl | H | H | H | CH₃ |
| A.1.56 | 3-cyanophenyl | H | H | H | H |
| A.1.57 | 3-cyanophenyl | CH₃ | H | H | H |
| A.1.58 | 3-cyanophenyl | CH₃ | CH₃ | H | H |
| A.1.59 | 3-cyanophenyl | H | H | CH₃ | H |
| A.1.60 | 3-cyanophenyl | H | H | H | CH₃ |
| A.1.61 | pyrid-2-yl | H | H | H | H |
| A.1.62 | pyrid-2-yl | CH₃ | H | H | H |
| A.1.63 | pyrid-2-yl | CH₃ | CH₃ | H | H |
| A.1.64 | pyrid-2-yl | H | H | CH₃ | H |
| A.1.65 | pyrid-2-yl | H | H | H | CH₃ |
| A.1.66 | pyrid-3-yl | H | H | H | H |
| A.1.67 | pyrid-3-yl | CH₃ | H | H | H |
| A.1.68 | pyrid-3-yl | CH₃ | CH₃ | H | H |
| A.1.69 | pyrid-3-yl | H | H | CH₃ | H |
| A.1.70 | pyrid-3-yl | H | H | H | CH₃ |
| A.1.71 | pyrid-4-yl | H | H | H | H |
| A.1.72 | pyrid-4-yl | CH₃ | H | H | H |
| A.1.73 | pyrid-4-yl | CH₃ | CH₃ | H | H |
| A.1.74 | pyrid-4-yl | H | H | CH₃ | H |
| A.1.75 | pyrid-4-yl | H | H | H | CH₃ |
| A.1.76 | 6-chloropyrid-2-yl | H | H | H | H |
| A.1.77 | 6-chloropyrid-2-yl | CH₃ | H | H | H |
| A.1.78 | 6-chloropyrid-2-yl | CH₃ | CH₃ | H | H |
| A.1.79 | 6-chloropyrid-2-yl | H | H | CH₃ | H |
| A.1.80 | 6-chloropyrid-2-yl | H | H | H | CH₃ |
| A.1.81 | 2,5-dimethylphenyl | H | H | H | H |
| A.1.82 | 2,5-dimethylphenyl | CH₃ | H | H | H |
| A.1.83 | 2,5-dimethylphenyl | CH₃ | CH₃ | H | H |
| A.1.84 | 2,5-dimethylphenyl | H | H | CH₃ | H |
| A.1.85 | 2,5-dimethylphenyl | H | H | H | CH₃ |
| A.1.86 | 6-chloropyrid-3-yl | H | H | H | H |
| A.1.87 | 6-chloropyrid-3-yl | CH₃ | H | H | H |
| A.1.88 | 6-chloropyrid-3-yl | CH₃ | CH₃ | H | H |
| A.1.89 | 6-chloropyrid-3-yl | H | H | CH₃ | H |
| A.1.90 | 6-chloropyrid-3-yl | H | H | H | CH₃ |
| A.1.91 | 2-chloropyrid-4-yl | H | H | H | H |
| A.1.92 | 2-chloropyrid-4-yl | CH₃ | H | H | H |
| A.1.93 | 2-chloropyrid-4-yl | CH₃ | CH₃ | H | H |
| A.1.94 | 2-chloropyrid-4-yl | H | H | CH₃ | H |
| A.1.95 | 2-chloropyrid-4-yl | H | H | H | CH₃ |
| A.1.96 | 2-methylpyrid-4-yl | H | H | H | H |
| A.1.97 | 2-methylpyrid-4-yl | CH₃ | H | H | H |
| A.1.98 | 2-methylpyrid-4-yl | CH₃ | CH₃ | H | H |
| A.1.99 | 2-methylpyrid-4-yl | H | H | CH₃ | H |
| A.1.100 | 2-methylpyrid-4-yl | H | H | H | CH₃ |
| A.1.101 | 3-fluorophenyl | H | H | H | H |
| A.1.102 | 3-fluorophenyl | CH₃ | H | H | H |
| A.1.103 | 3-fluorophenyl | CH₃ | CH₃ | H | H |
| A.1.104 | 3-fluorophenyl | H | H | CH₃ | H |
| A.1.105 | 3-fluorophenyl | H | H | H | CH₃ |
| A.1.106 | 4-fluorophenyl | H | H | H | H |
| A.1.107 | 4-fluorophenyl | CH₃ | H | H | H |
| A.1.108 | 4-fluorophenyl | CH₃ | CH₃ | H | H |
| A.1.109 | 4-fluorophenyl | H | H | CH₃ | H |
| A.1.110 | 4-fluorophenyl | H | H | H | CH₃ |
| A.1.111 | 3-methylphenyl | H | H | H | H |
| A.1.112 | 3-methylphenyl | CH₃ | H | H | H |
| A.1.113 | 3-methylphenyl | CH₃ | CH₃ | H | H |
| A.1.114 | 3-methylphenyl | H | H | CH₃ | H |
| A.1.115 | 3-methylphenyl | H | H | H | CH₃ |
| A.1.116 | 4-methylphenyl | H | H | H | H |
| A.1.117 | 4-methylphenyl | CH₃ | H | H | H |
| A.1.118 | 4-methylphenyl | CH₃ | CH₃ | H | H |
| A.1.119 | 4-methylphenyl | H | H | CH₃ | H |
| A.1.120 | 4-methylphenyl | H | H | H | CH₃ |
| A.1.121 | 3-methoxyphenyl | H | H | H | H |
| A.1.122 | 3-methoxyphenyl | CH₃ | H | H | H |
| A.1.123 | 3-methoxyphenyl | CH₃ | CH₃ | H | H |
| A.1.124 | 3-methoxyphenyl | H | H | CH₃ | H |
| A.1.125 | 3-methoxyphenyl | H | H | H | CH₃ |
| A.1.126 | 4-methoxyphenyl | H | H | H | H |
| A.1.127 | 4-methoxyphenyl | CH₃ | H | H | H |
| A.1.128 | 4-methoxyphenyl | CH₃ | CH₃ | H | H |
| A.1.129 | 4-methoxyphenyl | H | H | CH₃ | H |
| A.1.130 | 4-methoxyphenyl | H | H | H | CH₃ |
| A.1.131 | 3-trifluoromethylphenyl | H | H | H | H |
| A.1.132 | 3-trifluoromethylphenyl | CH₃ | H | H | H |
| A.1.133 | 3-trifluoromethylphenyl | CH₃ | CH₃ | H | H |
| A.1.134 | 3-trifluoromethylphenyl | H | H | CH₃ | H |
| A.1.135 | 3-trifluoromethylphenyl | H | H | H | CH₃ |
| A.1.136 | 2-(2-Methoxy-ethoxy) | H | H | H | H |
| | phenyl | | | | |
| A.1.137 | 2-(2-Methoxy-ethoxy) | CH₃ | H | H | H |
| | phenyl | | | | |
| A.1.138 | 2-(2-Methoxy-ethoxy) | CH₃ | CH₃ | H | H |
| | phenyl | | | | |
| A.1.139 | 2-(2-Methoxy-ethoxy) | H | H | CH₃ | H |
| | phenyl | | | | |
| A.1.140 | 2-(2-Methoxy-ethoxy) | H | H | H | CH₃ |
| | phenyl | | | | |
| A.1.141 | 3-trifluoromethoxyphenyl | H | H | H | H |
| A.1.142 | 3-trifluoromethoxyphenyl | CH₃ | H | H | H |
| A.1.143 | 3-trifluoromethoxyphenyl | CH₃ | CH₃ | H | H |
| A.1.144 | 3-trifluoromethoxyphenyl | H | H | CH₃ | H |
| A.1.145 | 3-trifluoromethoxyphenyl | H | H | H | CH₃ |
| A.1.146 | 4-trifluoromethoxyphenyl | H | H | H | H |
| A.1.147 | 4-trifluoromethoxyphenyl | CH₃ | H | H | H |
| A.1.148 | 4-trifluoromethoxyphenyl | CH₃ | CH₃ | H | H |
| A.1.149 | 4-trifluoromethoxyphenyl | H | H | CH₃ | H |
| A.1.150 | 4-trifluoromethoxyphenyl | H | H | H | CH₃ |
| A.1.151 | 4-cyanophenyl | H | H | H | H |
| A.1.152 | 4-cyanophenyl | CH₃ | H | H | H |
| A.1.153 | 4-cyanophenyl | CH₃ | CH₃ | H | H |
| A.1.154 | 4-cyanophenyl | H | H | CH₃ | H |
| A.1.155 | 4-cyanophenyl | H | H | H | CH₃ |
| A.1.156 | 2,3-dimethylphenyl | H | H | H | H |
| A.1.157 | 2,3-dimethylphenyl | CH₃ | H | H | H |
| A.1.158 | 2,3-dimethylphenyl | CH₃ | CH₃ | H | H |
| A.1.159 | 2,3-dimethylphenyl | H | H | CH₃ | H |
| A.1.160 | 2,3-dimethylphenyl | H | H | H | CH₃ |
| A.1.161 | 2,4-dimethylphenyl | H | H | H | H |
| A.1.162 | 2,4-dimethylphenyl | CH₃ | H | H | H |
| A.1.163 | 2,4-dimethylphenyl | CH₃ | CH₃ | H | H |
| A.1.164 | 2,4-dimethylphenyl | H | H | CH₃ | H |
| A.1.165 | 2,4-dimethylphenyl | H | H | H | CH₃ |
| A.1.166 | 2,5-dimethylphenyl | H | H | H | H |
| A.1.167 | 2,5-dimethylphenyl | CH₃ | H | H | H |
| A.1.168 | 2,5-dimethylphenyl | CH₃ | CH₃ | H | H |
| A.1.169 | 2,5-dimethylphenyl | H | H | CH₃ | H |
| A.1.170 | 2,5-dimethylphenyl | H | H | H | CH₃ |
| A.1.171 | 6-methoxypyrid-3-yl | H | H | H | H |
| A.1.172 | 6-methoxypyrid-3-yl | CH₃ | H | H | H |
| A.1.173 | 6-methoxypyrid-3-yl | CH₃ | CH₃ | H | H |
| A.1.174 | 6-methoxypyrid-3-yl | H | H | CH₃ | H |
| A.1.175 | 6-methoxypyrid-3-yl | H | H | H | CH₃ |
| A.1.176 | 6-methoxypyrid-2-yl | H | H | H | H |
| A.1.177 | 6-methoxypyrid-2-yl | CH₃ | H | H | H |
| A.1.178 | 6-methoxypyrid-2-yl | CH₃ | CH₃ | H | H |
| A.1.179 | 6-methoxypyrid-2-yl | H | H | CH₃ | H |
| A.1.180 | 6-methoxypyrid-2-yl | H | H | H | CH₃ |
| A.1.181 | 6-methylpyrid-2-yl | H | H | H | H |
| A.1.182 | 6-methylpyrid-2-yl | CH₃ | H | H | H |
| A.1.183 | 6-methylpyrid-2-yl | CH₃ | CH₃ | H | H |
| A.1.184 | 6-methylpyrid-2-yl | H | H | CH₃ | H |
| A.1.185 | 6-methylpyrid-2-yl | H | H | H | CH₃ |
| A.1.186 | 6-methylpyrid-3-yl | H | H | H | H |
| A.1.187 | 6-methylpyrid-3-yl | CH₃ | H | H | H |
| A.1.188 | 6-methylpyrid-3-yl | CH₃ | CH₃ | H | H |
| A.1.189 | 6-methylpyrid-3-yl | H | H | CH₃ | H |
| A.1.190 | 6-methylpyrid-3-yl | H | H | H | CH₃ |
| A.1.191 | thien-2-yl | H | H | H | H |
| A.1.192 | thien-2-yl | CH₃ | H | H | H |
| A.1.193 | thien-2-yl | CH₃ | CH₃ | H | H |
| A.1.194 | thien-2-yl | H | H | CH₃ | H |
| A.1.195 | thien-2-yl | H | H | H | CH₃ |
| A.1.196 | thien-3-yl | H | H | H | H |
| A.1.197 | thien-3-yl | CH₃ | H | H | H |
| A.1.198 | thien-3-yl | CH₃ | CH₃ | H | H |
| A.1.199 | thien-3-yl | H | H | CH₃ | H |
| A.1.200 | thien-3-yl | H | H | H | CH₃ |
| A.1.201 | 2-fluoro-3-methylphenyl | H | H | H | H |
| A.1.202 | 2-fluoro-3-methylphenyl | CH₃ | H | H | H |
| A.1.203 | 2-fluoro-3-methylphenyl | CH₃ | CH₃ | H | H |
| A.1.204 | 2-fluoro-3-methylphenyl | H | H | CH₃ | H |
| A.1.205 | 2-fluoro-3-methylphenyl | H | H | H | CH₃ |
| A.1.206 | 6-methoxypyrid-4-yl | H | H | H | H |
| A.1.207 | 6-methoxypyrid-4-yl | CH₃ | H | H | H |
| A.1.208 | 6-methoxypyrid-4-yl | CH₃ | CH₃ | H | H |
| A.1.209 | 6-methoxypyrid-4-yl | H | H | CH₃ | H |
| A.1.210 | 6-methoxypyrid-4-yl | H | H | H | CH₃ |
| A.1.211 | 2,5-dimethoxyphenyl | H | H | H | H |
| A.1.212 | 2,5-dimethoxyphenyl | CH₃ | H | H | H |
| A.1.213 | 2,5-dimethoxyphenyl | CH₃ | CH₃ | H | H |
| A.1.214 | 2,5-dimethoxyphenyl | H | H | CH₃ | H |
| A.1.215 | 2,5-dimethoxyphenyl | H | H | H | CH₃ |

Table 1:

This table discloses the 215 compounds T1.1.1 to T1.1.215 of formula

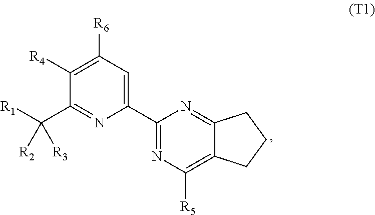

in which, for each of these 215 specific compounds, each of the of the variables R₁, R₂, R₃, R₄ and R₅ has the specific meaning given in the corresponding line, appropriately selected from the 215 lines A.1.1 to A.1.215 of Table A and R₆ is H. For example, the specific compound T1.1.23 is the compound of the formula T1, in which each of the variables R₁, R₂, R₃, R₄ and R₅ has the specific meaning given in the line A.1.23 of the Table A and R₆ is H, and has therefor the following formula:

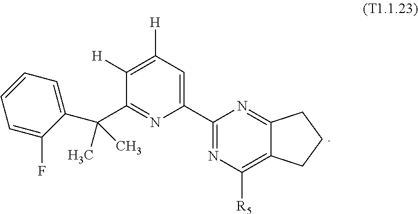

According to the same system, also all of the other 215 specific compounds disclosed in the Table 1 as well as all of the specific compounds disclosed in the Tables 2 to 19 are specified analogously.

Table 2:

This table discloses the 215 compounds T2.1.1 to T2.1. 215 of the formula

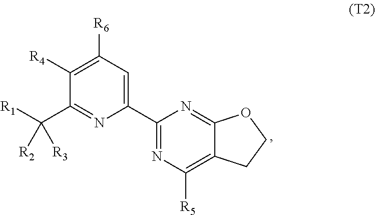

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 3:

This table discloses the 215 compounds T3.1.1 to T3.1. 215 of the formula

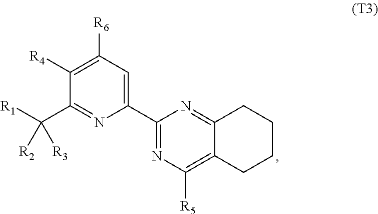

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 4:

This table discloses the 215 compounds T4.1.1 to T4.1. 215 of the formula

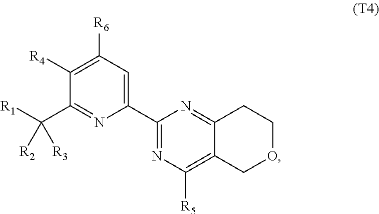

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 5:

This table discloses the 215 compounds T5.1.1 to T5.1. 215 of the formula

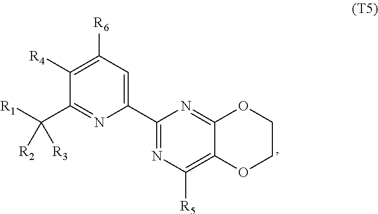

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 6:

This table discloses the 215 compounds T6.1.1 to T6.1. 215 of the formula

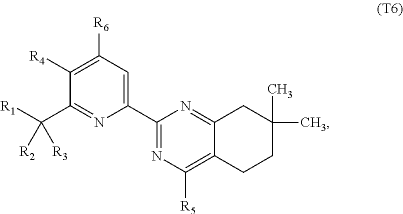

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 7:

This table discloses the 215 compounds T7.1.1 to T7.1. 215 of the formula

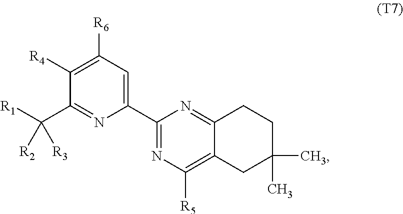

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 8:

This table discloses the 215 compounds T8.1.1 to T8.1. 215 of the formula

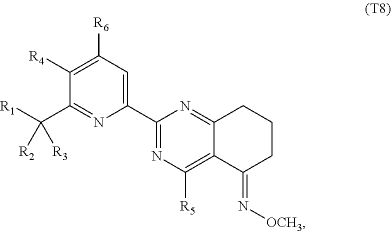

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 9:

This table discloses the 215 compounds T9.1.1 to T9.1. 215 of the formula

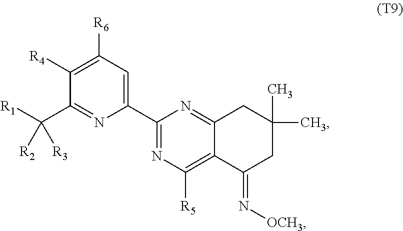

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 10:

This table discloses the 215 compounds T10.1.1 to T10.1. 215 of the formula

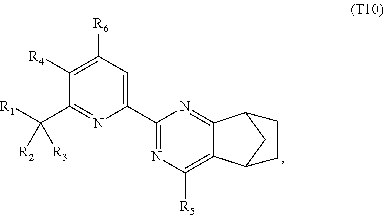

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 11:

This table discloses the 215 compounds T11.1.1 to T11.1. 215 of the formula

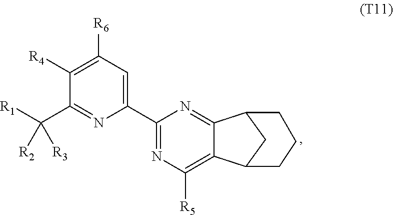

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 12:

This table discloses the 215 compounds T12.1.1 to T12.1. 215 of the formula

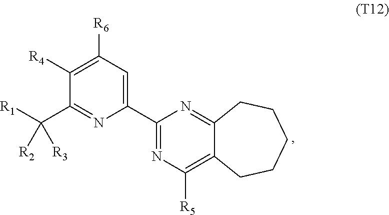

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 13:

This table discloses the 215 compounds T13.1.1 to T13.1. 215 of the formula

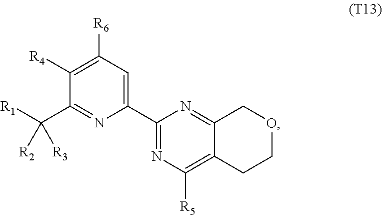

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 14:

This table discloses the 215 compounds T14.1.1 to T14.1. 215 of the formula

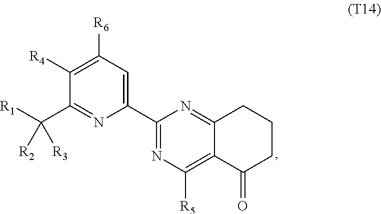

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 15:

This table discloses the 215 compounds T15.1.1 to T15.1. 215 of the formula

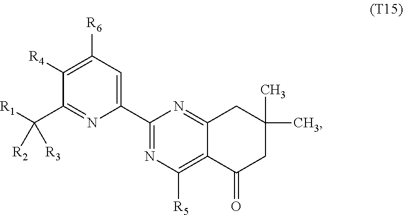

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 16:

This table discloses the 215 compounds T16.1.1 to T16.1. 215 of the formula

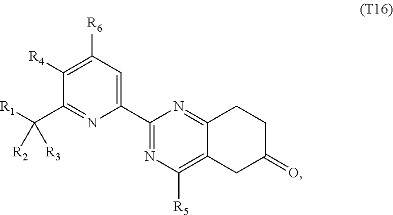

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 17:

This table discloses the 215 compounds T17.1.1 to T17.1. 215 of the formula

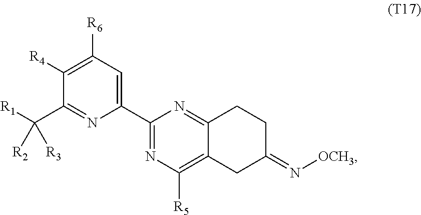

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 18:

This table discloses the 215 compounds T18.1.1 to T18.1. 215 of the formula

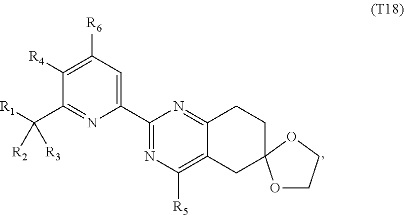

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 19:

This table discloses the 215 compounds T19.1.1 to T19.1. 215 of the formula

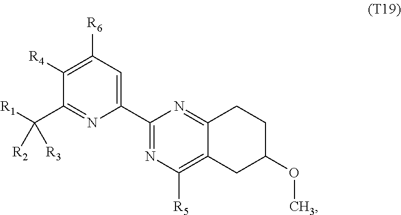

in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is H.

Table 20:

This table discloses the 215 compounds T20.1.1 to T20.1. 215 of the formula (T1) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 21:

This table discloses the 215 compounds T21.1.1 to T21.1. 215 of the formula (T2) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 22:

This table discloses the 215 compounds T22.1.1 to T22.1. 215 of the formula (T3) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 23:

This table discloses the 215 compounds T23.1.1 to T23.1. 215 of the formula (T4) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 24:

This table discloses the 215 compounds T24.1.1 to T24.1. 215 of the formula (T5) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 25:

This table discloses the 215 compounds T25.1.1 to T25.1. 215 of the formula (T6) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 26:

This table discloses the 215 compounds T26.1.1 to T26.1. 215 of the formula (T7) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 27

This table discloses the 215 compounds T27.1.1 to T27.1. 215 of the formula (T8) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 28:

This table discloses the 215 compounds T28.1.1 to T28.1. 215 of the formula (T9) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 29:

This table discloses the 215 compounds T29.1.1 to T29.1. 215 of the formula (T10) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 30:

This table discloses the 215 compounds T30.1.1 to T30.1. 215 of the formula (T11) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 31:

This table discloses the 215 compounds T31.1.1 to T31.1. 215 of the formula (T12) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 32:

This table discloses the 215 compounds T32.1.1 to T32.1. 215 of the formula (T13) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 33:

This table discloses the 215 compounds T33.1.1 to T33.1. 215 of the formula (T14) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 34:

This table discloses the 215 compounds T34.1.1 to T34.1. 215 of the formula (T15) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 35:

This table discloses the 215 compounds T35.1.1 to T35.1. 215 of the formula (T16) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 36:

This table discloses the 215 compounds T36.1.1 to T36.1. 215 of the formula (T17) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 37:

This table discloses the 215 compounds T37.1.1 to T37.1. 215 of the formula (T18) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 38:

This table discloses the 215 compounds T38.1.1 to T38.1. 215 of the formula (T19) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is CH₃.

Table 39:

This table discloses the 215 compounds T39.1.1 to T39.1. 215 of the formula (T1) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 40:

This table discloses the 215 compounds T40.1.1 to T40.1. 215 of the formula (T2) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 41:

This table discloses the 215 compounds T41.1.1 to T41.1. 215 of the formula (T3) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 42:

This table discloses the 215 compounds T42.1.1 to T42.1. 215 of the formula (T4) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 43:

This table discloses the 215 compounds T43.1.1 to T43.1. 215 of the formula (T5) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 44:

This table discloses the 215 compounds T44.1.1 to T44.1. 215 of the formula (T6) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 45:

This table discloses the 215 compounds T45.1.1 to T45.1. 215 of the formula (T7) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 46:

This table discloses the 215 compounds T46.1.1 to T46.1. 215 of the formula (T8) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 47

This table discloses the 215 compounds T47.1.1 to T47.1. 215 of the formula (T9) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 48:

This table discloses the 215 compounds T48.1.1 to T48.1. 215 of the formula (T10) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 49:

This table discloses the 215 compounds T49.1.1 to T49.1. 215 of the formula (T11) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 50:

This table discloses the 215 compounds T50.1.1 to T50.1. 215 of the formula (T12) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 51:

This table discloses the 215 compounds T51.1.1 to T51.1. 215 of the formula (T13) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 52:

This table discloses the 215 compounds T52.1.1 to T52.1. 215 of the formula (T14) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 53:

This table discloses the 215 compounds T53.1.1 to T53.1. 215 of the formula (T15) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 54:

This table discloses the 215 compounds T54.1.1 to T54.1. 215 of the formula (T16) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 55:

This table discloses the 215 compounds T55.1.1 to T55.1. 215 of the formula (T17) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 56:

This table discloses the 215 compounds T56.1.1 to T56.1. 215 of the formula (T18) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table 57:

This table discloses the 215 compounds T57.1.1 to T57.1. 215 of the formula (T19) in which, for each of these 215 specific compounds, each of the of the variables R₁, R₂, R₃, R₄ and R₅ has the specific meaning given in the corresponding line, appropriately selected from the 215 lines A.1.1 to A.1.215 of the Table A and R₆ is OCH₃.

Table A1: shows selected m.p. and/or LCMS data and retention times/MW for compounds of Tables 1 to 57.

Throughout this description, temperatures are given in degrees Celsius and “m.p.” means melting point.

The analytical methods used are described here below:

Method U: 6410-Triple Quad Mass Spectrometer from Agilent (Triple quadrupole mass spectrometer)
Ionisation method: Electrospray
Polarity: positive ions and negative ions simultaneous scanning

### Capillary (V) 4000, Frag (V) 100.00,

Source parameters
Gas Temp (° C.) 350, Gas Flow (l/min) 11; Nebulizer (psi): 35
Mass range: 80 to 800 Da
DAD Wavelength range (nm): 190 to 400
Method Agilent 1200 series with the following HPLC gradient conditions
(Solvent A: Water, 0.1% formic acid and Solvent B: Acetonitrile, 0.1% formic acid)

| Time (minutes) | A (%) | B (%) | Flow rate (ml/min) |
|---|---|---|---|
| 0 | 90 | 10 | 1.8 |
| 2 | 0 | 100 | 1.8 |
| 3 | 0 | 100 | 1.8 |
| 3.2 | 90 | 10 | 1.8 |
| 4 | 90 | 10 | 1.8 |

Type of column: Waters XTerra MS C-18; Column length: 30 mm; Internal diameter of column: 4.6 mm; Particle Size: 3.5 micron; Temperature: 30° C.
Method A: ZQ Mass Spectrometer from Waters (Single quadrupole mass spectrometer)
Instrument Parameter Ionisation method: Electrospray; Polarity: positive (negative) ions

### Capillary (kV) 3.00, Cone (V) 30.00, Extractor (V) 2.00, Source Temperature (° C.) 100, Desolvation Temperature (° C.) 250, Cone Gas Flow (L/Hr) 50, Desolvation Gas Flow (L/Hr) 400

Mass range: 100 to 900 Da (LC8 apolar: 150-1000 Da)
HP 1100 HPLC from Agilent: solvent degasser, quaternary pump (ZCQ)/binary pump (ZDQ), heated column compartment and diode-array detector.
Column: Phenomenex Gemini C18, 3 μm particle size, 110 Angström, 30×3 mm,

### Temp: 60° C.

DAD Wavelength range (nm): 200 to 500

### Solvent Gradient:

A=water+0.05% HCOOH
B=Acetonitril/Methanol (4:1, v:v)+0.04% HCOOH

| Time | A % | B % | Flow (ml/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

| | | | Retention Time | (M + H)+ |
|---|---|---|---|---|
| Compound No. | Structure | Melting poing (° C.) | (min/method) | (measured) |
| 1 | 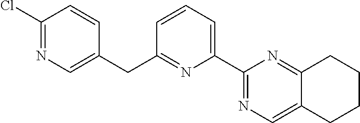 [SMILES: Clc1ccc(Cc2cccc(-c3ncc4c(n3)CCCC4)n2)cn1] | 115-120 | | |
| 2 | 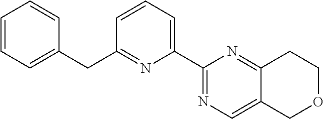 [SMILES: c1ccc(Cc2cccc(-c3ncc4c(n3)CCOC4)n2)cc1] | 244-245 | | |
| 3 | 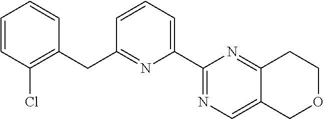 [SMILES: Clc1ccccc1Cc1cccc(-c2ncc3c(n2)CCOC3)n1] | 112-113 | | |
| 4 | 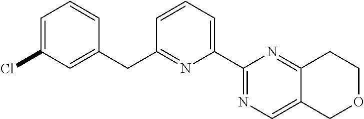 | 148-149 | | |
| 5 | 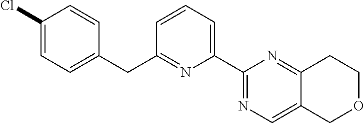 | 104-106 | | |
| 6 | 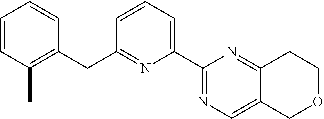 | 132-133 | | |
| 7 | 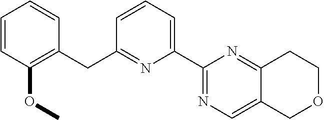 | 135-137 | | |
| 8 | 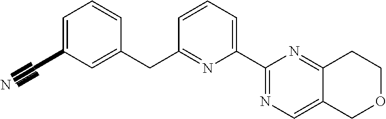 | 206-207 | | |
| 9 | 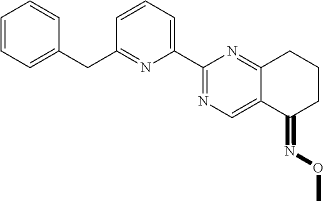 | 213-215 | | |
| 10 | 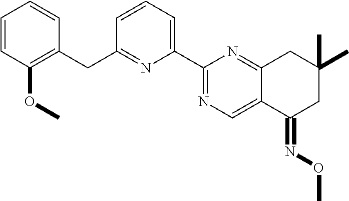 | 239-241 | | |
| 11 | 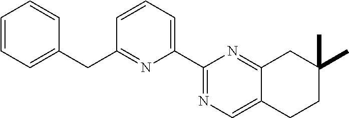 | 226-228 | | |
| 12 | 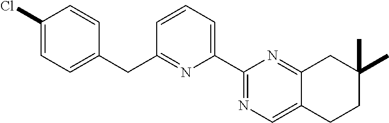 | 183-184 | | |
| 13 | 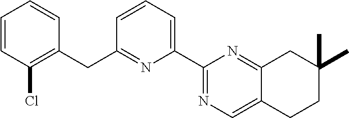 | 272-273 | | |
| 14 | 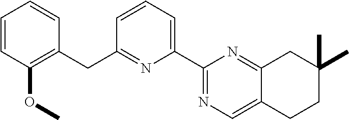 | 251-252 | | |
| 15 | 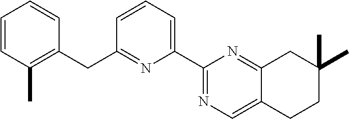 | 259-260 | | |
| 16 | 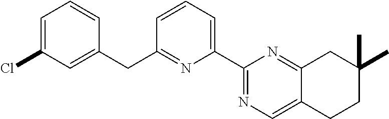 | 219-220 | | |
| 17 | 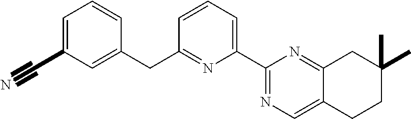 | 222-223 | | |
| 18 | 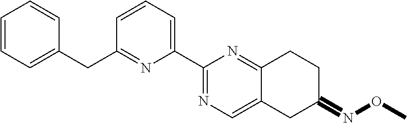 | 175-177 | | |
| 19 | 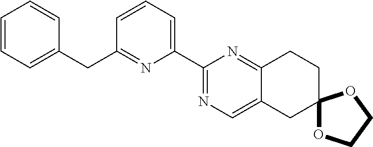 | 236-237 | | |
| 20 | 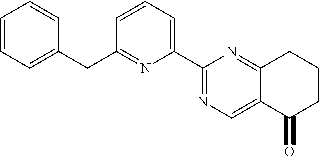 [SMILES: O=C1CCCc2nc(-c3cccc(Cc4ccccc4)n3)ncc21] | 69-75 | | |
| 21 | 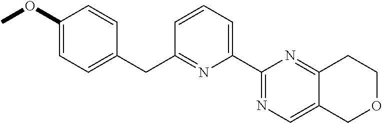 | 216-219 | | |
| 22 | 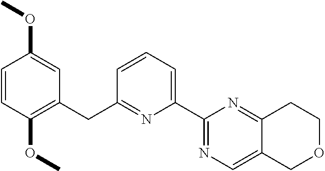 | 286-288 | | |
| 23 | 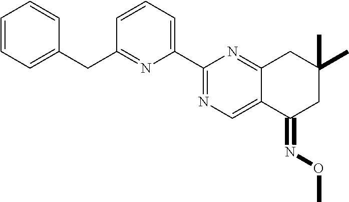 | | 2.09 (A) | 373 |
| 24 | 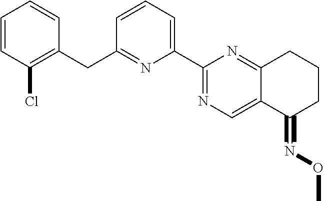 | | 2.01 (A) | 379 |
| 25 | 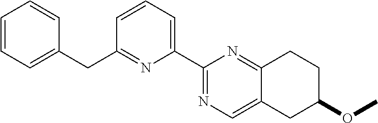 | | 1.62 (A) | 332 |
| 26 | 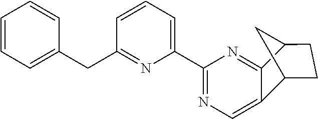 [SMILES: c1ccc(Cc2cccc(-c3ncc4c(n3)C3CCC4C3)n2)cc1] | | 1.66 (A) | 314 |
| 27 | 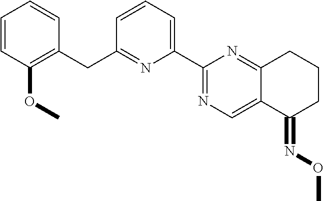 | | 1.84 (A) | 375 |
| 28 | 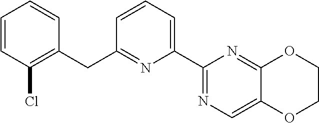 | | 1.66 (A) | 340 |
| 29 | 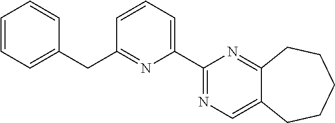 [SMILES: c1ccc(Cc2cccc(-c3ncc4c(n3)CCCCC4)n2)cc1] | | 1.90 (U) | 316 |
| 30 | 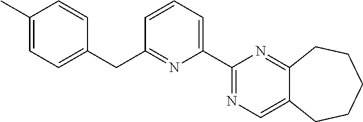 [SMILES: Cc1ccc(Cc2cccc(-c3ncc4c(n3)CCCCC4)n2)cc1] | | 1.98 (U) | 330 |
| 31 | 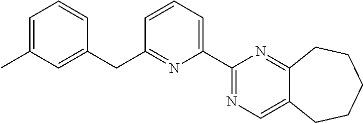 [SMILES: Cc1cccc(Cc2cccc(-c3ncc4c(n3)CCCCC4)n2)c1] | | 1.99 (U) | 330 |
| 32 | 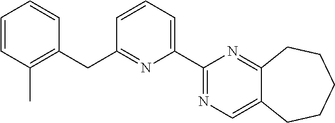 [SMILES: Cc1ccccc1Cc1cccc(-c2ncc3c(n2)CCCCC3)n1] | | 1.99 (U) | 330 |
| 33 | 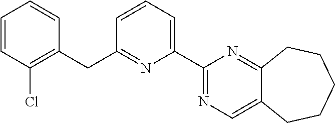 [SMILES: Clc1ccccc1Cc1cccc(-c2ncc3c(n2)CCCCC3)n1] | | 2.10 (U) | 350 |
| 34 | 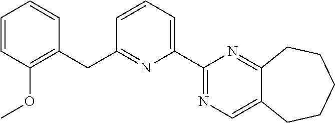 [SMILES: COc1ccccc1Cc1cccc(-c2ncc3c(n2)CCCCC3)n1] | | 1.72 (U) | 346 |
| 35 | 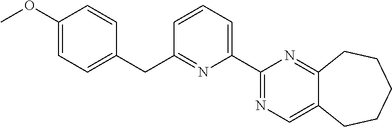 [SMILES: COc1ccc(Cc2cccc(-c3ncc4c(n3)CCCCC4)n2)cc1] | | 1.86 (U) | 346 |
| 36 | 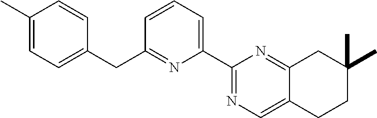 | | 2.10 (U) | 344 |
| 37 | 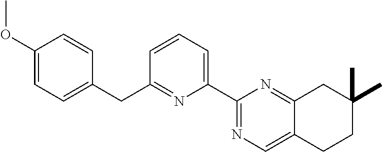 | | 1.98 (U) | 360 |
| 38 | 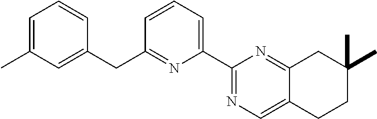 | | 2.11 (U) | 344 |
| 39 | 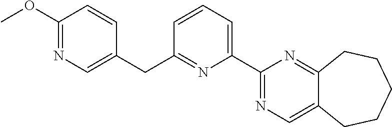 [SMILES: COc1ccc(Cc2cccc(-c3ncc4c(n3)CCCCC4)n2)cn1] | | 1.75 (U) | 347 |
| 40 | 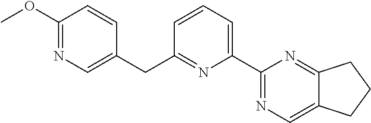 [SMILES: COc1ccc(Cc2cccc(-c3ncc4c(n3)CCC4)n2)cn1] | | 1.49 (U) | 319 |
| 41 | 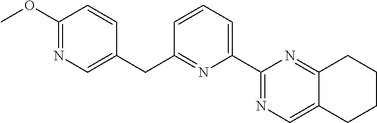 [SMILES: COc1ccc(Cc2cccc(-c3ncc4c(n3)CCCC4)n2)cn1] | | 1.57 (A) | 333 |
| 42 | 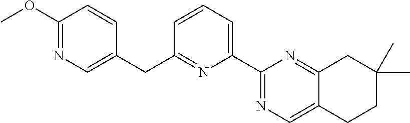 | | 1.72 (A) | 361 |
| 43 | 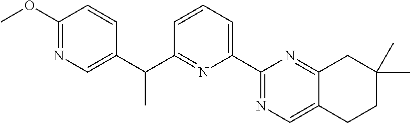 | | 1.82 (A) | 375 |
| 44 | 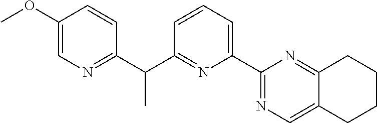 [SMILES: COc1ccc(C(C)c2cccc(-c3ncc4c(n3)CCCC4)n2)nc1] | | 1.73 (A) | 347 |
| 45 | 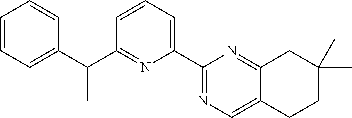 [SMILES: CC(c1ccccc1)c1cccc(-c2ncc3c(n2)CC(C)(C)CC3)n1] | 136-138 | | |
| 46 | 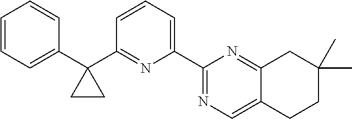 [SMILES: CC1(C)CCc2cnc(-c3cccc(C4(c5ccccc5)CC4)n3)nc2C1] | | 2.03 (A) | 356 |
| 47 | 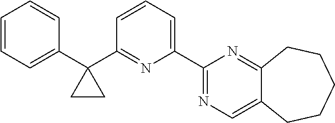 [SMILES: c1ccc(C2(c3cccc(-c4ncc5c(n4)CCCCC5)n3)CC2)cc1] | | 1.95 (A) | 342 |
| 48 | 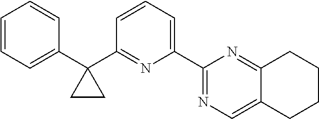 [SMILES: c1ccc(C2(c3cccc(-c4ncc5c(n4)CCCC5)n3)CC2)cc1] | | 1.86 (A) | 328 |

### Formulation Examples for Compounds of Formula I

### Example F-1.1 to F-1.2

### Emulsifiable Concentrates

| Components | F-1.1 | F-1.2 |
|---|---|---|
| compound of Tables 1-13 | 25% | 50% |
| calcium dodecylbenzenesulfonate | 5% | 6% |
| castor oil polyethylene glycol ether | 5% | — |
| (36 mol ethylenoxy units) | | |
| tributylphenolpolyethylene glycol ether | — | 4% |
| (30 mol ethylenoxy units) | | |
| cyclohexanone | — | 20% |
| xylene mixture | 65% | 20% |

Emulsions of any desired concentration can be prepared by diluting such concentrates with water.

### Example F-2

### Emulsifiable Concentrate

| Components | F-2 |
|---|---|
| compound of Tables 1-13 | 10% |
| octylphenolpolyethylene glycol ether | 3% |
| (4 to 5 mol ethylenoxy units) | |
| calcium dodecylbenzenesulfonate | 3% |
| castor oil polyglycol ether | 4% |
| (36 mol ethylenoxy units) | |
| cyclohexanone | 30% |
| xylene mixture | 50% |

Emulsions of any desired concentration can be prepared by diluting such concentrates with water.

### Examples F-3.1 to F-3.4

### Solutions

| Components | F-3.1 | F-3.2 | F-3.3 | F-3.4 |
|---|---|---|---|---|
| compound of Tables 1-13 | 80% | 10% | 5% | 95% |
| propylene glycol monomethyl ether | 20% | — | — | — |
| polyethylene glycol (relative molecular | — | 70% | — | — |
| mass: 400 atomic mass units) | | | | |
| N-methylpyrrolid-2-one | — | 20% | — | — |
| epoxidised coconut oil | — | — | 1% | 5% |
| benzin (boiling range: 160-190°) | — | — | 94% | — |

The solutions are suitable for use in the form of microdrops.

### Examples F-4.1 to F-4.4

### Granulates

| Components | F-4.1 | F-4.2 | F-4.3 | F-4.4 |
|---|---|---|---|---|
| compound of Tables 1-13 | 5% | 10% | 8% | 21% |
| kaolin | 94% | — | 79% | 54% |
| highly dispersed silicic acid | 1% | — | 13% | 7% |
| attapulgite | — | 90% | — | 18% |

The novel compound is dissolved in dichloromethane, the solution is sprayed onto the carrier and the solvent is then removed by distillation under vacuum.

### Examples F-5.1 and F-5.2

### Dusts

| Components | F-5.1 | F-5.2 |
|---|---|---|
| compound of Tables 1-13 | 2% | 5% |
| highly dispersed silicic acid | 1% | 5% |
| talcum | 97% | — |
| kaolin | — | 90% |

Ready for use dusts are obtained by intimately mixing all components.

### Examples F-6.1 to F-6.3

### Wettable Powders

| Components | F-6.1 | F-6.2 | F-6.3 |
|---|---|---|---|
| compound of Tables 1-13 | 25% | 50% | 75% |
| sodium lignin sulfonate | 5% | 5% | — |
| sodium lauryl sulfate | 3% | — | 5% |
| sodium diisobutylnaphthalene sulfonate | — | 6% | 10% |
| octylphenolpolyethylene glycol ether | — | 2% | — |
| (7 to 8 mol ethylenoxy units) | | | |
| highly dispersed silicic acid | 5% | 10% | 10% |
| kaolin | 62% | 27% | — |

All components are mixed and the mixture is thoroughly ground in a suitable mill to give wettable powders which can be diluted with water to suspensions of any desired concentration.

### Example F7

### Flowable Concentrate for Seed Treatment

| | |
|---|---|
| compound of Tables 1-13 | 40% |
| propylene glycol | 5% |
| copolymer butanol PO/EO | 2% |
| tristyrenephenole with 10-20 moles EO | 2% |
| 1,2-benzisothiazolin-3-one (in the form of a 20% | 0.5% |
| solution in water) | |
| monoazo-pigment calcium salt | 5% |
| Silicone oil (in the form of a 75% emulsion in water) | 0.2% |
| Water | 45.3% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Biological Examples

### Biological Example 1

### Fungicidal Activity Against Alternaria solani/Tomato/Leaf Disc (Early Blight)

Tomato leaf disks cv. Baby were placed on agar in multiwell plates (24-well format) and sprayed with the formulated test compound diluted in water. The leaf disks were inoculated with a spore suspension of the fungus 2 days after application. The inoculated leaf disks were incubated at 23° C./21° C. (day/night) and 80% rh under a light regime of 12/12 h (light/dark) in a climate cabinet and the activity of a compound was assessed as percent disease control compared to untreated when an appropriate level of disease damage appears on untreated check disk leaf disks (5-7 days after application).

Compounds 3, 5, 6, 7, 19, 21, 25 and 33 at 200 ppm give at least 80% disease control in this test when compared to untreated control leaf disks under the same conditions, which show extensive disease development.

### Biological Example 2

### Fungicidal Activity Against Blumeria graminis f. Sp. tritici (Erysiphe graminis f. sp. tritici)/Wheat/Leaf Disc Preventative (Powdery Mildew on Wheat)

Wheat leaf segments cv. Kanzler were placed on agar in a multiwell plate (24-well format) and sprayed with the formulated test compound diluted in water. The leaf disks were inoculated by shaking powdery mildew infected plants above the test plates 1 day after application. The inoculated leaf disks were incubated at 20° C. and 60% rh under a light regime of 24 h darkness followed by 12 h light/12 h darkness in a climate chamber and the activity of a compound was assessed as percent disease control compared to untreated when an appropriate level of disease damage appears on untreated check leaf segments (6-8 days after application).

Compounds 1, 2, 3, 4, 5, 6, 7, 9, 11, 18, 19, 21, 22, 25, 26, 27, 28, 29, 30, 31, 32, 33, 34, 35, 36, 37, 39, 41, 42, 43 and 44 at 200 ppm give at least 80% disease control in this test when compared to untreated control leaf disks under the same conditions, which show extensive disease development.

### Biological Example 3

### Fungicidal Activity Against Botryotinia fuckeliana (Botrytis cinerea)/Liquid Culture (Gray Mould)

Conidia of the fungus from cryogenic storage were directly mixed into nutrient broth (Vogels broth). After placing a (DMSO) solution of test compound into a microtiter plate (96-well format), the nutrient broth containing the fungal spores was added. The test plates were incubated at 24° C. and the inhibition of growth was determined photometrically 3-4 days after application.

Compounds 1, 2, 3, 4, 5, 6, 7, 9, 11, 12, 13, 14, 15, 16, 17, 18, 19, 20, 21, 22, 23, 24, 25, 26, 27, 28, 29, 30, 32, 33, 34, 35, 36, 37, 41, 42, 43, 44 and 45 at 200 ppm give at least 80% disease control in this test when compared to untreated control leaf disks under the same conditions, which show extensive disease development.

### Biological Example 4

### Fungicidal Activity Against Gaeumannomyces graminis/Liquid Culture (Take-all of Cereals)

Mycelial fragments of the fungus from cryogenic storage were directly mixed into nutrient broth (PDB potato dextrose broth). After placing a (DMSO) solution of test compound into a microtiter plate (96-well format), the nutrient broth containing the fungal spores iss added. The test plates were incubated at 24° C. and the inhibition of growth was determined photometrically 4-5 days after application.

Compounds 1, 2, 3, 4, 5, 6, 7, 9, 11, 14, 17, 18, 19, 20, 21, 22, 23, 24, 26, 27, 28, 29, 30, 31, 32, 33, 34, 35, 36, 37, 39, 41, 42, 43, 44 and 45 at 200 ppm give at least 80% disease control in this test when compared to untreated control leaf disks under the same conditions, which show extensive disease development.

### Biological Example 5

### Fungicidal Activity Against Glomerella lagenarium (Colletotrichum lagenarium)/Liquid Culture (Anthracnose)

Conidia of the fungus from cryogenic storage were directly mixed into nutrient broth (PDB potato dextrose broth). After placing a (DMSO) solution of test compound into a microtiter plate (96-well format), the nutrient broth containing the fungal spores was added. The test plates were incubated at 24° C. and the inhibition of growth was measured photometrically 3-4 days after application.

Compounds 1, 2, 3, 4, 5, 6, 7, 9, 11, 13, 14, 15, 16, 17, 18, 19, 20, 21, 22, 23, 24, 25, 26, 27, 28, 29, 30, 31, 32, 33, 34, 35, 36, 37, 39, 41, 42, 43, 44 and 45 at 200 ppm give at least 80% disease control in this test when compared to untreated control leaf disks under the same conditions, which show extensive disease development.

### Biological Example 6

### Fungicidal Activity Against Monographella nivalis (Microdochium nivale)/Liquid Culture (Foot Rot Cereals)

Conidia of the fungus from cryogenic storage were directly mixed into nutrient broth (PDB potato dextrose broth). After placing a (DMSO) solution of test compound into a microtiter plate (96-well format), the nutrient broth containing the fungal spores was added. The test plates were incubated at 24° C. and the inhibition of growth was determined photometrically 4-5 days after application.

Compounds 1, 3, 4, 5, 6, 7, 9, 11, 13, 14, 15, 16, 17, 19, 21, 23, 24, 25, 26, 27, 28, 29, 30, 32, 33, 34, 35, 36, 37, 41, 42, 43, 44 and 45 at 200 ppm give at least 80% disease control in this test when compared to untreated control leaf disks under the same conditions, which show extensive disease development.

### Biological Example 7

### Fungicidal Activity Against Mycosphaerella arachidis (Cercospora arachidicola)/Liquid Culture (Early Leaf Spot)

Conidia of the fungus from cryogenic storage were directly mixed into nutrient broth (PDB potato dextrose broth). After placing a (DMSO) solution of test compound into a microtiter plate (96-well format), the nutrient broth containing the fungal spores was added. The test plates were incubated at 24° C. and the inhibition of growth was determined photometrically 4-5 days after application.

Compounds 1, 2, 3, 4, 5, 6, 7, 9, 11, 12, 13, 14, 15, 16, 17, 18, 19, 20, 21, 23, 24, 25, 26, 27, 28, 29, 30, 31, 32, 33, 34, 35, 36, 37, 39, 41, 42, 43, 44 and 45 at 200 ppm give at least 80% disease control in this test when compared to untreated control leaf disks under the same conditions, which show extensive disease development.

### Biological Example 8

### Fungicidal Activity Against Mycosphaerella graminicola (Septoria tritici)/Liquid Culture (Septoria Blotch)

Conidia of the fungus from cryogenic storage were directly mixed into nutrient broth (PDB potato dextrose broth). After placing a (DMSO) solution of test compound into a microtiter plate (96-well format), the nutrient broth containing the fungal spores was added. The test plates were incubated at 24° C. and the inhibition of growth was determined photometrically 4-5 days after application.

Compounds 1, 2, 3, 4, 5, 6, 7, 11, 13, 14, 15, 16, 17, 18, 19, 20, 21, 22, 23, 24, 25, 26, 27, 28, 29, 30, 31, 32, 33, 34, 35, 36, 37, 39, 41, 42, 43, 44 and 45 at 200 ppm give at least 80% disease control in this test when compared to untreated control leaf disks under the same conditions, which show extensive disease development.

### Biological Example 9

### Fungicidal Activity Against Phaeosphaeria nodorum (Septoria nodorum)/Wheat/Leaf Disc Preventative (Glume Blotch)

Wheat leaf segments cv. Kanzler were placed on agar in a multiwell plate (24-well format) and sprayed with the formulated test compound diluted in water. The leaf disks were inoculated with a spore suspension of the fungus 2 days after application. The inoculated test leaf disks were incubated at 20° C. and 75% rh under a light regime of 12 h light/12 h darkness in a climate cabinet and the activity of a compound was assessed as percent disease control compared to untreated when an appropriate level of disease damage appears in untreated check leaf disks (5-7 days after application).

Compounds 1, 2, 3, 4, 5, 6, 7, 9, 11, 13, 15, 16, 17, 18, 19, 21, 22, 24, 25, 26, 27, 28, 29, 30, 31, 32, 33, 34, 35, 36, 37, 39, 41, 42, 43, 44 and 45 at 200 ppm give at least 80% disease control in this test when compared to untreated control leaf disks under the same conditions, which show extensive disease development.

### Biological Example 10

### Fungicidal Activity Against Phytophthora infestans/Tomato/Leaf Disc Preventative (Late Blight)

Tomato leaf disks were placed on water agar in multiwell plates (24-well format) and sprayed with the formulated test compound diluted in water. The leaf disks were inoculated with a spore suspension of the fungus 1 day after application. The inoculated leaf disks were incubated at 16° C. and 75% rh under a light regime of 24 h darkness followed by 12 h light/12 h darkness in a climate cabinet and the activity of a compound was assessed as percent disease control compared to untreated when an appropriate level of disease damage appears in untreated check leaf disks (5-7 days after application).

Compounds 2, 21, 29, 30, 33 and 36 at 200 ppm give at least 80% disease control in this test when compared to untreated control leaf disks under the same conditions, which show extensive disease development.

### Biological Example 11

### Fungicidal Activity Against Plasmopara viticola/Grape/Leaf Disc Preventative (Late Blight)

Grape vine leaf disks were placed on water agar in multiwell plates (24-well format) and sprayed with the formulated test compound diluted in water. The leaf disks were inoculated with a spore suspension of the fungus 1 day after application. The inoculated leaf disks were incubated at 19° C. and 80% rh under a light regime of 12 h light/12 h darkness in a climate cabinet and the activity of a compound was assessed as percent disease control compared to untreated when an appropriate level of disease damage appears in untreated check leaf disks (6-8 days after application).

Compound 14, 33 and 34 at 200 ppm gives at least 80% disease control in this test when compared to untreated control leaf disks under the same conditions, which show extensive disease development.

### Biological Example 12

### Fungicidal Activity Against Puccinia recondita f. sp. tritici/Wheat/Leaf Disc Preventative (Brown Rust)

Wheat leaf segments cv. Kanzler were placed on agar in multiwell plates (24-well format) and sprayed with the formulated test compound diluted in water. The leaf disks were inoculated with a spore suspension of the fungus 1 day after application. The inoculated leaf segments were incubated at 19° C. and 75% rh under a light regime of 12 h light/12 h darkness in a climate cabinet and the activity of a compound was assessed as percent disease control compared to untreated when an appropriate level of disease damage appears in untreated check leaf segments (7-9 days after application).

Compounds 1, 2, 3, 4, 5, 6, 7, 9, 11, 18, 19, 21, 22, 24, 25, 26, 27, 28, 29, 30, 31, 32, 33, 34, 35, 37, 39, 41, 42, and 44 at 200 ppm give at least 80% disease control in this test when compared to untreated control leaf disks under the same conditions, which show extensive disease development.

### Biological Example 13

### Fungicidal Activity Against Pyrenophora teres/Barley/Leaf Disc Preventative (Net Blotch)

Barley leaf segments cv. Hasso were placed on agar in a multiwell plate (24-well format) and sprayed with the formulated test compound diluted in water. The leaf segments were inoculated with a spore suspension of the fungus 2 days after application. The inoculated leaf segments were incubated at 20° C. and 65% rh under a light regime of 12 h light/12 h darkness in a climate cabinet and the activity of a compound was assessed as disease control compared to untreated when an appropriate level of disease damage appears in untreated check leaf segments (5-7 days after application).

Compounds 1, 2, 3, 4, 5, 6, 7, 9, 11, 14, 15, 16, 17, 18, 19, 21, 22, 25, 26, 27, 28, 29, 30, 31, 32, 33, 34, 35, 36, 37, 39, 41, 42, 43, 44 and 45 at 200 ppm give at least 80% disease control in this test when compared to untreated control leaf disks under the same conditions, which show extensive disease development.

### Biological Example 14

### Fungicidal Activity Against Thanatephorus cucumeris (Rhizoctonia solani)/Liquid Culture (Foot Rot, Damping-Off)

Mycelia fragments of a newly grown liquid culture of the fungus were directly mixed into nutrient broth (PDB potato dextrose broth). After placing a (DMSO) solution of the test compounds into a microtiter plate (96-well format), the nutrient broth containing the fungal material was added. The test plates were incubated at 24° C. and the inhibition of growth was determined photometrically 3-4 days after application.

Compounds 1, 2, 3, 4, 5, 11, 13, 14, 15, 17, 18, 19, 21, 24, 26, 28, 29, 30, 31, 32, 33, 34, 35, 36, 37, 41, 42, 44 and 45 at 200 ppm give at least 80% disease control in this test when compared to untreated control leaf disks under the same conditions, which show extensive disease development

1. A compound of formula I 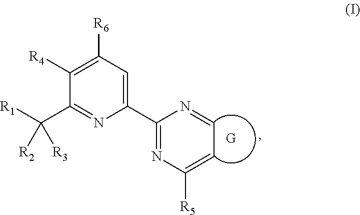
wherein
G represents together with the two carbon atoms of the pyrimidine ring to which it is attached, a 5- to 8-membered alicyclic or non aromatic heterocyclic ring system which is mono or bicyclic and contains 0 to 2 heteroatoms selected from the group consisting of nitrogen, oxygen and sulfur; and wherein said 5- to 8-membered alicyclic or non aromatic heterocyclic ring system can be mono-, di- or trisubstituted by substituents selected from the group consisting of halogen, hydroxyl, keto, C₁-C₆alkyl, C₁-C₆haloalkyl, C₁-C₆alkoxy, C₁-C₆haloalkoxy, C₁-C₆alkoxy-C₁-C₆alkyl, C₁-C₆alkyloximino and C₁-C₆alkylendioxy; R₁ is aryl or heteroaryl, which can be mono-, di- or trisubstituted by substituents selected from the group consisting of -halogen, hydroxy, cyano, nitro, formyl, C₁-C₆alkyl, C₂-C₆alkenyl, C₂-C₆alkynyl, C₃-C₆cycloalkyl, C₁-C₆haloalkyl, C₂-C₆haloalkenyl, C₂-C₆haloalkynyl, C₃-C₆halocycloalkyl, C₁-C₆alkoxy, C₁-C₆alkoxy-C₁-C₆alkyl, C₁-C₆alkoxy-C₁-C₆alkoxy, C₁-C₆alkoxy-C₁-C₆alkoxy-C₁-C₆alkyl, C₁-C₆alkoxy-C₁-C₆alkylthio, C₁-C₆alkylthio-C₁-C₆alkoxy, C₁-C₆haloalkoxy, C₁-C₆alkylthio, C₁-C₆haloalkylthio, C₁-C₆alkylsulfinyl, C₁-C₆alkylsulfonyl, C₁-C₆alkylamino, diC₁-C₆alkylamino, C₃-C₆cycloalkylamino, (C₁-C₆alkyl)(C₃-C₆cycloalkyl)amino, diC₃-C₆cycloalkylamino, C₁-C₆alkylcarbonyl, C₁-C₆alkoxycarbonyl, C₁-C₆alkylaminocarbonyl, diC₁-C₆alkylaminocarbonyl, C₁-C₆alkoxycarbonyloxy, C₁-C₆alkylaminocarbonyloxy, diC₁-C₆alkylaminocarbonyloxy, C₁-C₆alkylcarbonyloxy, C₁-C₆alkylcarbonylamino, C₁-C₆alkylcarbonyl-C₁-C₆alkylamino, C₁-C₆alkoxyimino, C₁-C₆alkoxyimino-C₁-C₆alkyl, triC₁₋₆alkylsilyl, C₁-C₆alkoxy-C₂-C₆alkynyl, C₁-C₆alkoxyimino-C₂-C₆alkynyl, C₁-C₆alkylthio-C₂-C₆alkynyl, hydroxy-C₂-C₆alkynyl, C₁-C₆alkylthio-C₁-C₆alkyl or hydroxy-C₁-C₆alkyl;
R₂ and R₃ are, independently from each other, hydrogen, hydroxyl, halogen, C₁-C₆alkyl or C₁-C₆alkoxy; or
R₂ and R₃ together form a 3- to 5-membered aliphatic carbocyclic ring or a 3- to 5-membered heterocyclic ring containing up to two heteroatoms selected from O, S and N; or
R₂ and R₃ together form a carbonyl or a C₁-C₆ alkyloximino;
R₄ is hydrogen, halogen, cyano, C₁-C₆alkyl, C₁-C₆alkoxy or C₁-C₆alkylthio;
R₅ is hydrogen, hydroxy, halogen, C₁-C₆alkyl or C₁-C₆alkoxy; and
R₆ is hydrogen, halogen, C₁-C₆alkyl, C₁-C₆alkoxy or C₁-C₆alkylthio;
and agronomically acceptable salts, isomers, atropisomers, structural isomers, stereoisomers, diastereoisomers, enantiomers, tautomers and N-oxides of those compounds;
with the proviso that when G is an unsubstituted 5 or 6 membered monocyclic alicyclic ring, and R₂ and R₃ are, independently from each other, hydrogen, C₁-C₄alkyl then R₁ cannot be phenyl or substituted phenyl.

2. A compound of formula I according to claim 1, wherein the pyrimidine ring together with the substituent G forms a ring system selected from the group consisting of 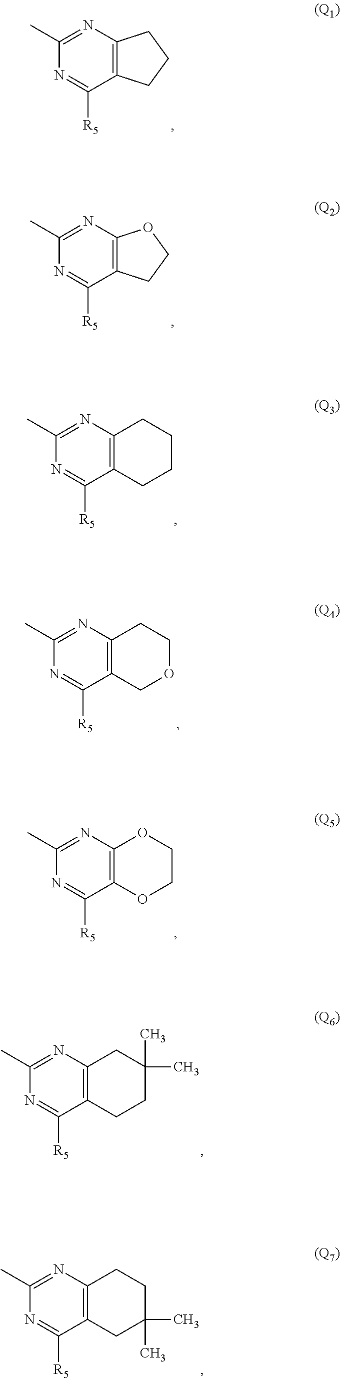 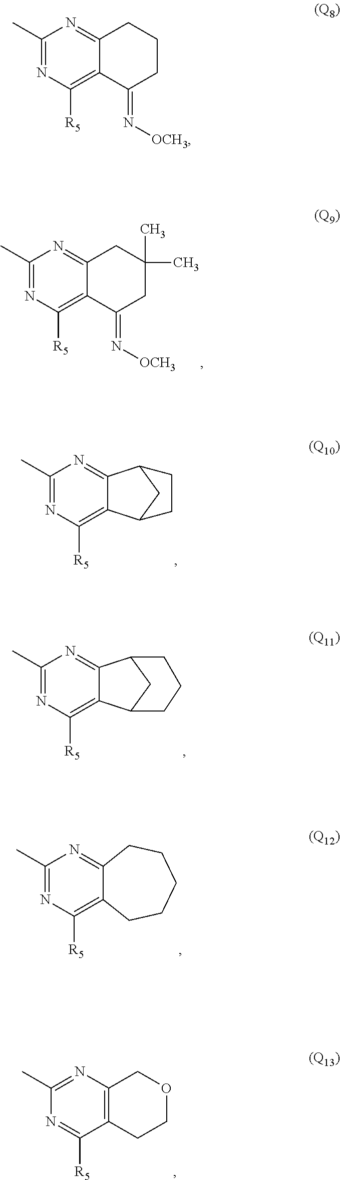 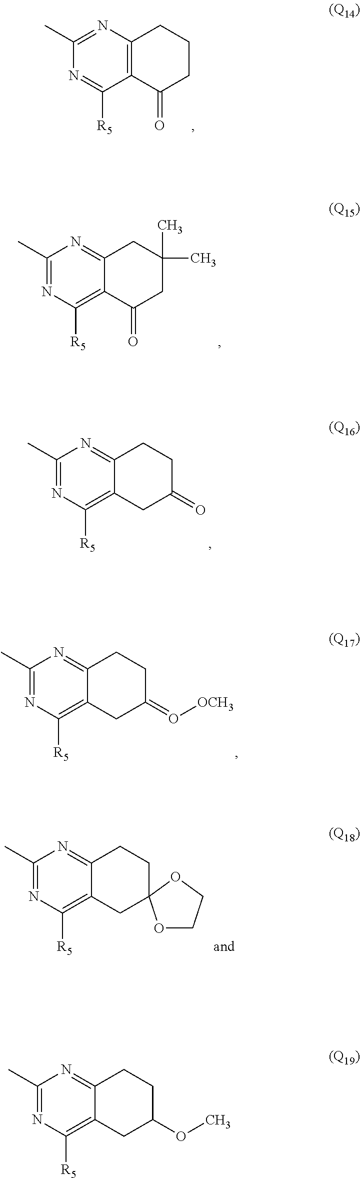
wherein R₅ has the meaning as defined under formula I in claim 1.

3. A compound of formula I according to claim 1 wherein R₂ and R₃ are, independently from each other, hydrogen, hydroxyl, halogen, C₁-C₆alkyl or C₁-C₆alkoxy or R₂ and R₃ together form a 3- to 5-membered aliphatic carbocyclic ring or a 3- to 5-membered heterocyclic ring containing up to two heteroatoms selected from O, S and N;

4. A compound of formula I according to claim 2, wherein R₅ is hydrogen, halogen, hydroxy, C₁-C₄alkyl or C₁-C₄alkoxy.

5. A compound of formula I according to claim 2, wherein the ring system is selected from Q₃, Q₄, Q₆, Q₁₂ and Q₁₉.

6. A compound of formula I according to claim 1, wherein
R₁ is phenyl, naphthyl, pyridyl, quinolinyl, pyridazinyl, cinnolinyl, pyrimidinyl, quinazolinyl, pyrazinyl, quinoxalinyl, thienyl, furyl, isoxazolyl, isothiazolyl, thiazoyl, oxazolyl, pyrazolyl, imidazolyl, pyrrolyl, oxadiazolyl, thiadiazolyl which can be mono- or disubstituted by substituents selected from halogen, C₁-C₄alkyl, C₁-C₄haloalkyl, C₁-C₄alkylthio or C₁-C₄alkoxy;
R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen, C₁-C₄alkyl or C₁-C₄alkoxy.

7. A compound of formula I according to claim 1, wherein
R₁ is phenyl or pyridyl or thienyl which can be substituted by halogen, C₁-C₄alkyl, C₁-C₄alkylthio or C₁-C₄alkoxy;
R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen, C₁-C₄alkyl or C₁-C₄alkoxy.

8. A compound of formula I according to claim 7, wherein
R₁ is phenyl, pyridyl or thienyl which can be substituted by halogen, C₁-C₄alkyl or C₁-C₄alkoxy;
R₂ and R₃ are hydrogen or C₁-C₄alkyl;
R₄ is hydrogen, C₁-C₄alkyl or C₁-C₄alkoxy;
R₅ is hydrogen, halogen or C₁-C₄alkyl; and
R₆ is hydrogen.

9. A compound of formula I according to claim 8, wherein
R₁ is phenyl which can be substituted by halogen, C₁-C₄alkyl or C₁-C₄alkoxy;
R₂ and R₃ are hydrogen or methyl;
R₄ is hydrogen or methyl;
R₅ is hydrogen or methyl; and
R₆ is hydrogen;

10. A method of controlling or preventing infestation of useful plants by phytopathogenic microorganisms, wherein a compound of formula I according to claim 1 or a composition, comprising this compound as active ingredient, is applied to the plants, to parts thereof or the locus thereof.

11. A composition for controlling and protecting against phytopathogenic microorganisms, comprising a compound of formula I according to claim 1 and at least one auxiliary.

12. A method of controlling phytopathogenic diseases on useful plants or plant propagation material thereof, which comprises applying to said plant propagation material a fungicidally effective amount of a plant propagation material protecting composition comprising a compound of formula (I) as defined in claim 1, together with a suitable carrier therefor.

13. A composition comprising a fungicidally effective amount of a compound of formula (I) as defined in claim 1, optionally comprising at least one additional active ingredient.
